(19) United States
(12) Patent Application Publication
(10) Pub. No.: US 2016/0127815 A1
(43) Pub. Date: May 5, 2016

(54) INPUT DEVICE AND TRANSMITTING METHOD, HOST DEVICE AND RECEIVING METHOD, AND SIGNAL PROCESSING SYSTEM AND TRANSCEIVING METHOD

(71) Applicant: SONY CORPORATION, Tokyo (JP)

(72) Inventors: Kazunobu Ookuri, Kanagwa (JP); Kohei Asada, Kanagawa (JP); Tetsunori Itabashi, Kanagawa (JP); Yasunobu Murata, Tokyo (JP); Mitsuhiro Suzuki, Tokyo (JP); Toshiya Murakami, Kanagawa (JP); Naotaka Tsunoda, Tokyo (JP); Kenji Irie, Kanagawa (JP)

(73) Assignee: SONY CORPORATION, Tokyo (JP)

(21) Appl. No.: 14/893,741

(22) PCT Filed: May 26, 2014
(86) PCT No.: PCT/JP2014/063825

§ 371 Date: Nov. 24, 2015

(30) Foreign Application Priority Data
Jun. 7, 2013 (JP) 2013-120678

(51) Int. Cl. H04R 1/06; H04R 3/00

(52) U.S. Cl. CPC H04R 1/06; H04R 3/005; H04R 2420/09; H04R 2420/01

(57) ABSTRACT

The present technology relates to an input device, a transmitting method, a host device, a receiving method, a signal processing system, and a transceiving method, which are capable of easily performing transmission and reception of multiplexed data obtained by multiplexing a plurality of electric signals between a plug device including a plug and a jack device including a jack. An input device detects whether or not the jack device including the jack is an associated device capable of dealing the multiplexed data obtained by multiplexing a plurality of electric signals, and transmits the multiplexed data via the plug when the jack device is the associated device. The host device detects whether or not the plug device including the plug is the associated device, and receives the multiplexed data transmitted from the plug device via the jack when the plug device is the associated device. The present technology can be applied to a music player having a jack and a headset having a plug, for example.

### TECHNICAL FIELD

The present technology relates to an input device, a transmitting method, a host device, a receiving method, a signal processing system, and a transceiving method, and more particularly, to an input device, a transmitting method, a host device, a receiving method, a signal processing system, and a transceiving method, which are capable of easily performing transmission and reception of multiplexed data obtained by multiplexing a plurality of electric signals, for example, between a plug device including a plug and a jack device including a jack.

### BACKGROUND ART

Techniques of transmitting analog signals output from a plurality of microphones to a host device capable of performing voice communication through one terminal (pin), for example, in a headset including a plurality of microphones have been proposed (for example, see Patent Document 1).

### CITATION LIST

### Patent Document

Patent Document 1: U.S. Patent Publication No. 2010/0284525

### SUMMARY OF THE INVENTION

### Problems to be Solved by the Invention

By the way, in recent years, there has been a demand for a technique capable of easily performing transmission and reception of multiplexed data obtained by multiplexing a plurality of electric signals between a plug device including a plug and a jack device including a jack.

The present technology was made in light of the foregoing, and it is desirable to provide a technique of easily performing transmission and reception of multiplexed data obtained by multiplexing a plurality of electric signals between a plug device and a jack device.

### Solutions to Problems

An input device of the present technology includes: a plug that is inserted into a jack of a jack device including the jack; a plurality of converting units each of which converts a physical quantity into an electric signal; a detecting unit that detects whether or not the jack device is an associated device capable of dealing with multiplexed data obtained by multiplexing the electric signals output from the plurality of converting units; and a transmission processing unit that transmits the multiplexed data via the plug when the jack device is the associated device.

A transmitting method of the present technology is a transmitting method of an input device including a plug inserted into a jack of a jack device including the jack and a plurality of converting units each of which converts a physical quantity into an electric signal, and the transmitting method includes: a step of detecting, by the input device, whether or not the jack device is an associated device capable of dealing with multiplexed data obtained by multiplexing the electric signals output from the plurality of converting units; and a step of transmitting, by the input device, the multiplexed data via the plug when the jack device is the associated device.

In the input device and the transmitting method of the present technology, it is detected whether or not the jack device is an associated device capable of dealing with the multiplexed data obtained by multiplexing the electric signals output from the plurality of converting units. Then, when the jack device is the associated device, the multiplexed data is transmitted via the plug.

A host device of the present technology includes: a jack into which a plug of a plug device including the plug is inserted; a detecting unit that detects whether or not the plug device is an associated device capable of dealing with multiplexed data obtained by multiplexing electric signals output from a plurality of converting units each of which converts a physical quantity into the electric signal; and a reception processing unit that receives the multiplexed data transmitted from the plug device serving as the associated device via the jack when the plug device is the associated device.

A receiving method of the present technology is a receiving method of a host device including a jack into which a plug of a plug device including the plug is inserted, the receiving method including:

a step of detecting whether or not the plug device is an associated device capable of dealing with multiplexed data obtained by multiplexing electric signals output from a plurality of converting units each of which converts a physical quantity into the electric signal; and

a step of receiving the multiplexed data transmitted from the plug device serving as the associated device via the jack when the plug device is the associated device.

In the host device and the receiving method of the present technology, it is detected whether or not the plug device is an associated device capable of dealing with multiplexed data obtained by multiplexing the electric signals output from the plurality of converting units each of which converts the physical quantity into the electric signal. Then, when the plug device is the associated device, the multiplexed data transmitted from the plug device serving as the associated device is received via the jack.

A signal processing system of the present technology includes: an input device including a plug that is inserted into a jack of a jack device including the jack, a plurality of converting units each of which converts a physical quantity into an electric signal, a detecting unit that detects whether or not the jack device is an associated device capable of dealing with multiplexed data obtained by multiplexing the electric signals output from the plurality of converting units, and a transmission processing unit that transmits the multiplexed data via the plug when the jack device is the associated device; and a host device including a jack into which a plug of a plug device including the plug is inserted, and another detecting unit that detects whether or not the plug device is the associated device, and a reception processing unit that receives the multiplexed data transmitted from the plug device serving as the associated device via the jack when the plug device is the associated device.

A transceiving method of the present technology includes: a step of detecting, by the input device, whether or not a jack device is an associated device capable of dealing with multiplexed data obtained by multiplexing electric signals output from a plurality of converting units, the input device including a plug inserted into a jack of the jack device including the jack and the plurality of converting units each of which converts a physical quantity into the electric signal; a step of transmitting, by the input device, the multiplexed data via the plug when the jack device is the associated device; a step of detecting, by a host device, whether or not a plug device is an associated device, the host device including a jack into which a plug of the plug device including the plug is inserted; and a step of receiving, by the host device, the multiplexed data transmitted from the plug device serving as the associated device via the jack when the plug device is the associated device.

In the signal processing system and the transceiving method of the present technology, in the input device, it is detected whether or not the jack device is an associated device capable of dealing with the multiplexed data obtained by multiplexing the electric signals output from the plurality of converting units, and when the jack device is the associated device, the multiplexed data is transmitted via the plug. In the host device, it is detected whether or not the plug device is the associated device, and when the plug device is the associated device, the multiplexed data transmitted from the plug device serving as the associated device is received via the jack.

The input device and the host device may be independent devices and may be a part configuring one device.

### Effects of the Invention

According to the present technology, it is possible to easily perform transmission and reception of multiplexed data obtained by multiplexing a plurality of electric signals between a plug device and a jack device.

The effects described in this specification are merely examples, and the effects of the present technology are not limited to the effects described in this specification, and an additional effect may be obtained.

### BRIEF DESCRIPTION OF DRAWINGS

FIG. 1 is a block diagram illustrating an exemplary configuration of a signal processing system according to an embodiment of the present technology.

FIG. 2 is a block diagram illustrating a first exemplary detailed configuration of a host device 10 and an input device 20.

FIG. 3 is a flowchart for describing processes of the host device 10 and the input device 20.

FIG. 4 is a block diagram illustrating a second exemplary detailed configuration of the host device 10 and the input device 20.

FIG. 5 is a block diagram illustrating a third exemplary detailed configuration of the host device 10 and the input device 20.

FIG. 6 is a block diagram illustrating a fourth exemplary detailed configuration of the host device 10 and the input device 20.

FIG. 7 is a block diagram illustrating a fifth exemplary detailed configuration of the host device 10 and the input device 20.

FIG. 8 is a block diagram illustrating a sixth exemplary detailed configuration of the host device 10 and the input device 20.

FIG. 9 is a flowchart for describing processes of the host device 10 and the input device 20.

FIG. 10 is a block diagram illustrating a seventh exemplary detailed configuration of the host device 10 and the input device 20.

FIG. 11 is a timing chart illustrating an exemplary signal exchanged between the host device 10 and the input device 20.

FIG. 12 is a timing chart illustrating an exemplary signal exchanged between the host device 10 and the input device 20.

FIG. 13 is a timing chart illustrating an exemplary signal serving as a command transmitted from the host device 10 to the input device 20.

FIG. 14 is a block diagram illustrating an exemplary configuration of an NC system of an FB scheme that performs an NC of the FB scheme.

FIG. 15 is a diagram for describing a transfer function of the NC system of the FB scheme.

FIG. 16 is a block diagram illustrating an exemplary configuration of the NC system of an FF scheme that performs an NC of the FF scheme.

FIG. 17 is a diagram for describing a transfer function of the NC system of the FF scheme.

FIG. 18 is a block diagram illustrating an exemplary configuration of the NC system of an FF+FB scheme that performs an NC of an FF+FB scheme.

FIG. 19 is a block diagram illustrating an exemplary configuration of a noise suppression system that performs noise suppression.

FIG. 20 is a perspective view illustrating an exemplary external appearance configuration of an application system to which the host device 10 and the input device 20 are applied.

FIG. 21 is a block diagram illustrating an exemplary electrical configuration of the application system.

FIG. 22 is a diagram illustrating exemplary device information stored in non-volatile memory 85.

FIG. 23 is a perspective view illustrating an exemplary external appearance configuration of a first system to which the application system is applied.

FIG. 24 is a block diagram illustrating an exemplary electrical configuration of the first system.

FIG. 25 is a perspective view illustrating an exemplary external appearance configuration of a second system to which the application system is applied.

FIG. 26 is a block diagram illustrating an exemplary electrical configuration of the second system.

FIG. 27 is a perspective view illustrating an exemplary external appearance configuration of a third system to which the application system is applied.

FIG. 28 is a perspective view illustrating an exemplary external appearance configuration of a fourth system to which the application system is applied.

FIG. 29 is a perspective view illustrating an exemplary external appearance configuration of a fifth system to which the application system is applied.

FIG. 30 is a perspective view illustrating an exemplary external appearance configuration of a sixth system to which the application system is applied.

FIG. 31 is a perspective view illustrating an exemplary external appearance configuration of a seventh system to which the application system is applied.

FIG. 32 is a block diagram illustrating an eighth exemplary detailed configuration of the host device 10 and the input device 20.

FIG. 33 is a circuit diagram illustrating an exemplary configuration of a switch unit 401.

FIG. 34 is a circuit diagram illustrating an exemplary configuration of the switch unit 401 when a protection diode is installed.

FIG. 35 is a circuit diagram illustrating an exemplary configuration of a switch unit 411.

FIG. 36 is a circuit diagram illustrating an exemplary configuration of the switch unit 411 when a protection diode is installed.

FIG. 37 is a block diagram illustrating an exemplary configuration of a computer according to an embodiment of the present technology.

### MODE FOR CARRYING OUT THE INVENTION

### Signal Processing System According to Embodiment of Present Technology

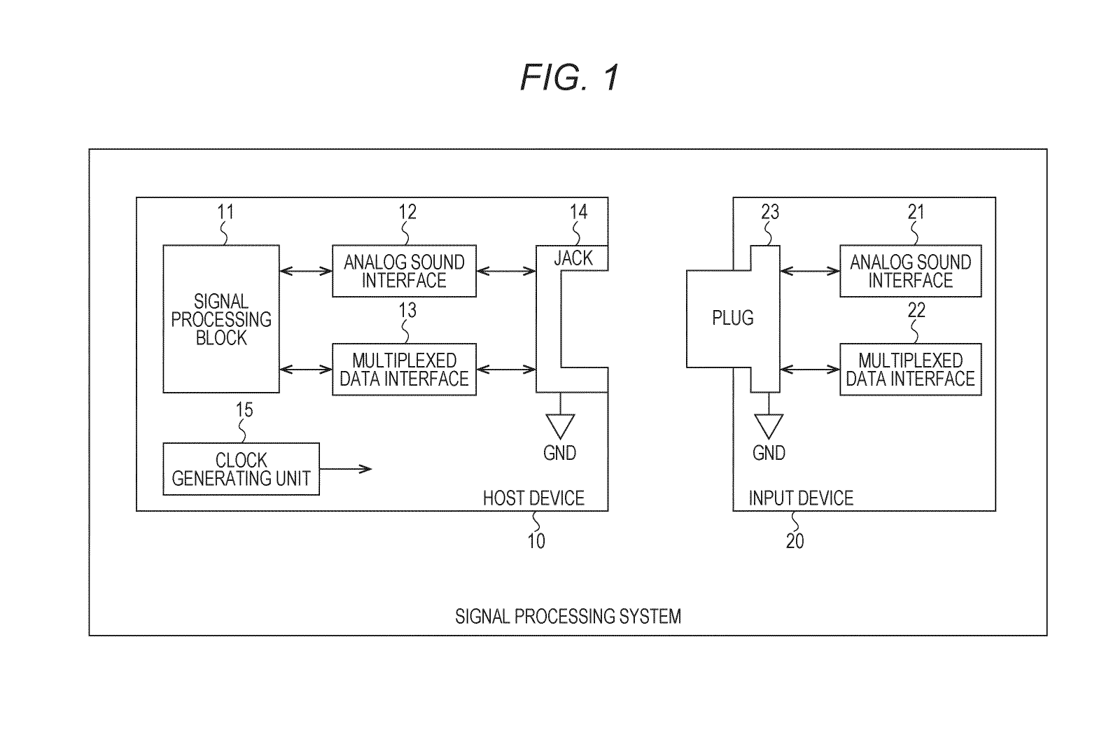

FIG. 1 is a block diagram illustrating an exemplary configuration of a signal processing system (a system refers to one in which a plurality of devices are physically assembled, and it does not matter whether or not devices of respective configurations are arranged in the same housing).

Referring to FIG. 1, a signal processing system includes a host device 10 and an input device 20.

The host device 10 includes a signal processing block 11, an analog sound interface 12, a multiplexed data interface 13, a jack 14, and a clock generating unit 15.

The host device 10 is a jack device including a jack, and when a plug is inserted into the jack 14, the host device 10 receives multiplexed data that is obtained by multiplexing a plurality of digital signals (electric signal) and transmitted from, for example, the input device 20 serving as a plug device including a plug via the jack 14 through the multiplexed data interface 13.

In the host device 10, the signal processing block 11 performs various kinds of signal processing using the digital signal included in the multiplexed data received by the multiplexed data interface 13.

As the host device 10, for example, a mobile device with a signal processing function such as a mobile phone, a smartphone, a portable music player, a digital camera, or a laptop personal computer (PC) can be employed. Further, as the host device 10, for example, any device capable of performing signal processing such as a tablet terminal, a desktop PC, or a television receiver (TV) can be employed.

For example, the signal processing block 11 is configured with a central processing unit (CPU) or a micro-processing unit (MPU) that is a processor such as a digital signal processor (DSP), and performs various kinds of signal processing using the digital signal included in the multiplexed data supplied from the multiplexed data interface 13 or the analog signal supplied from the analog sound interface 12.

For example, the signal processing block 11 supplies the analog sound signal obtained by the signal processing or the like to the analog sound interface 12, supplies a command or the like to be transmitted to the input device 20 to the multiplexed data interface 13, and controls the overall host device 10 as necessary.

The analog sound interface 12 is an interface for transceiving the analog sound signal via the jack 14, and transmits the analog sound signal supplied from the signal processing block 11 to the plug device (for example, the input device 20) whose plug is inserted into the jack 14.

The analog sound interface 12 receives the analog signal (the analog sound signal or the like) transmitted from the plug device whose plug is inserted into the jack 14, and supplies the analog signal to the signal processing block 11.

The multiplexed data interface 13 is an interface for transceiving digital multiplexed data via the jack 14, and receives the multiplexed data transmitted from the plug device whose plug is inserted into the jack 14 and supplies the multiplexed data to the signal processing block 11.

The multiplexed data interface 13 transmits the signal (the command or the like) supplied from the signal processing block 11 to the plug device whose plug is inserted into the jack 14.

The plug of the plug device is inserted into the jack 14.

The clock generating unit 15 generates a predetermined clock, and supplies the generated clock to a necessary block of the host device 10. The host device 10 operates in synchronization with the clock generated by the clock generating unit 15.

In the host device 10, the analog sound interface 12 is not mandatory.

The input device 20 includes an analog sound interface 21, a multiplexed data interface 22, and a plug 23.

The input device 20 is the plug device including a plug, and when the plug 23 is inserted into the jack, the input device 20 transmits the multiplexed data to, for example, the host device 10 that is the jack device including the jack via the plug 23 from the multiplexed data interface 13.

Thus, the input device 20 functions as a device that inputs (supplies) the multiplexed data to the host device 10.

As the input device 20, for example, a device including a plurality of converting units (transducers) each of which converts a physical quantity of a headset including a plurality of microphones or the like into an electric signal can be employed.

The analog sound interface 21 is an interface for transceiving the analog sound signal via the plug 23, and transmits the analog sound signal or the like obtained through, for example, the microphone (not illustrated in FIG. 1) to the jack device including the jack into which the plug 23 is inserted.

The analog sound interface 21 receives the analog sound signal transmitted from the jack device including the jack into which the plug 23 is inserted, and outputs (emits) a sound corresponding to the sound signal.

The multiplexed data interface 22 is an interface for transceiving the digital multiplexed data via the plug 23, and transmits the multiplexed data obtained by multiplexing the digital data obtained by performing analog-to-digital (AD) conversion on the analog sound signal through, for example, a plurality of microphones (not illustrated in FIG. 1) to the jack device including the jack into which the plug 23 is inserted.

The multiplexed data interface 22 receives the signal (the command or the like) transmitted from the jack device including the jack into which the plug 23 is inserted (for example, the host device 10), and performs a predetermined process on the received signal.

The plug 23 is inserted into the jack of the jack device.

In the input device 20, the analog sound interface 21 is not mandatory.

Here, the host device 10 includes the multiplexed data interface 13 and thus can deal with the digital multiplexed data as will be described later, and the input device 20 includes the multiplexed data interface 22 and thus can also deal with the digital multiplexed data as will be described later.

If the jack device and the plug device capable of dealing with the digital multiplexed data are referred to as associated devices, and both the host device 10, and the input device 20 are associated devices.

Hereinafter, in order to facilitate description, a description of an exemplary detailed configuration of the host device 10 and the input device 20 will proceed with an example in which a smartphone having a function of a device that processes an sound signal such as a music player or a telephone is employed as the host device 10, and a headset connected to the host device 10 of the smartphone is employed as the input device 20.

<First Exemplary Detailed Configuration of Host Device 10 and Input Device 20>

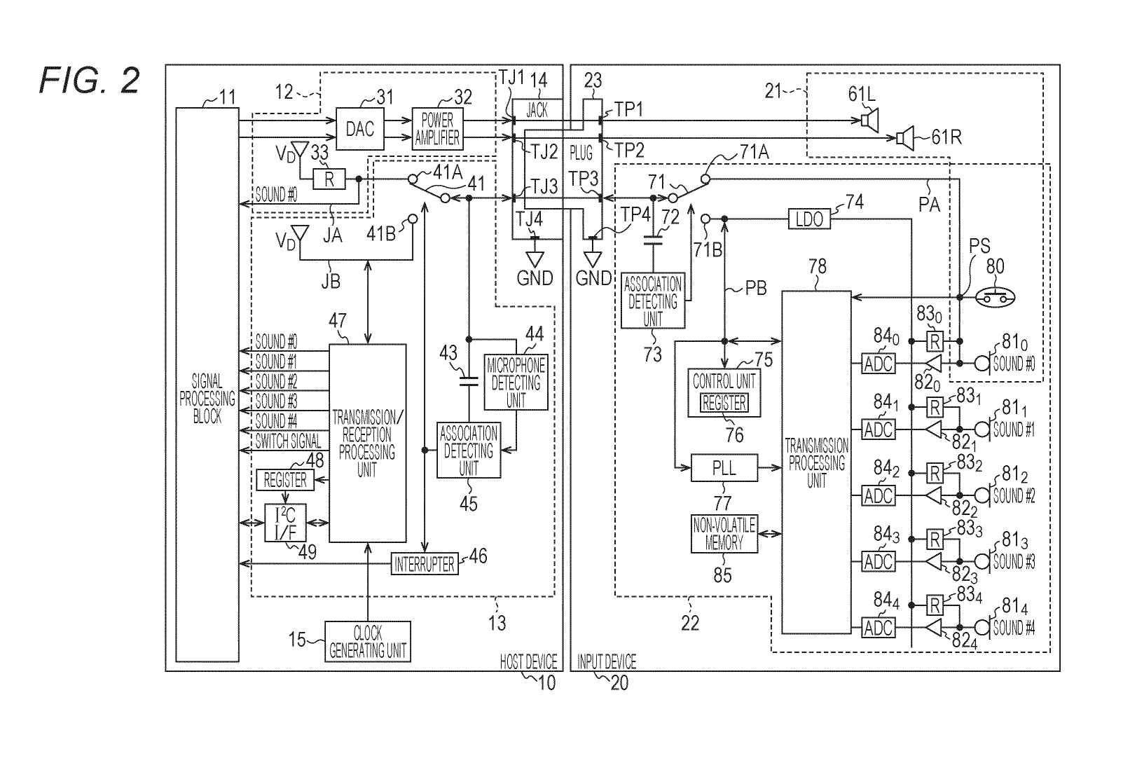

FIG. 2 is a block diagram illustrating a first exemplary detailed configuration of the host device 10 and the input device 20.

Hereinafter, for example, a 4-pole jack and a 4-pole plug are assumed to be employed as the jack 14 and the plug 23.

In other words, the jack 14 includes two (stereo) sound signal terminals TJ1 and TJ2, one microphone terminal TJ3, and one ground terminal TJ4, and the plug 23 includes two sound signal terminals TP1 and TP2, one microphone terminal TP3, and one ground terminal TP4.

The sound signal terminals TJ1, TJ2, TP1, and TP2 are terminals for exchanging analog sound signals of two channels. The sound signal terminals TJ1 and TP1 are L (Left) channel terminals, and the sound signal terminals TJ2 and TP2 are R (Right) channel terminals.

In other words, the sound signal terminal TJ1 is a terminal that outputs the L channel sound signal, and the sound signal terminal TJ2 is a terminal that outputs the R channel sound signal. The sound signal terminal TP1 is a terminal that is supplied with the L channel sound signal, and the sound signal terminal TP2 is a terminal that is supplied with the R channel sound signal.

The microphone terminals TJ3 and TP3 are terminals for exchanging the analog sound signal obtained from a microphone (one of microphones 81₀ to 81₄ (which will be described later), for example, a microphone 81₀).

The ground terminals TJ4 and TP4 are terminals connected to the ground (GND).

When the plug 23 is inserted into the jack 14, the sound signal terminals TJ1 and TP1 are connected to each other, the sound signal terminals TJ2 and TP2 are connected to each other, the microphone terminals TJ3 and TP3 are connected to each other, and the ground terminals TJ4 and TP4 are connected to each other.

Here, as the existing headset, there are a driver (headphone driver) (for example, a transducer that is configured with a coil, a vibrating plate, and the like and converts a sound signal into a sound (sound wave) serving as air vibrations) (which is also referred to as a “speaker”) serving as a sound output unit that outputs sounds of L and R channels and a headset that includes a microphone and a 4-pole plug.

The same plug as the 4-pole plug installed in the existing headset may be employed as the plug 23, and a 4-pole jack corresponding to the 4-pole plug installed in the existing headset may be employed as the jack 14.

In this case, the plug 23 can be inserted into a jack (4-pole jack) of a jack device such as an existing music player in which an existing 4-pole headset (including a plug) can be used. A plug (4-pole plug) of an existing 4-pole headset can be inserted into the jack 14.

When the plug 23 is inserted into a 3-pole jack including no microphone terminal corresponding to the microphone terminal TJ3, the sound signal terminals TP1 and TP2 of the plug 23 are connected with the sound signal terminal of the 3-pole jack, the ground terminal TP4 of the plug 23 is connected with the ground terminal of the 3-pole jack, and the microphone terminal TJ3 of the plug 23 is configured not to cause the terminals to be short-circuited. The same applies to the jack 14.

The plug 23 is neither limited to the same plug as the 4-pole plug installed in the existing headset nor the 4-pole plug. In other words, for example, a 3-pole plug including one (monaural) sound signal terminal TP1, one microphone terminal TP3, and one ground terminal TP4 and a 5- or more pole plug including a separate microphone terminal or a terminal for a predetermined signal in addition to two sound signal terminals TJ1 and TJ2, one microphone terminal TJ3, and one ground terminal TJ4 may be employed as the plug 23. Here, since a plug including many poles (terminals) has a complicated configuration, for example, a 4-, 5-, or 6-pole plug that is not extremely large in the number of poles can be employed as the plug 23.

The above points are similarly applied to the jack 14.

Here, in FIG. 2, in order to simplify the drawing, the 4-pole plug 23 is installed directly in the main body of the input device 20, but the 4-pole plug 23 may be connected to the main body of the input device 20 via a 4-core cable.

In the host device 10 serving as the smartphone, the analog sound interface 12 includes a digital-to-analog converter (DAC) 31, a power amplifier (a headphone amplifier) 32, and a resistor (R) 33.

The digital sound signals of the L and R channels, that is, for example, a sound signal of a song reproduced in the host device 10 serving as the music player or a sound signal of a voice of a phone call counterpart received by the host device 10 serving as the telephone are supplied from the signal processing block 11 to the DAC 31.

The DAC 31 performs DA conversion on the digital sound signals of the L and R channels received from the signal processing block 11 to obtain the analog sound signals of the L and R channels, and supplies analog sound signals of the L and R channels to the power amplifier 32.

The power amplifier 32 amplifies the analog sound signals of the L and R channels received from the DAC 31 as necessary, and outputs the amplified analog sound signals of the L and R channels to the sound signal terminal TJ1 and TJ2 of the jack 14.

When the plug 23 is inserted into the jack 14, the sound signal terminals TJ1 and TP1 are connected to each other, and the sound signal terminals TJ2 and TP2 are connected to each other as described above, and thus the analog sound signals of the L and R channels output to the sound signal terminal TJ1 and TJ2 of the jack 14 are output to the sound signal terminals TP1 and TP2 of the plug 23, respectively.

One end of the resistor 33 is connected to a power source V_{D}, and the other end of the resistor 33 is connected to a terminal 41A of a switch 41.

In the host device 10 serving as the smartphone, the multiplexed data interface 13 includes a switch 41, a capacitor 43, a microphone detecting unit 44, an association detecting unit 45, an interrupter 46, a transmission/reception processing unit 47, a register 48, and an I²C interface (I/F) 49.

The switch 41 includes terminals 41A and 41B, and is connected to the microphone terminal TJ3 of the jack 14. The switch 41 connects the microphone terminal TJ3 of the jack 14 with the terminal 41A or 41B by selecting the terminal 41A or 41B.

The switch 41 selects the terminal 41A of the terminals 41A and 41B in a default state, that is, an initial state, a standby state, a state in which nothing is inserted in the jack 14, and a state in which the switch 41 does not perform switching to select the terminal 41B.

The other end of the resistor 33 is connected to the terminal 41A as described above, and a sound signal line JA serving as a signal line for receiving an analog sound signal #0 output from the microphone 81₀ which will be described later is connected to the terminal 41A.

The sound signal line JA connects the terminal 41A with the signal processing block 11, and when the switch 41 selects the terminal 41A (eventually, the sound signal line JA connected to the terminal 41A), the signal processing block 11 is connected to the microphone terminal TJ3 of the jack 14 via the sound signal line JA connected to the terminal 41A and the switch 41.

The other end of the resistor 33 whose one end is connected to the power source V_{D} is also connected to the terminal 41A as described above, and when the switch 41 selects the terminal 41A, the power source V_{D} is also connected to the microphone terminal TJ3 of the jack 14 via the resistor 33 and the switch 41.

A multiplexed data signal line JB for receiving the multiplexed data transmitted from the input device 20 is connected to the terminal 41B.

In addition to the terminal 41B, the power source V_{D} and the transmission/reception processing unit 47 are connects to the multiplexed data signal line JB, and thus when the switch 41 selects the terminal 41B (eventually, the multiplexed data signal line JB connected to the terminal 41B), the power source V_{D} and the transmission/reception processing unit 47 are connected to the microphone terminal TJ3 of the jack 14 via the multiplexed data signal line JB and the switch 41.

One end of the capacitor 43 is connected to the microphone terminal TJ3 of the jack 14, the other end of the capacitor 43 is connected to the association detecting unit 45, and the capacitor 43 cuts off a direct current (DC) component of a signal passing through the capacitor 43.

The microphone detecting unit 44 monitors a voltage of the microphone terminal TJ3 of the jack 14.

When the plug 23 is inserted into the jack 14, the microphone terminals TJ3 and TP3 are connected, the microphone 81₀ of the input device 20 is connected to the power source V_{D} via a switch 71, the microphone terminal TP3 of the plug 23, the microphone terminal TJ3 of the jack 14, the switch 41, and the resistor 33.

In this case, the microphone 81₀ of the input device 20 functions as a DC resistor (component) of several k ohms for the host device 10, and the voltage of the microphone terminal TJ3 of the jack 14 changes. Based on the change in the voltage, the microphone detecting unit 44 detects that the microphone has been connected, that is, that (the plug of) the plug device including the microphone such as the headset including the 4-pole plug has been inserted into the jack 14. The microphone detecting unit 44 may detect that the microphone has been connected based on a change in a signal rather than a voltage such as a change in an electric current flowing to the microphone terminal TJ3 in addition to the change in the voltage of the microphone terminal TJ3.

Upon detecting that the microphone has been connected, the microphone detecting unit 44 supplies a microphone detection signal indicating the detection of the microphone to the association detecting unit 45.

When the microphone detection signal is supplied from the microphone detecting unit 44, that is, when the plug of the plug device including the microphone is inserted into the jack 14, the association detecting unit 45 outputs a handshake signal for detecting whether or not the plug device is the associated device.

The handshake signal output from the association detecting unit 45 is supplied to the microphone terminal TJ3 of the jack 14 via the capacitor 43.

Here, for example, a sine wave of several tens to several hundreds of kHz can be employed as the handshake signal.

After the microphone detection signal is supplied from the microphone detecting unit 44, and the handshake signal is output as described above, when a predetermined signal responding to the handshake signal is received from the microphone terminal TJ3 of the jack 14 via the capacitor 43, the association detecting unit 45 detects the plug device whose plug is inserted into the jack 14 to be the associated device.

When the plug device whose plug is inserted into the jack 14 is detected to be the associated device, the association detecting unit 45 switches the switch 41 selecting the terminal 41A to select the terminal 41B, and supplies information indicating switching of the switch 41 to the interrupter 46.

When information indicating that the switch 41 has been switched to select the terminal 41B is supplied from the association detecting unit 45, the interrupter 46 supplies information indicating that (the plug of) the associated device has been inserted into the jack 14 to the signal processing block 11.

Here, when the information indicating that the switch 41 has been switched to select the terminal 41B is supplied from the association detecting unit 45 to the interrupter 46, the interrupter 46 supplies the information indicating that the associated device has been inserted into the jack 14 to the signal processing block 11, but it may be inquired about whether or not the associated device has been inserted into the jack 14 by performing polling at regular intervals (at irregular intervals) from the signal processing block 11 to the interrupter 46.

When the information indicating that the associated device has been inserted into the jack 14 is supplied from the interrupter 46, the signal processing block 11 performs signal processing for the associated device.

The clock is supplied from the clock generating unit 15 to the transmission/reception processing unit 47, and the transmission/reception processing unit 47 operates in synchronization with the clock supplied from the clock generating unit 15.

Then, when the switch 41 selects the terminal 41B, the transmission/reception processing unit 47 receives the multiplexed data supplied via the microphone terminal TJ3 of the jack 14, the switch 41, and the multiplexed data signal line JB.

The transmission/reception processing unit 47 performs an appropriate process such as a process of demultiplexing (deserializing) (demodulating) the multiplexed data, and separates original data included in the multiplexed data, for example, digital sound signals #0, #1, #2, #3, and #4 and additional data.

Here, in the present embodiment, for example, the digital sound signals #0, #1, #2, #3, and #4, and additional data are included in the multiplexed data.

Each of the digital sound signals #0, #1, #2, #3, and #4 is the digital sound signal corresponding to the sound collected by the microphone 81₀, 81₁, 81₂, 81₃, and 81₄ which will be described later.

The additional data includes a switch (SW) signal indicating an operation of a switch 80 which will be described later, device information which will be described later, and other data.

The transmission/reception processing unit 47 supplies the digital sound signals #0, #1, #2, #3, and #4 and the switch signal included in the additional data to the signal processing block 11, supplies the device information and the other data included in the additional data to the register 48, and supplies the device information and the other data included in the additional data to the signal processing block 11 via the I²C interface 49.

Here, the signal processing block 11 can perform various signal processing according to the device information using the digital sound signals #0, #1, #2, #3, and #4 and the switch signal supplied from the transmission/reception processing unit 47 or data (information) supplied via the I²C interface 49 as necessary.

In other words, for example, the signal processing block 11 may perform a noise cancellation (NC) process (which will be described later) on the sound signal of the song supplied to the DAC 31 as the signal processing according to the device information using the digital sound signals #1 to #4. Further, for example, the signal processing block 11 may perform a beam forming process or the like as the signal processing according to the device information using the digital sound signals #01 to #4.

When the switch 41 selects the terminal 41B, the transmission/reception processing unit 47 not only receives the multiplexed data as described above but also transmits a command on the associated device to the plug device serving as the associated device whose plug is inserted into the jack 14 via the multiplexed data signal line JB, the switch 41, and the microphone terminal TJ3 of the jack 14 according to a request supplied from the signal processing block 11 via the I²C interface 49.

The register 48 temporarily stores the device information and the like supplied from the transmission/reception processing unit 47.

The I²C interface 49 function as an interface that connects the transmission/reception processing unit 47 with the signal processing block 11 according to an inter-integrated circuit (I²C) specification.

In the input device 20 serving as the headset, the analog sound interface 21 includes drivers 61L and 61R, a switch (button) 80, and the microphone 81₀.

The drivers 61L and 61R are drivers (headphone driver) (for example, transducers that are configured with a coil, a vibrating plate, and the like and converts a sound signal into a sound (sound wave) serving as air vibrations), and outputs (emits) the sounds corresponding to the sound signals supplied from the sound signal terminals TP1 and TP2 of the plug 23, respectively.

As described above, when the plug 23 is inserted into the jack 14, the sound signal terminals TJ1 and TP1 are connected, the sound signal terminals TJ2 and TP2 are connected, and, for example, the sound signal of the song or the like reproduced in the host device 10 is output from the signal processing block 11 to the sound signal terminals TP1 and TP2 of the plug 23 via the DAC 31, the power amplifier 32, and the jack 14.

As a result, the sounds corresponding to the sound signals of the song or the like reproduced in the host device 10 are output from the drivers 61L and 61R.

The switch 80 is operated by the user, and changes a switch signal (an impedance of the switch 80 seen from a connect point PS) serving as a voltage of the connect point PS connected to the switch 80 when operated and when not operated. The switch signal (an H or L level) of the switch 80 is supplied to a terminal 71A of the switch 71 and a transmission processing unit 78.

The microphone 81₀ is a transducer that converts a sound (sound wave) serving as a physical quantity into a sound signal serving as an electric signal, and outputs an analog sound signal corresponding to a sound input to the microphone 81₀.

Here, for example, the microphone 81₀ can be used as a voice microphone that is intended to collect the voice of the user wearing the input device 20 serving as the headset.

An output terminal of the microphone 81₀ is connected to an amplifier 82₀, a resistor (R) 83₀, and a connect point PS to which the switch signal of the switch 80 is output, and the connect point PS is connected to the terminal 71A of the switch 71.

Thus, the switch signal of the switch 80 is superimposed on the analog sound signal output from the microphone 81₀ at the connect point PS, and then the resultant signal is supplied to the terminal 71A of the switch 71.

The switch 80 and the microphone 81₀ configure the analog sound interface 21 as described above and configure the multiplexed data interface 22 as well as will be described later.

In the input device 20 serving as the headset, the multiplexed data interface 22 includes the switch 71, a capacitor 72, an association detecting unit 73, a low drop-out regulator (LDO) 74, a control unit 75, a phase lock loop (PLL) 77, the transmission processing unit 78, the switch 80, the microphones 81₀, 81₁, 81₂, 81₃, and 81₄, amplifiers 82₀, 82₁, 82₂, 82₃, and 82₄, resistors 83₀, 83₁, 83₂, 83₃, and 83₄, analog-to-digital converters (ADCs) 84₀, 84₁, 84₂, 84₃, and 84₄, and non-volatile memory 85.

The switch 71 includes terminals 71A and 71B and is connected to the microphone terminal TP3 of the plug 23. The switch 71 connects the microphone terminal TP3 of the plug 23 with the terminal 71A or 71B by selecting the terminal 71A or 71B.

The switch 71 selects the terminal 71A of the terminals 71A and 71B in the default state.

A sound signal line PA serving as the signal line for transmitting the analog sound signal #0 output from the microphone 81₀ is connected to the terminal 71A.

The sound signal line PA connects the terminal 71A with the connect point PS, and when the switch 71 selects the terminal 71A (eventually, the sound signal line PA connected to the terminal 71A), the connect point PS is connected to the microphone terminal TP3 of the plug 23 via the sound signal line PA connected to the terminal 71A, and the switch 71.

Thus, the analog sound signal output from the microphone 81₀ on which the switch signal of the switch 80 is superimposed at the connect point PS is output to the microphone terminal TP3 of the plug 23 via the sound signal line PA and the switch 71 selecting the terminal 71A.

A multiplexed data signal line PB for transmitting the multiplexed data output from the transmission processing unit 78 to the host device 10 is connected to the terminal 71B.

In addition to the terminal 71B, the control unit 75, the PLL 77, and the transmission processing unit 78 are connected to the multiplexed data signal line PB, and thus, when the switch 71 selects the terminal 71B (eventually, the multiplexed data signal line PB connected to the terminal 71B), the control unit 75, the PLL 77, and the transmission processing unit 78 are connected to the microphone terminal TP3 of the plug 23 via the multiplexed data signal line PB and the switch 71.

In addition to the multiplexed data signal line PB, the LDO 74 is connected to the terminal 71B, and when the switch 71 selects the terminal 71B, the LDO 74 is also connected to the microphone terminal TP3 of the plug 23 via the switch 71.

One end of the capacitor 72 is connected to the microphone terminal TP3 of the plug 23, and the other end of the capacitor 72 is connected to the association detecting unit 73, and the capacitor 72 cuts off a DC component of a signal passing through the capacitor 72.

Upon receiving the handshake signal from the microphone terminal TP3 of the plug 23 via the capacitor 72, the association detecting unit 73 detects the jack device including the jack into which the plug 23 is inserted to be the associated device.

When the jack device including the jack into which the plug 23 is inserted is detected to be the associated device, the association detecting unit 73 switches the switch 71 selecting the terminal 71A to select the terminal 71B, and in order to report the fact that the input device 20 is the associated device to the jack device including the jack into which the plug 23 is inserted, the handshake signal having the same or different frequency as the received handshake signal is output to the microphone terminal TP3 of the plug 23 via the capacitor 72.

The LDO 74 is a voltage regulator, and generates a predetermined voltage from the signal supplied from the microphone terminal TP3 of the plug 23 via the switch 71, supplies electric power serving as a power source to the amplifier 82ᵢ and the like via the resistor 83ᵢ, and supplies electric power to the control unit 75, the transmission processing unit 78, the ADC 84ᵢ, and blocks of the multiplexed data interface 22 that need electric power.

Thus, the multiplexed data interface 22 of the input device 20 operates by the electric power serving as the power source supplied from (the power source V_{D} of) the host device 10.

The signal lines used for the LDO 74 to supply the electric power serving as the power source to the respective blocks are appropriately omitted in order to avoid complicated illustration.

The control unit 75 includes a register 76 therein, and performs a process according to a storage value of the register 76.

The control unit 75 performs writing of data in the register 76, reading of data from the register 76 and the non-volatile memory 85, and other processes according to the signal (command) supplied from the microphone terminal TP3 of the plug 23 via the switch 71 (selecting the terminal 71B) and the multiplexed data signal line PB.

Here, in reading of data from the register 76, the control unit 75 reads data from the register 76, and supplies the read data to the transmission processing unit 78. In the transmission processing unit 78, data from the control unit 75 is included in the multiplexed data and transmitted from the microphone terminal TP3 of the plug 23 via the multiplexed data signal line PB, and the switch 71.

In reading of data from the non-volatile memory 85, the control unit 75 controls the transmission processing unit 78 such that data is read from the non-volatile memory 85, included in the multiplexed data, and transmitted from the microphone terminal TP3 of the plug 23 via the multiplexed data signal line PB and the switch 71.

In addition, the control unit 75 controls the necessary block of the input device 20 as necessary. The signal line for controlling the necessary block through the control unit 75 is appropriately omitted in order to avoid complicated illustration.

When the switch 71 selects the terminal 71B, the signal from the jack device including the jack (the associated device) into which the plug 23 is inserted is supplied to the PLL 77 via the microphone terminal TP3 of the plug 23, the switch 71, and the multiplexed data signal line PB.

The PLL 77 generates the clock synchronized with the signal supplied via the microphone terminal TP3 of the plug 23, the switch 71, and the multiplexed data signal line PB, and supplies the generated clock to the transmission processing unit 78 and any other necessary block.

The switch signal (the H or L level indicating whether or not the switch 80 has been operated) from the switch 80 is supplied to the transmission processing unit 78, and, for example, the sound signal #i serving as a 1-bit digital signal of a sound collected by the microphone 81ᵢ is supplied from the ADC 84ᵢ (i=0, 1, 2, 3, and 4).

The transmission processing unit 78 operates in synchronization with the clock supplied from the PLL 77, performs (time division) multiplexing (serializing) (modulation) on the switch signal supplied from the switch 80, the digital sound signal #i supplied from the ADC 84ᵢ, the data read from the register 76, and the data (the device information) read from the non-volatile memory 85, performs any other necessary process, and transmits the resultant multiplexed data from the microphone terminal TP3 of the plug 23 via the multiplexed data signal line PB and the switch 71.

Here, the multiplexed data includes the digital sound signals #0, #1, #2, #3, and #4 and the additional data as described above. The switch signal, the data read from the register 76, and the data read from the non-volatile memory 85 are the additional data.

The microphone 81ᵢ is a transducer that converts a sound (sound wave) serving as a physical quantity into a sound signal serving as an electric signal, and outputs the analog sound signal #i corresponding to a sound #i input to the microphone 81ᵢ.

Here, for example, the microphone 81₀ can be used as a voice microphone that is intended to collect the voice of the user wearing the input device 20 serving as the headset.

For example, the microphones 81₁ to 81₄ can be used as an NC microphone that is intended to collect a sound such as a noise and used for an NC process performed by the signal processing block 11 of the host device 10.

The analog sound signal #i output from the microphone 81ᵢ is supplied to the amplifier 82ᵢ.

The amplifier 82ᵢ amplifies the analog sound signal #i output from the microphone 81ᵢ, and supplies the analog sound signal #i to the ADC 84ᵢ.

The resistor 83ᵢ is connected to between the output terminal of the LDO 74 and a connection point of the microphone 81ᵢ and the amplifier 82ᵢ.

The ADC 84ᵢ performs the AD conversion on the analog sound signal #i supplied from the amplifier 82ᵢ, and supplies the resulting digital sound signal #i to the transmission processing unit 78.

Here, for example, ΔΣ modulation serving as 1-bit AD conversion can be employed as the AD conversion of the ADC 84ᵢ.

The non-volatile memory 85 is, for example, one time programmable (OTP) memory, erasable programmable read only memory (EPROM), or the like, and the non-volatile memory 85 stores the device information.

The device information is information related to the input device 20, and the device information may include a vendor identification (ID) specifying a manufacturing company of the input device 20 or the like or a product ID specifying a model of the input device 20 (an individual) or the like.

The device information may further include configuration function information indicating a configuration, a function, and an intended use of the input device 20.

For example, information indicating that the input device 20 is a headset or the like, the number of transducers such as the number of microphones 81ᵢ installed in the input device 20 can be employed as the configuration function information.

The device information may include process information for causing the signal processing block 11 to perform an optimal (or appropriate) process for the input device 20 when the plug 23 of the input device 20 is inserted into the jack 14 of the host device 10, and the input device 20 is used.

For example, an algorithm of the NC process for performing the optimal NC process for the input device 20 serving as the headset when the NC process is performed by the signal processing block 11 the host device 10 serving as the smartphone functioning as the music player, a filter coefficient of a filter used in the NC process, characteristics of the microphone 81ᵢ and characteristics of the drivers 61L and 61R that can be used to obtain the filter coefficient, and the like can be employed as the process information.

In FIG. 2, one switch 80 is installed in the input device 20, but two or more switches may be installed in the input device 20 (in parallel to the connect point PS). The input device 20 may be configured without the switch.

In FIG. 2, the five microphones 81₀ to 81₄ are installed in the input device 20, but four or less or six or more microphones may be installed in the input device 20.

A transducer that converts a physical quantity into an electric signal rather than a microphone, that is, for example, an acceleration sensor, a touch sensor, a biological sensor that senses a biological physical quantity such as a body temperature or a pulse, or the like may be installed in the input device 20.

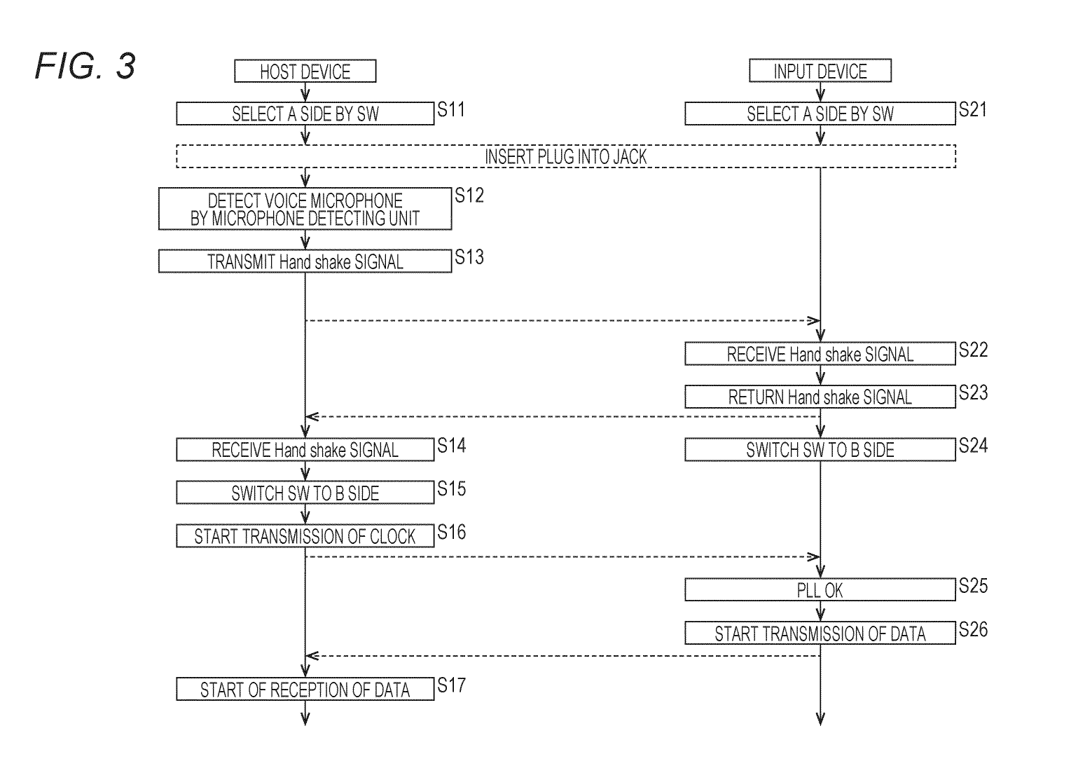

FIG. 3 is a flowchart for describing processes of the host device 10 and the input device 20 of FIG. 2.

In step S11, in the host device 10, the switch 41 selects the terminal 41A in the default state.

On the other hand, in step S21, in the input device 20, the switch 71 selects the terminal 71A in the default state.

Then, when the plug 23 of the input device 20 is inserted into the jack 14 of the host device 10, in step S12, in the host device 10, the microphone detecting unit 44 detects the microphone 81₀ serving as the voice microphone arranged in the input device 20 serving as the plug device including the plug 23 inserted into the jack 14.

In other words, when the plug 23 is inserted into the jack 14, the microphone terminal TJ3 of the jack 14 is connected with the microphone terminal TP3 of the plug 23, and the microphone 81₀ of the input device 20 is connected to the power source V_{D} via the switch 71 (selecting the terminal 71A), the microphone terminal TP3 of the plug 23, the microphone terminal TJ3 of the jack 14, the switch 41 (selecting the terminal 41A), and the resistor 33.

In this case, the microphone 81₀ of the input device 20 functions as a DC resistor (component) of several k ohms for the host device 10, and the voltage of the microphone terminal TJ3 of the jack 14 changes. Based on the change in the voltage, the microphone detecting unit 44 detects that the microphone 81₀ has been connected, eventually, the microphone 81₀.

Upon detecting the microphone 81₀, the microphone detecting unit 44 supplies the microphone detection signal indicating the detection of the microphone 81₀ to the association detecting unit 45.

When the microphone detection signal is supplied from the microphone detecting unit 44, in step S13, the association detecting unit 45 transmits the handshake signal.

The handshake signal transmitted from the association detecting unit 45 arrives at the association detecting unit 73 of the input device 20 via the capacitor 43, the microphone terminal TJ3 of the jack 14, the microphone terminal TP3 of the plug 23, and the capacitor 72.

In step S22, in the input device 20, the association detecting unit 73 receives the handshake signal transmitted from the association detecting unit 45 of the host device 10 as described above.

The association detecting unit 73 receives the handshake signal, and detects (recognizes) the host device 10 serving as the jack device including the jack 14 into which the plug 23 is inserted to be the associated device.

When the host device 10 serving as the jack device including the jack 14 into which the plug 23 is inserted is detected to be the associated device, in step S23, the association detecting unit 73 transmits the handshake signal for informing the jack device including the jack into which the plug 23 is inserted of the fact that the input device 20 is the associated device.

In step S24, the association detecting unit 73 switches the switch 71 selecting the terminal 71A to select the terminal 71B.

When the switch 71 is switched to select the terminal 71B, the microphone terminal TP3 of the plug 23 is connected to the LDO 74 via the switch 71 (selecting the terminal 71B).

Further, the microphone terminal TP3 of the plug 23 is connected to the control unit 75, the PLL 77, and the transmission processing unit 78 via the switch 71 and the multiplexed data signal line PB.

The handshake signal transmitted from the association detecting unit 73 in step S23 arrives at the association detecting unit 45 of the host device 10 via the capacitor 72, the microphone terminal TP3 of the plug 23, the microphone terminal TJ3 of the jack 14, and the capacitor 43.

In step S14, in the host device 10, the association detecting unit 45 receives the handshake signal transmitted from the association detecting unit 73 of the input device 20 as described above.

The association detecting unit 45 receives the handshake signal, and detects (recognizes) the input device 20 serving as the plug device including the plug 23 inserted into the jack 14 to be the associated device.

When the input device 20 serving as the plug device including the plug 23 inserted into the jack 14 is detected to be the associated device, the association detecting unit 45 switches the switch 41 selecting the terminal 41A to select the terminal 41B, and supplies information indicating the switching of the switch 41 to the interrupter 46.

When the information indicating that the switch 41 has been switched to select the terminal 41B is supplied from the association detecting unit 45, the interrupter 46 supplies information indicating that (the plug of) the associated device has been inserted into the jack 14 to the signal processing block 11.

When the information indicating that the associated device has been inserted into the jack 14 is supplied from the interrupter 46, the signal processing block 11 starts the signal processing for the associated device.

Further, when the switch 41 is switched to select the terminal 41B, the microphone terminal TJ3 of the jack 14 is connected to the transmission/reception processing unit 47 and the power source V_{D} via the switch 41 (selecting the terminal 41B) and the multiplexed data signal line JB.

As described above, as the microphone terminal TJ3 of the jack 14 is connected to the power source V_{D} via the switch 41 and the multiplexed data signal line JB, the power source V_{D} is connected to LDO 74 via the multiplexed data signal line JB, the switch 41, and the microphone terminal TJ3 of the jack 14 of the host device 10 and the microphone terminal TP3 of the plug 23 and the switch 71 (selecting the terminal 71B) of the input device 20.

As described above, when the power source V_{D} of the host device 10 is connected to the LDO 74 of the input device 20, the LDO 74 is supplied with electric power from the power source V_{D}, and starts to supply the electric power serving as the power source to the block needing electric power such as the amplifier 82ᵢ of the input device 20.

Further, when the microphone terminal TJ3 of the jack 14 is connected to the transmission/reception processing unit 47 via the switch 41 and the multiplexed data signal line JB, in step S16, the transmission/reception processing unit 47 starts to transmit (the signals including) the clock in synchronization with the clock supplied from the clock generating unit 15.

The clock transmitted from the transmission/reception processing unit 47 arrives at the PLL 77 via the multiplexed data signal line JB, the switch 41, the microphone terminal TJ3 of the jack 14, the microphone terminal TP3 of the plug 23, the switch 71, and the multiplexed data signal line PB.

In step S25, the PLL 77 starts to operate according to the clock transmitted from the transmission/reception processing unit 47 as described above, and when the PLL 77 enters a so-called lock state, the PLL 77 supplies the clock synchronized with the clock supplied from the transmission/reception processing unit 47 to the control unit 75, the transmission processing unit 78, or the like.

In step S26, the transmission processing unit 78 starts to operate in synchronization with the clock supplied from the PLL 77, and starts a process of multiplexing the switch signal supplied from the switch 80, the digital sound signal #i supplied from the ADC 84ᵢ, the data read from the register 76, and the data read from the non-volatile memory 85 and transmitting the resulting multiplexed data to the transmission/reception processing unit 47 via the multiplexed data signal line PB, the switch 71, the microphone terminal TP3 of the plug 23, the microphone terminal TJ3 of the jack 14, the switch 41, and the multiplexed data signal line JB.

In step S17, the transmission/reception processing unit 47 starts to receive the multiplexed data transmitted from the transmission processing unit 78 as described above.

As described above, the input device 20 detects whether or not the jack device including the jack into which the plug 23 is inserted is the associated device capable of dealing with the multiplexed data, and when the jack device is the associated device, the multiplexed data is transmitted via the plug 23. On the other hand, the host device 10 detects whether or not the plug device including the plug inserted into the jack 14 is the associated device, and when the plug device is the associated device, the multiplexed data transmitted from the plug device serving as the associated device is received via the jack 14. Thus, transmission and reception of the multiplexed data from the input device 20 serving as the plug device serving as the associated device to the host device 10 serving as the jack device serving as the associated device can be easily performed.

In other words, it is possible to include, for example, the sound signals #0 to #4 that are output from the five microphones 81₀ to 81₄ and serve as the signals output from a plurality of transducers in the multiplexed data and transceive the resultant multiplexed data using one microphone terminals TJ3 and TP3 without increasing the number of terminals of the jack 14 and the plug 23.

The host device 10 detects whether or not the plug device including the plug inserted into the jack 14 is the associated device, and when the plug device is the associated device, the switch 41 selecting the terminal 41A is switched to select the terminal 41B, and thus when the plug device is not the associated device, the switch 41 selecting the terminal 41A remains in the state in which the terminal 41A is selected.

As a result, the host device 10 has so-called backward compatibility capable of using the existing headset even when the existing headset including the microphone which is the existing plug device including the 4-pole plug that is not the associated device is connected as well as when (the plug 23 of) the input device 20 which is the associated device is connected (to the jack 14).

Similarly, the input device 20 detects whether or not the jack device including the jack into which the plug 23 is inserted is the associated device, and when the jack device is the associated device, the switch 71 selecting the terminal 71A is switched to select the terminal 71B, and thus when the jack device is not the associated device, the switch 71 selecting the terminal 71A remains in the state in which the terminal 71A is selected.

As a result, the input device 20 has backward compatibility capable of using the existing smartphone even when the input device 20 is connected to, for example, the existing smartphone serving as the existing jack device including the 4-pole jack which is not the associated device as well as when (the plug 23 of) the input device 20 is connected to (the jack 14 of) the host device 10 which is the associated device.

Here, the host device 10 can be fictitiously recognized as the existing smartphone or the like by disabling the multiplexed data interface 13.

In the host device 10 that is fictitiously recognized as the existing smartphone, the switch 41 remains in the default state, that is, in the state in which the terminal 41A connected to the sound signal line JA is selected, and the microphone terminal TJ3 of the jack 14 remains in the state in which it is connected to the sound signal line JA to which the resistor 33 and the signal processing block 11 are connected.

Further, the input device 20 can be fictitiously recognized as the existing 4-pole headset including the microphone or the like by disabling the multiplexed data interface 22 (here, excluding the switch 80 and the microphone 81₀ configuring the analog sound interface 21).

In the input device 20 that is fictitiously recognized as the existing headset, the switch 71 remains in the default state, that is, the state in which the terminal 71A connected to the sound signal line PA is selected, and the microphone terminal TP3 of the plug 23 remains in the state in which is connected to the sound signal line PA connected to the connect point PS with which the switch 80 and the microphone 81₀ are connected.

The following description will proceed with the case in which (the input device 20 fictitiously recognized as) the existing headset that is not the associated device is connected to the host device 10 serving as the associated device and the case in which the input device 20 serving as the associated device is connected to (the host device 10 fictitiously recognized as) the existing smartphone that is not the associated device.

Further, the case in which (the plug 23 of) the input device 20 serving as the associated device is connected to (inserted into) (the jack 14 of) the host device 10 serving as the associated device, that is, the case in which the process described with reference to FIGS. 2 and 3 is performed between the host device 10 and the input device 20 is hereinafter referred to as a “standard case.”

First, when the input device 20 fictitiously recognized as the existing headset is connected to the host device 10 serving as the associated device, in the host device 10, similarly to the standard case, the microphone 81₀ is detected in the microphone detecting unit 44, and the handshake signal is transmitted from the association detecting unit 45.

The handshake signal from the association detecting unit 45 arrives at the association detecting unit 73 of the input device 20 via the capacitor 43, the microphone terminal TJ3 of the jack 14, the microphone terminal TP3 of the plug 23, and the capacitor 72, but in this case, since the multiplexed data interface 22 does not operate in the input device 20 fictitiously recognized as the existing headset, the association detecting unit 73 does not return the handshake signal, unlike the standard case.

As a result, since the association detecting unit 45 hardly receives the handshake signal, the association detecting unit 45 detects (recognizes) the input device 20 fictitiously recognized as the existing headset to be not the associated device.

In this case, the association detecting unit 45 maintain the state in which the terminal 41A is selected without switching the switch 41 selecting the terminal 41A, and thus the terminal TJ3 of the jack 14 is connected to (remains in the connected state to) the power source V_{D} and the sound signal line JA via the switch 41 (selecting the terminal 41A) and the resistor 33.

On the other hand, in the input device 20 fictitiously recognized as the existing headset, since the switch 71 keep selecting the terminal 71A to which the sound signal line PA is connected, the microphone terminal TP3 of the plug 23 remains connected to the sound signal line PA connected to the connect point PS to which the switch 80 and the microphone 81₀ are connected.

Thus, a voltage by the power source V_{D} is applied to the path of the sound signal line JA, the switch 41, the microphone terminal TJ3 of the jack 14, the microphone terminal TP3 of the plug 23, the switch 71, and the sound signal line PA via the resistor 33 for preventing an overcurrent.

Then, the analog sound signal #0 output from the microphone 81₀ is supplied to the signal processing block 11 via the connect point PS, the sound signal line PA, the switch 71, the microphone terminal TP3 and TJ3, the switch 41, and the sound signal line JA.

The signal processing block 11 performs the signal processing such as the AD conversion on the analog sound signal #0 that is output from the microphone 81₀ and supplied as described above as necessary, and transmits the signal processing result, for example, as a voice of a telephone call (call transmission).

Further, the switch signal output from the switch 80 is supplied to the signal processing block 11 via the connect point PS, the sound signal line PA, the switch 71, the microphone terminal TP3 and TJ3, the switch 41, and the sound signal line JA in the form in which the switch signal is superimposed on the analog sound signal #0 output from the microphone 81₀.

The signal processing block 11 detects the switch signal, that is, detects an operation of the switch 80 based on the DC component of the analog sound signal #0 supplied via the sound signal line JA, and performs signal processing according to the operation of the switch 80.

The sound signal of the song reproduced in the host device 10, the sound signal of the voice received by the host device 10 serving as the telephone, or the like is supplied to the analog sound interface 21 of the input device 20 fictitiously recognized as the existing headset via the analog sound interface 12 of the host device 10, the sound signal terminal TJ1 and TJ2 of the jack 14, and the sound signal terminals TP1 and TP2 of the plug 23. Then, in the analog sound interface 21, the sound signal of the song reproduced in the host device 10 or the sound corresponding to the sound signal of the voice or the like received by the host device 10 serving as the telephone is output from the drivers 61L and 61R.

When (the input device 20 fictitiously recognized as) the existing 4-pole headset including the microphone is connected to the host device 10 serving as the associated device as described above, as the switch 41 enters the state in the terminal 41A is selected, the existing 4-pole headset including the microphone can be used without limiting the function thereof, similarly to when it is connected to the existing smartphone or the like. Thus, the host device 10 serving as the associated device has backward compatibility.

The input device 20 is configured with the analog sound interface 21 and the plug 23 including no microphone terminal TP3 and thus can be fictitiously recognized as the existing headphone including the 3-pole plug, but when the existing headphone is connected to the host device 10 serving as the associated device, the existing headphone can be used, similarly to when it is connected to the existing music player including the 3-pole jack or the like.

Then, when the input device 20 serving as the associated device is connected to the host device 10 fictitiously recognized as the existing smartphone, no handshake signal is transmitted from the host device 10 fictitiously recognized as the existing smartphone.

As a result, in the input device 20 serving as the associated device, since the association detecting unit 73 hardly receives the handshake signal, the host device 10 fictitiously recognized as the existing smartphone is not detected to be the associated device.

In this case, the association detecting unit 73 maintain the state in which the terminal 71A is selected without switching the switch 71 selecting the terminal 71A, and thus the terminal TP3 of the plug 23 remains in the state in which it is connected to the sound signal line PA connected to the connect point PS to which the switch 80 and the microphone 81₀ are connected via the switch 71 (selecting the terminal 71A).

On the other hand, in the host device 10 fictitiously recognized as the existing smartphone, since the switch 41 remains in the state in which the terminal 41A is selected, the terminal TJ3 of the jack 14 is connected to (remains in the connected state to) the power source V_{D} and the sound signal line JA via the switch 41 (selecting the terminal 41A) and the resistor 33.

When the input device 20 serving as the associated device is connected to the host device 10 fictitiously recognized as the existing smartphone as described above, the input device 20 is in the same state as when the input device 20 fictitiously recognized as the existing headset is connected to the host device 10 serving as the associated device.

Thus, when the input device 20 serving as the associated device is connected to (the host device 10 fictitiously recognized as) the existing smartphone, the existing smartphone can be used without limiting the function thereof, similarly to when it is connected to the existing headset or the like.

Then, when the input device 20 serving as the associated device is connected to the existing smartphone, the input device 20 serving as the associated device functions as the existing 4-pole headset including the microphone.

When the input device 20 serving as the associated device is connected to (the host device 10 fictitiously recognized as) the existing smartphone as described above, the switch 71 enters the state in which the terminal 71A is selected, and thus the input device 20 serving as the associated device functions as the existing 4-pole headset including the microphone and has backward compatibility.

Further, when the input device 20 serving as the associated device is connected to the existing music player including the 3-pole jack including the sound signal terminals TJ1 and TJ2 and the ground terminal TJ4, the input device 20 serving as the associated device functions as the 3-pole existing headphone.

As described above, the host device 10 and the input device 20 serving as the associated devices can perform transmission and reception of the multiplexed data, and thus signals in which the number of signals is larger than the number of poles can be included in the multiplexed data and transceived between the host device 10 and the input device 20 via the jack 14, and the plug 23 including the limited number of poles (the limited number of terminals).

In other words, for example, the sound signals of the L and R channels, the sound signal (hereinafter, referred to as a “microphone sound signal”) #0 output from the microphone 81₀ serving as the voice (phone call) microphone, the switch signal output from the switch 80, the microphone sound signals #1 to #4 output from the microphones 81₁ to 81₄ that can be used for the NC process or the like, the device information stored in the non-volatile memory 85, and other data can be transceived between the host device 10 and the input device 20 through the 4-pole jack 14 and the 4-pole plug 23.

Specifically, (the microphone sound signals obtained by performing the AD conversion on) the microphone sound signals #0 to #4 output from the microphone 81₀ to 81₄, the switch signal output from the switch 80, and the device information stored in the non-volatile memory 85, and other data are multiplexed into the multiplexed data, and the multiplexed data is transceived via the microphone terminals TJ3 and TP3 serving as one 4-pole terminal, and thus without particularly changing (using, without change,) the sound signal terminals TJ1, TJ2, TP1, and TP2 through which the sound signals (hereinafter, referred to as “speaker sound signals”) of the L and R channels supplied to the drivers 61L and 61R and the ground terminals TJ4 and TP4 connected to the ground, the speaker sound signals of the L and R channels, the microphone sound signals #0 to #4, the switch signal, the device information stored in the non-volatile memory 85, and other data can be transceived between the host device 10 and the input device 20.

Thus, the input device 20 can be regarded as a device that functions as an interface of inputting the microphone sound signals #0 to #4 output from a plurality of microphones 81₀ to 81₄ or the like to the host device 10.

Here, in order to simplify the description, referring to the sound signal among the signals included in the multiplexed data, the analog microphone sound signals #0 to #4 that are output from the five microphones 81₀ to 81₄ and serve as a plurality of sound signals undergo the AD conversion to be converted into the digital microphone sound signals #0 to #4 in the ADC 84₀ to 84₄ and then multiplexed into the multiplexed data.

Meanwhile, as a method of multiplexing a plurality of sound signals, there is a method of multiplexing a plurality of analog sound signals in the analog signal state instead of AD-converting a plurality of analog sound signals into a plurality of digital sound signals and then multiplexing the plurality of digital sound signals.

As a method of multiplexing a plurality of sound signals in the analog signal state and transmitting the multiplexed signal, for example, there is a method of periodically perform sample and hold (S&H) on a plurality of analog sound signals, selecting a sound signals that have undergone the S&H through a switch, and using it as multiplexed data (hereinafter, also referred to as a “switch+S&H technique”).

However, in the switch+S&H technique, since the S&H is periodically performed on a plurality of sound signals, it is difficult to perform the S&H of the sound signals of the same time on each of a plurality of sound signals. Thus, for example, when the signal processing such as the beam forming is performed using a plurality of sound signals multiplexed by the switch+S&H technique, since the sound signals of the same time are not included in the multiplexed data for a plurality of sound signals obtained by the microphones arranged at different positions, that is, at the left and right positions, the accuracy of the beam forming may deteriorate.

Further, when a plurality of sound signals are multiplexed in the analog signal state in the input device 20, the host device 10 side needs an ADC that performs the AD conversion on each of the plurality of sound signals.

In addition, in the switch+S&H technique, as described with reference to FIG. 2, compared to when the analog sound signal is AD-converted into one bit through ΔΣ modulation and then multiplexed, the configuration of the host device 10 or the input device 20 is complicated, and it is disadvantageous in terms of power consumption.

In FIG. 2, the host device 10 operates in synchronization with the clock output from the clock generating unit 15. The input device 20 operates in synchronization with the clock that are generated from the PLL 77 in synchronization with the clock output from the clock generating unit 15 of the host device 10.

Thus, the host device 10 and the input device 20 operate in synchronization with each other.

In the input device 20, for example, the ADC 84ᵢ performs the AD conversion using the clock generated from the PLL 77 in synchronization with the clock output from the clock generating unit 15 of the host device 10 as a sampling timing.

In the host device 10, in the state in which the plug 23 is not inserted into the jack 14, the switch 41 can select the terminal 41A. Similarly, in the input device 20, in the state in which the plug 23 is not inserted into the jack, the switch 71 can select the terminal 71A.

In the host device 10, the transmission/reception processing unit 47 can appropriately perform separation (demultiplexing) of the sound signal included in the multiplexed data from the multiplexed data, for example, based on the number of microphones 81ᵢ installed in the input device 20, which is included in the device information.

Further, in the host device 10, the clock generating unit 15 can perform the AD conversion on the sound signals in which the number of sound signal is equal to the number of microphones 81ᵢ based on the number of microphones 81ᵢ installed in the input device 20, which is included in the device information and generate a clock of a sufficient frequency (period) that is necessary for generating the multiplexed data.

Here, in FIG. 2, two-way communication is performed between the host device 10 and the input device 20.

In two-way communication performed between the host device 10 and the input device 20, as data (a signal) transmitted from the input device 20 to the host device 10, for example, there is the multiplexed data. The multiplexed data includes the microphone voice signal #i (the signal (digital signal) output from the transducer when the transducer rather than the microphone 81ᵢ is installed in the input device 20) output from the microphone 81ᵢ, the switch signal output from the switch 80, the device information stored in the non-volatile memory 85, and the like.

In the two-way communication performed between the host device 10 and the input device 20, the data (the signal) transmitted from the host device 10 to the input device 20 includes, for example, the clock generated by the clock generating unit 15, the command on the control unit 75, and the like.

Examples of the command on the control unit 75 include a command to read/write data from/in the register 76 or the non-volatile memory 85, a command to cause the input device 20 to enter a sleep state (for example, a state in which supply of electric power to minimum necessary blocks other than blocks such as the ADC 84ᵢ is stopped), and a command to cause the input device 20 to return (activate) from the sleep state.

Here, since the control unit 75 performs the process according to the storage value of the register 76, a command other than the command to read/write data from/in the register 76 or the non-volatile memory 85, that is, for example, the command to cause the input device 20 to enter the sleep state or the command to cause the input device 20 to return from the sleep state can be given by writing a predetermined value in the register 76 without preparing a dedicated command.

An analog microphone and a digital microphone can be used together as microphones serving as a plurality of transducers installed in the input device 20.

<Second Exemplary Detailed Configuration of Host Device 10 and Input Device 20>

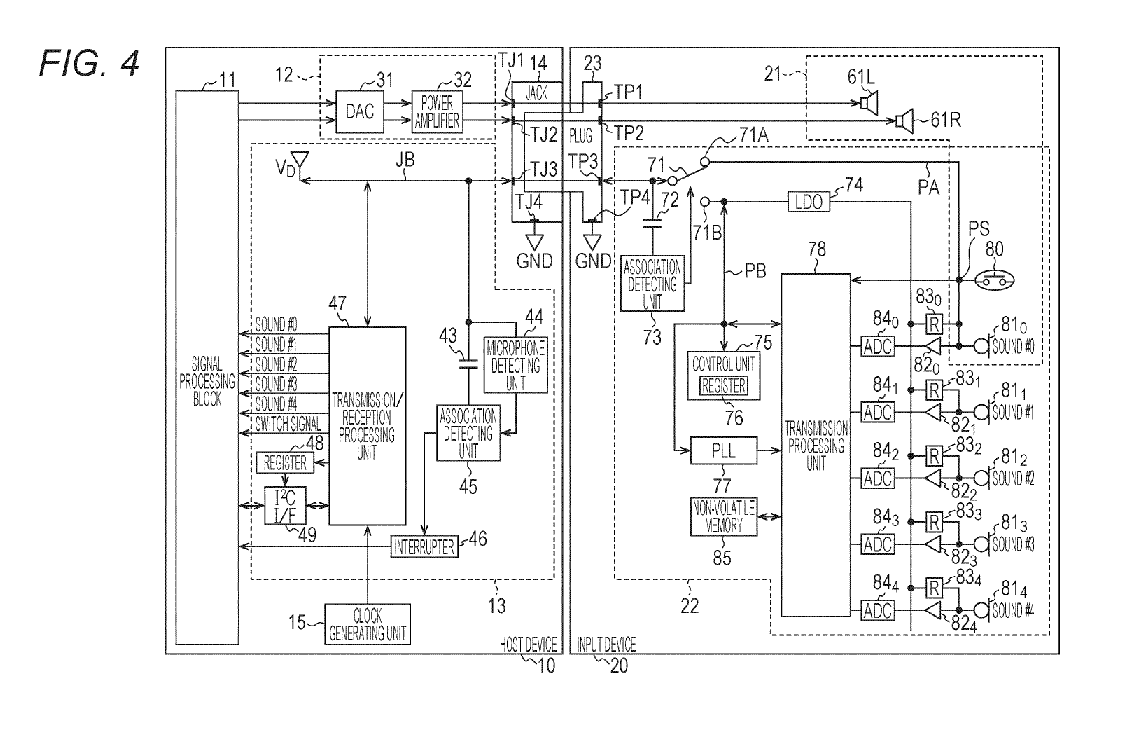

FIG. 4 is a block diagram illustrating a second exemplary detailed configuration of the host device 10 and the input device 20.

In FIG. 4, parts corresponding to those in FIG. 2 are denoted by the same reference numerals, and hereinafter, a description thereof will be appropriately omitted.

In FIG. 4, the input device 20 has a configuration similar to that of FIG. 2.

Referring to FIG. 4, the host device 10 is the same as that of FIG. 2 in that the signal processing block 11, the clock generating unit 15, the DAC 31, the power amplifier 32, the capacitor 43, the microphone detecting unit 44, the association detecting unit 45, the interrupter 46, the transmission/reception processing unit 47, the register 48, and the I²C interface 49 are arranged.

Here, the host device 10 of FIG. 4 differs from that of FIG. 2 in that the resistor 33 and the switch 41 are not arranged.

Thus, the analog sound interface 12 of FIG. 4 is the same as that of FIG. 2 in that the DAC 31 and the power amplifier 32 are arranged but differs from that of FIG. 2 in that the resistor 33 is not arranged.

Further, the multiplexed data interface 13 of FIG. 4 is the same as that of FIG. 2 in that the capacitor 43, the microphone detecting unit 44, the association detecting unit 45, the interrupter 46, the transmission/reception processing unit 47, the register 48, and the I²C interface 49 are arranged but differs from that of FIG. 2 in that the switch 41 is not arranged.

Since the host device 10 of FIG. 4 does not include the switch 41, the host device 10 of FIG. 4 does not include the sound signal line JA that connects the terminal 41A of the switch 41 with the signal processing block 11 in FIG. 2.

Further, since the host device 10 of FIG. 4 does not include the switch 41, the multiplexed data signal line JB is connected directly to the microphone terminal TJ3 of the jack 14 instead of being connected to the microphone terminal TJ3 of the jack 14 via the switch 41 as in FIG. 2.

Since the host device 10 of FIG. 4 does not include the resistor 33, the switch 41, and the sound signal line JA as described above, it is possible to perform the operation when the switch 41 selects the terminal 41B in FIG. 2, but it is difficult to perform the operation when the switch 41 selects the terminal 41A.

Since the host device 10 of FIG. 4 can perform the operation when the switch 41 selects the terminal 41B in FIG. 2 as described above, the host device 10 can receive the multiplexed data from the input device 20. Thus, in FIG. 4, the host device 10 is the associated device.

However, the host device 10 of FIG. 4 hardly performs the operation when the switch 41 selects the terminal 41A in FIG. 2.

Since the backward compatibility of the host device 10 is secured as the switch 41 enters the state in which the terminal 41A is selected in FIG. 2, the host device 10 of FIG. 4 that hardly performs the operation when the switch 41 selects the terminal 41A does not have the backward compatibility.

In other words, for example, when the existing 4-pole headset including the microphone is connected to the host device 10 in FIG. 4, the sound corresponding to the speaker sound signal supplied from the signal processing block 11 to the sound signal terminals TJ1 and TJ2 of the jack 14 via the DAC 31 and the power amplifier 32 can be output from the existing headset.

However, even when the (analog) microphone sound signal of the existing headset is supplied to the microphone terminal TJ3 of the jack 14, the microphone sound signal is not received (not processed) in the host device 10 of FIG. 4.

Further, when the input device 20 of FIG. 4, that is, the input device 20 serving as the associated device and having the backward compatibility is connected to the host device 10 of FIG. 4, that is, the host device 10 serving as the associated device but having no backward compatibility, the handshake signal is transceived between the association detecting units 45 and 73, similarly to the standard case, and thus the host device 10 and the input device 20 detect the counterpart device to be the associated device.

Thereafter, except when the switch 41 is not switched to select the terminal 41B in the host device 10, the multiplexed data is transceived between the host device 10 and the input device 20, similarly to the standard case.

<Third Exemplary Detailed Configuration of Host Device 10 and Input Device 20>

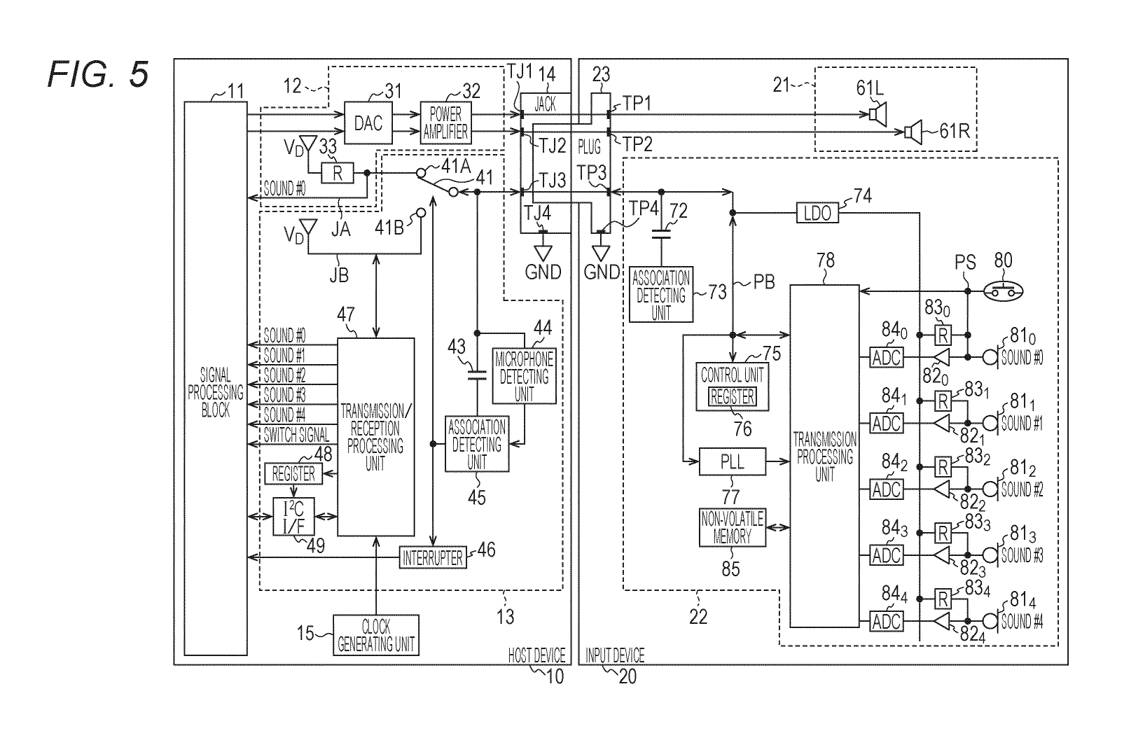

FIG. 5 is a block diagram illustrating a third exemplary detailed configuration of the host device 10 and the input device 20.

In FIG. 5, parts corresponding to those in FIG. 2 are denoted by the same reference numerals, and hereinafter, a description thereof will be appropriately omitted.

The host device 10 of FIG. 5 has a configuration similar to that of FIG. 2.

The input device 20 of FIG. 5 is the same as that of FIG. 2 in that the drivers 61L and 61R, the capacitor 72, the association detecting unit 73, the LDO 74, the control unit 75, the PLL 77, the transmission processing unit 78, the switch 80, the microphones 81₀ to 81₄, the amplifiers 82₀ to 82₄, the resistors 83₀ to 83₄, the ADCs 84₀ to 84₄, and the non-volatile memory 85 are arranged.

Here, the input device 20 of FIG. 5 differs from that of FIG. 2 in that the switch 71 is not arranged.

The analog sound interface 21 of FIG. 5 is the same as that of FIG. 2 in that the drivers 61L and 61R are arranged but differs from that of FIG. 2 in that the switch 80 and the microphone 81₀ are not included as the component of the analog sound interface 21.

The multiplexed data interface 13 of FIG. 5 is the same as that of FIG. 2 in that the capacitor 72, the association detecting unit 73, the LDO 74, the control unit 75, the PLL 77, the transmission processing unit 78, the switch 80, the microphones 81₀ to 81₄, the amplifiers 82₀ to 82₄, the resistors 83₀ to 83₄, the ADC 84₀ to 84₄, and the non-volatile memory 85 are arranged but differs from that of FIG. 2 in that the switch 71 is not arranged.

Since the input device 20 of FIG. 5 does not include the switch 71, the input device 20 of FIG. 5 does not include the sound signal line PA that connects the terminal 71A of the switch 71 with the connect point PS.

Since the input device 20 of FIG. 5 does not include the switch 71, the multiplexed data signal line PB is connected directly to the microphone terminal TP3 of the plug 23 instead of being connected to the microphone terminal TP3 of the plug 23 via the switch 71 as in FIG. 2.

Since the input device 20 of FIG. 5 does not include the switch 71 and the sound signal line PA as described above, it is possible to perform the operation when the switch 71 selects the terminal 71B in FIG. 2, but it is difficult to perform the operation when the switch 71 selects the terminal 71A.

Since the input device 20 of FIG. 5 can perform the operation when the switch 71 selects the terminal 71B in FIG. 2 as described above, it is possible to transmit the multiplexed data via the microphone terminal TP3 of the plug 23. Thus, the input device 20 of FIG. 5 is the associated device.

However, the input device 20 of FIG. 5 hardly performs the operation when the switch 71 selects the terminal 71A in FIG. 2.

Further, since the backward compatibility of the input device 20 is secured by selecting the terminal 71A through the switch 71 in FIG. 2, the input device 20 of FIG. 5 that hardly perform the operation when the switch 71 selects the terminal 71A does not have the backward compatibility.

In other words, when the input device 20 of FIG. 5 is connected to the existing smartphone including the 4-pole jack corresponding to, for example, the existing 4-pole headset including the microphone, the sound corresponding to the speaker sound signal supplied from the existing smartphone to the sound signal terminals TP1 and TP2 of the plug 23 can be output from the drivers 61L and 61R.

However, even if the multiplexed data is supplied from the transmission processing unit 78 to the microphone terminal TP3 of the plug 23 via the multiplexed data signal line PB, the multiplexed data is not received (not processed) by the existing smartphone.

Since the analog sound signal #0 (including the analog sound signal #0 on which the switch signal of the switch 80 is superimposed) output from the microphone 81₀ is not supplied to the microphone terminal TP3 of the plug 23, the analog sound signal #0 is hardly input to the existing smartphone. Thus, the existing smartphone receives neither the sound #0 input to the microphone 81₀ nor the operation of the switch 80.

Further, when the input device 20 of FIG. 5, that is, the input device 20 serving as the associated device but having no backward compatibility is connected to the host device 10 of FIG. 5, that is, the host device 10 serving as the associated device and having the backward compatibility, the handshake signal is transceived between the association detecting units 45 and 73, similarly to the standard case, and thus the host device 10 and the input device 20 detect the counterpart device to be the associated device.

Thereafter, except when the switch 71 is not switched to select the terminal 71B in the input device 20, the multiplexed data is transceived between the host device 10 and the input device 20, similarly to the standard case.

<Fourth Exemplary Detailed Configuration of Host Device 10 and Input Device 20>

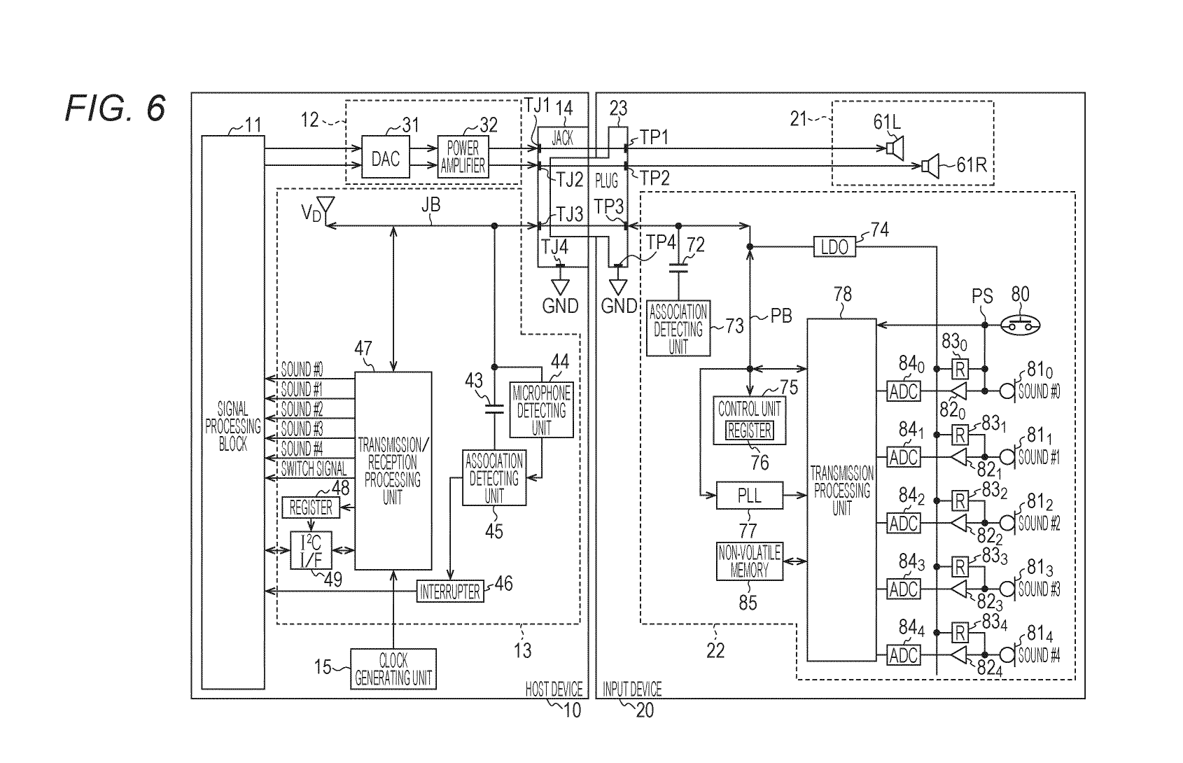

FIG. 6 is a block diagram illustrating a fourth exemplary detailed configuration of the host device 10 and the input device 20.

In FIG. 6, parts corresponding to those in FIG. 4 or 5 are denoted by the same reference numerals, and hereinafter, a description thereof will be appropriately omitted.

In FIG. 6, the host device 10 has a similar configuration to that of FIG. 4, and the input device 20 has a similar configuration to that of FIG. 5.

Thus, in FIG. 6, both the host device 10 and the input device 20 are the associated device but have no backward compatibility.

When the host device 10 and the input device 20 that are the associated device but have no backward compatibility as described above are connected, the handshake signal is transceived between the association detecting units 45 and 73, similarly to the standard case, and thus the host device 10 and the input device 20 detect the counterpart device to be the associated device.

Thereafter, except when the switch 41 is not switched to select the terminal 41B in the host device 10 and when the switch 71 is not switched to select the terminal 71B in the input device 20, the multiplexed data is transceived between the host device 10 and the input device 20, similarly to the standard case.

<Fifth Exemplary Detailed Configuration of Host Device 10 and Input Device 20>

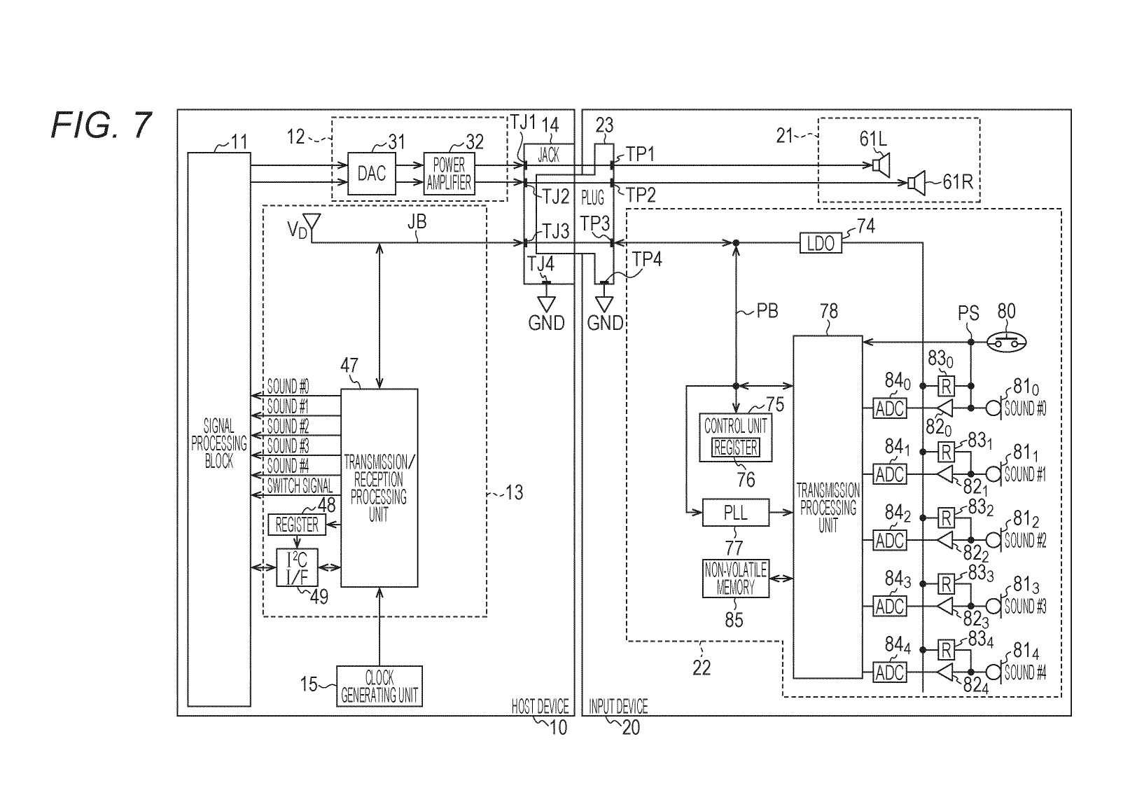

FIG. 7 is a block diagram illustrating a fifth exemplary detailed configuration of the host device 10 and the input device 20.

In FIG. 7, parts corresponding to those in FIG. 6 are denoted by the same reference numerals, and hereinafter, a description thereof will be appropriately omitted.

The host device 10 of FIG. 7 has a similar configuration to that of FIG. 6 except that the capacitor 43, the microphone detecting unit 44, the association detecting unit 45, and the interrupter 46 are not arranged.

The input device 20 of FIG. 7 has a similar configuration to that of FIG. 6 except that the capacitor 72 and the association detecting unit 73 are not arranged.

Since the host device 10 does not include the association detecting unit 45, it is not detected whether or not the plug device including the plug inserted into the jack 14 is the associated device. Similarly, since the input device 20 does not include the association detecting unit 73, it is not detected whether or not the jack device including the jack into which the plug 23 is inserted is the associated device.

Thus, when the host device 10 and the input device 20 of FIG. 7 are connected, none of transmission and reception (and detection of the microphone by the microphone detecting unit 44 of the host device 10 (FIG. 6)) of the handshake signal, switching of selecting the terminal 41B through the switch 41, and switching of selecting the terminal 71B through the switch 71 is performed, and the multiplexed data is transceived between the input device 20 and the host device 10.

The host device 10 of FIG. 7 has no backward compatibility, similarly to the host device 10 of FIG. 4.

The input device 20 of FIG. 7 has no backward compatibility, similarly to the input device 20 of FIG. 5.

Here, as a method of multiplexing and transceiving a plurality of sound signals, for example, there is the switch+S&H technique of multiplexing a plurality of analog sound signals in the analog signal state instead of AD-converting a plurality of analog sound signals into a plurality of digital sound signals and then multiplexing the plurality of digital sound signals.

In the fifth exemplary detailed configuration of FIG. 7, a method of multiplexing a plurality of analog sound signals in the analog signal state can be regarded as a digitalized method.

However, the host device 10 and the input device 20 of FIG. 7 have no backward compatibility. This point is the same in the host devices 10 of FIGS. 4 and 6 and the input devices 20 of FIGS. 5 and 6.

Thus, in terms of backward compatibility, it is desirable that the host device 10 and the input device 20 be configured as illustrated in FIG. 2.

<Sixth Exemplary Detailed Configuration of Host Device 10 and Input Device 20>

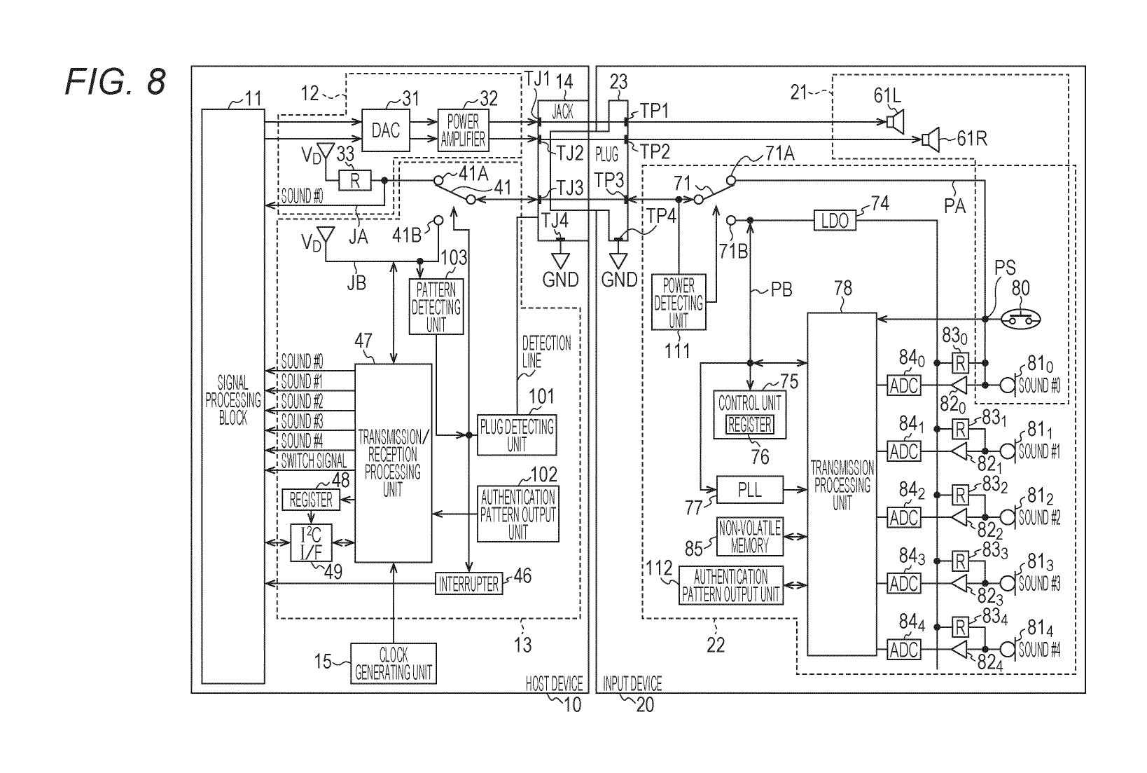

FIG. 8 is a block diagram illustrating a sixth exemplary detailed configuration of the host device 10 and the input device 20.

In FIG. 8, parts corresponding to those in FIG. 2 are denoted by the same reference numerals, and hereinafter, a description thereof will be appropriately omitted.

The host device 10 of FIG. 8 is similar to that of FIG. 2 in that the signal processing block 11, the clock generating unit 15, the DAC 31, the power amplifier 32, the resistor 33, the switch 41, the interrupter 46, the transmission/reception processing unit 47, the register 48, and the I²C interface 49 are arranged.

However, the host device 10 of FIG. 8 differs from that of FIG. 2 in that the capacitor 43, the microphone detecting unit 44, and the association detecting unit 45 are not arranged, and a plug detecting unit 101, an authentication pattern output unit 102, and a pattern detecting unit 103 are newly arranged.

In the host device 10 of FIG. 8, the analog sound interface 12 has a similar configuration to that of FIG. 2.

In the host device 10 of FIG. 8, the multiplexed data interface 13 is configured with the switch 41, the interrupter 46, the transmission/reception processing unit 47, the register 48, a I²C interface 49, the plug detecting unit 101, the authentication pattern output unit 102, and the pattern detecting unit 103.

The input device 20 of FIG. 8 is the same as that of FIG. 2 in that the drivers 61L and 61R, the switch 71, the LDO 74, the control unit 75, the PLL 77, the transmission processing unit 78, the switch 80, the microphones 81₀ to 81₄, the amplifiers 82₀ to 82₄, the resistors 83₀ to 83₄, the ADCs 84₀ to 84₄, and the non-volatile memory 85 are arranged.

However, the input device 20 of FIG. 8 differs from that of FIG. 2 in that the capacitor 72 and the association detecting unit 73 are not arranged, but a power detecting unit 111 and an authentication pattern output unit 112 are newly arranged.

In the input device 20 of FIG. 8, the analog sound interface 21 has a similar configuration to that of FIG. 2.

In the input device 20 of FIG. 8, the multiplexed data interface 22 is configured with the switch 71, the LDO 74, the control unit 75, the PLL 77, the transmission processing unit 78, the switch 80, the microphones 81₀ to 81₄, the amplifiers 82₀ to 82₄, the resistors 83₀ to 83₄, the ADCs 84₀ to 84₄, the non-volatile memory 85, the power detecting unit 111, and the authentication pattern output unit 112.

In the host device 10 of FIG. 8, the plug detecting unit 101 monitors a signal on a detection line connected to the jack 14, and detects that the plug has inserted into the jack 14 based on the signal on the detection line.

In other words, in FIG. 8, for example, a mechanical mechanism for detecting insertion of the plug is installed in the jack 14, and the detection line is connected to the mechanical mechanism.

Further, when the plug is inserted into the jack 14, the signal (impedance when the detection line is viewed from the plug detecting unit 101) on the detection line changes, and the plug detecting unit 101 detects that the plug has been inserted into the jack 14 based on the signal on the detection line.

Upon detecting that the plug has been inserted into the jack 14, the plug detecting unit 101 switches the switch 41 selecting the terminal 41A in the default state to select the terminal 41B.

The authentication pattern output unit 102 stores an authentication pattern serving as a predetermined signal for authenticating (detecting) that the host device 10 is the associated device, and outputs the authentication pattern to the transmission/reception processing unit 47.

After the plug detecting unit 101 detects that the plug has been inserted into the jack 14, and the switch 41 is switched to select the terminal 41B, the transmission/reception processing unit 47 transmits the authentication pattern output from the authentication pattern output unit 102 during a predetermined period of time.

The authentication pattern transmitted by the transmission/reception processing unit 47 is output from the microphone terminal TJ3 of the jack 14 via the multiplexed data signal line JB and the switch 41 selecting the terminal 41B.

Here, the authentication pattern stored in the authentication pattern output unit 102 is hereinafter referred to as a “master authentication pattern.”

The pattern detecting unit 103 is connected to the multiplexed data signal line JB connected to the terminal 41B of the switch 41, and receives an authentication pattern (a slave authentication pattern which will be described later) transmitted from the input device 20 serving as the associated device via the microphone terminal TJ3 of the jack 14, the switch 41 (selecting the terminal 41), and the multiplexed data signal line JB.

The pattern detecting unit 103 receives the slave authentication pattern, and detects the plug device including the plug inserted into the jack 14 to be the associated device.

When the plug device including the plug inserted into the jack 14 is detected to be the associated device, the pattern detecting unit 103 supplies information indicating that the switch 41 has been switched to select the terminal 41B to the interrupter 46.

Further, when the slave authentication pattern has not been received during a predetermined period of time after the plug detecting unit 101 detects that the plug has been inserted into the jack 14, and the switch 41 is switched to select the terminal 41B, the pattern detecting unit 103 detects the plug device including the plug inserted into the jack 14 to be not the associated device, and the switch 41 switched to select the terminal 41B is switched to select the terminal 41A again.

In the input device 20 of FIG. 8, the power detecting unit 111 detects that that the plug 23 has been inserted into the jack by detecting a change in the voltage of the microphone terminal TP3 of the plug 23.

In other words, for example, when the plug 23 is inserted into the jack 14 of the host device 10 (the same applies, for example, even when the plug 23 is inserted into the jack of the existing jack device corresponding the existing 4-pole headset including the microphone), the voltage of the power source V_{D} appears in the microphone terminal TP3 of the plug 23 via the resistor 33, the switch selecting the terminal 41A, and the microphone terminal TJ3 of the jack 14 or via the multiplexed data signal line JB, the switch 41 selecting the terminal 41B, and the microphone terminal TJ3 of the jack 14.

When the voltage of the microphone terminal TP3 of the plug 23 is changed to (a voltage close to) the voltage of the power source V_{D}, the power detecting unit 111 detects that the plug 23 has been inserted into the jack, and switches the switch 71 selecting the terminal 71A in the default state to select the terminal 71B.

The authentication pattern output unit 112 stores an authentication pattern serving as a predetermined signal for authenticating (detecting) that the input device 20 is the associated device, and outputs the authentication pattern to the transmission processing unit 78.

Hereinafter, the authentication pattern stored in the authentication pattern output unit 112 is also referred to as a “slave authentication pattern.”

After the power detecting unit 111 detects that the plug 23 has been inserted into the jack, and the switch 71 is switched to select the terminal 71B, the control unit 75 waits for and receives the master authentication pattern that is transmitted from the jack device including the jack into which the plug 23 is inserted via the microphone terminal TP3 of the plug 23, the switch 71 selecting the terminal 71B, and the multiplexed data signal line PB.

Upon receiving the master authentication pattern, the control unit 75 detects the jack device including the jack into which the plug 23 is inserted to be the associated device, and causes the transmission processing unit 78 to transmit the slave authentication pattern output from the authentication pattern output unit 112 during a predetermined period of time.

The slave authentication pattern transmitted by the transmission processing unit 78 is output from the microphone terminal TP3 of the plug 23 via the multiplexed data signal line JB and the switch 71 selecting the terminal 71B.

On the other hand, when the control unit 75 has not received the master authentication pattern during a predetermined period of time after the power detecting unit 111 detects that the plug 23 has been inserted into the jack, and the switch 71 is switched to select the terminal 71B, the jack device including the jack into which the plug 23 is inserted is detected to be not the associated device, and the switch 71 switched to select the terminal 71B is switched to select the terminal 71A again.

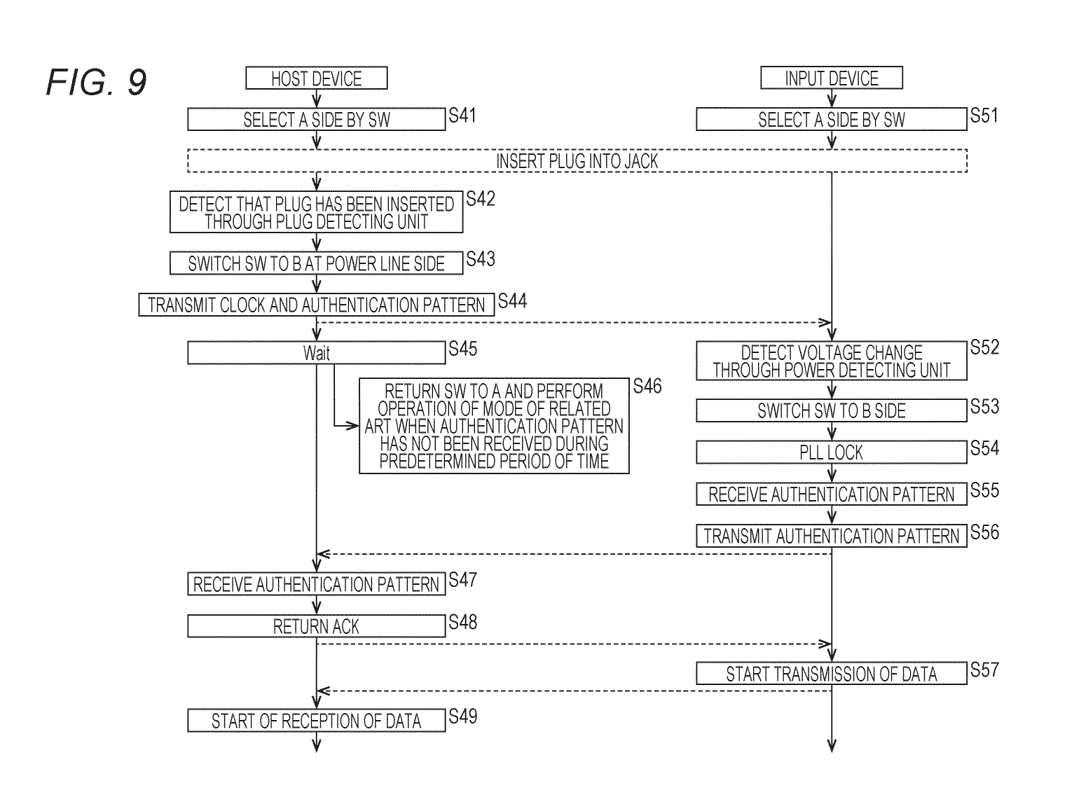

FIG. 9 is a flowchart for describing processes of the host device 10 of FIG. 8, and the input device 20.

In step S41, in the host device 10, the switch 41 selects the terminal 41A in the default state.

On the other hand, in step S51, in the input device 20, the switch 71 selects the terminal 71A in the default state.

Then, when the plug 23 of the input device 20 is inserted into the jack 14 of the host device 10, in the host device 10, in step S42, the plug detecting unit 101 detects that the plug has been inserted into the jack 14.

When the plug detecting unit 101 detects that the plug has been inserted into the jack 14, in step S43, the switch 41 selecting the terminal 41A in the default state is switched to select the terminal 41B.

Thereafter, in step S44, the transmission/reception processing unit 47 starts transmission of (the signal including) the clock in synchronization with the clock output from the clock generating unit 15.

In step S44, the transmission/reception processing unit 47 starts transmission of the master authentication pattern stored in the authentication pattern output unit 102 in synchronization with the clock output from the clock generating unit 15.

The clock and the master authentication pattern transmitted by the transmission/reception processing unit 47 are output from the microphone terminal TJ3 of the jack via the multiplexed data signal line JB and the switch 41.

After the transmission of the clock and the master authentication pattern starts, in step S45, the pattern detecting unit 103 is on standby for the slave authentication pattern transmitted from the plug device including the plug inserted into the jack 14.

Then, when the slave authentication pattern has not been transmitted during a predetermined period of time, in step S46, the pattern detecting unit 103 detects (recognizes) the plug device including the plug inserted into the jack 14 to be not the associated device, and the switch 41 switched to select the terminal 41B is switched to select the terminal 41A again.

After the switch 41 is switched to select the terminal 41A, the host device 10 performs the operation (the operation of the mode of the related art) when the plug device including the plug inserted into the jack 14 is not the associated device such as the existing 4-pole headset including the microphone as described above with reference to FIG. 2.

On the other hand, when the slave authentication pattern has been transmitted from the plug device including the plug inserted into the jack 14, that is, for example, when the plug 23 of the input device 20 serving as the associated device is inserted into the jack 14, and the slave authentication pattern is transmitted from the input device 20 to the pattern detecting unit 103 via the microphone terminal TJ3 of the jack 14, the switch 41 (selecting the terminal 41), and the multiplexed data signal line JB, in step S47, the pattern detecting unit 103 receives the slave authentication pattern.

The pattern detecting unit 103 receives the slave authentication pattern, and detects the plug device including the plug inserted into the jack 14 to be the associated device.

When the plug device including the plug inserted into the jack 14 is detected to be the associated device, the pattern detecting unit 103 supplies information indicating that the switch 41 has been switched to select the terminal 41B to the interrupter 46.

When the information indicating that the switch 41 has been switched to select the terminal 41B is supplied from the pattern detecting unit 103, the interrupter 46 supplies information indicating that (the plug of) the associated device has been inserted into the jack 14 to the signal processing block 11.

When the information indicating that the associated device has been inserted into the jack 14 is supplied from the interrupter 46, the signal processing block 11 starts the signal processing for the associated device.

When the pattern detecting unit 103 receives the slave authentication pattern, in step S48, the transmission/reception processing unit 47 transmits (returns) an ACKnowledgement (ACK) (a positive response) signal to the input device 20 serving as the plug device including the plug inserted into the jack 14 via the multiplexed data signal line JB, the switch 41, and the microphone terminal TJ3 of the jack 14.

Thereafter, in step S49, the transmission/reception processing unit 47 starts reception of the multiplexed data transmitted from the input device 20 via the microphone terminal TJ3 of the jack 14, the switch 41, and the multiplexed data signal line JB as will be described later.

On the other hand, in the input device 20, when the plug 23 of the input device 20 is inserted into the jack 14 of the host device 10, in step S52, the power detecting unit 111 detects that the plug 23 has been inserted into the jack.

In other words, when the plug 23 of the input device 20 is inserted into the jack 14 of the host device 10, the voltage of the power source V_{D} appears in the microphone terminal TP3 of the plug 23 via the resistor 33, the switch selecting the terminal 41A, and the microphone terminal TJ3 of the jack 14 or the multiplexed data signal line JB, the switch 41 selecting the terminal 41B, and the microphone terminal TJ3 of the jack 14.

When the voltage of the microphone terminal TP3 of the plug 23 is changed to the voltage of the power source V_{D} or the like, the power detecting unit 111 detects that the plug 23 has been inserted into the jack.

When the power detecting unit 111 detects that the plug 23 has been inserted into the jack, in step S53, the switch 71 selecting the terminal 71A in the default state is switched to select the terminal 71B.

When the switch 71 is switched to select the terminal 71B, the microphone terminal TP3 of the plug 23 is connected to the LDO 74 via the switch 71 (selecting the terminal 71B).

Further, the microphone terminal TP3 of the plug 23 is connected to the control unit 75, the PLL 77, and the transmission processing unit 78 via the switch 71 and the multiplexed data signal line PB.

Here, in the host device 10, in step S43, the switch 41 is switched to select the terminal 41B as described above, and as a result, the microphone terminal TJ3 of the jack 14 is connected to the transmission/reception processing unit 47, the pattern detecting unit 103, and the power source V_{D} via the switch 41 (selecting the terminal 41B) and the multiplexed data signal line JB.

As described above, as the microphone terminal TJ3 of the jack 14 is connected to the power source V_{D} via the switch 41, and the multiplexed data signal line JB, the power source V_{D} is connected to the LDO 74 via the multiplexed data signal line JB of the host device 10, the switch 41, and the microphone terminal TJ3 of the jack 14 and via the microphone terminal TP3 of the plug 23 of the input device 20 and the switch 71 selecting the terminal 71B.

When the power source V_{D} of the host device 10 is connected to the LDO 74 of the input device 20 as described above, the LDO 74 starts to supply the electric power serving as the power source to the block that needs electric power such as the amplifier 82ᵢ of the input device 20.

Further, in the host device 10, as described above, in step S44, the transmission/reception processing unit 47 starts the transmission of the clock and the master authentication pattern, the clock and the master authentication pattern are output from the microphone terminal TJ3 of the jack 14 via the multiplexed data signal line JB and the switch 41.

The clock that is output from the microphone terminal TJ3 of the jack 14 and transmitted by the transmission/reception processing unit 47 are supplied to the PLL 77 via the microphone terminal TP3 of the plug 23, the switch 71, and the multiplexed data signal line PB in the input device 20.

In step S54, the PLL 77 starts its operation according to the clock from the transmission/reception processing unit 47 that are supplied as described above, and when the PLL 77 enters the lock state, the PLL 77 supplies the clock synchronized with the clock supplied from the transmission/reception processing unit 47 to the transmission processing unit 78 or the like.

The transmission processing unit 78 starts its operation in synchronization with the clock from the PLL 77.

When the switch 71 is switched to select the terminal 71B, and the PLL 77 enters the lock state as described above, in step S55, the control unit 75 waits for and receives the master authentication pattern transmitted from the host device 10.

In other words, in the host device 10, in step S44, the transmission/reception processing unit 47 starts the transmission of the master authentication pattern, and the master authentication pattern is output from the microphone terminal TJ3 of the jack 14 via the multiplexed data signal line JB and the switch 41.

The control unit 75 receives the master authentication pattern output from the microphone terminal TJ3 of the jack 14 via the microphone terminal TP3 of the plug 23, the switch 71, and the multiplexed data signal line PB.

Further, when no clock is supplied to the PLL 77 in step S54 or when the control unit 75 has not received the master authentication pattern in step S55, the jack device including the jack into which the plug 23 is inserted is regarded to be not the associated device, and the switch 71 switched to select the terminal 71B is switched to select the terminal 71A again.

After the switch 71 is switched to select the terminal 41A, the input device 20 performs the operation when the jack device including the jack into which the plug 23 is inserted is not the associated device such as the existing smartphone corresponding to, for example, the existing 4-pole headset including the microphone or the like as described above with reference to FIG. 2.

Upon receiving the master authentication pattern in step S55, the control unit 75 detects the jack device including the jack into which the plug 23 is inserted to be the associated device, and in step S56, the control unit 75 causes the transmission processing unit 78 to transmit the slave authentication pattern output from the authentication pattern output unit 112 during a predetermined period of time.

The slave authentication pattern transmitted by the transmission processing unit 78 is output from the microphone terminal TP3 of the plug 23 via the multiplexed data signal line JB and the switch 71 selecting the terminal 71B.

The slave authentication pattern output from the microphone terminal TP3 of the plug 23 is transmitted to the pattern detecting unit 103 via the microphone terminal TJ3 of the jack 14, the switch 41 (selecting the terminal 41), and the multiplexed data signal line JB, and received by the pattern detecting unit 103 in step S47.

In the host device 10, after the pattern detecting unit 103 receives the slave authentication pattern, the transmission/reception processing unit 47 transmits the ACK signal via the multiplexed data signal line JB, the switch 41, and the microphone terminal TJ3 of the jack 14 in step S48 as described above, and thus in the control unit 75 and the PLL 77 of the input device 20, the ACK signal transmitted via the microphone terminal TJ3 of the jack 14 is received via the microphone terminal TP3 of the plug 23, the switch 71, and the multiplexed data signal line PB as described above.

Thereafter, in step S57, the transmission processing unit 78 starts the process of multiplexing the switch signal supplied from the switch 80, the digital sound signal #i supplied from the ADC 84ᵢ, the data read from the register 76, and the data read from the non-volatile memory 85 and transmitting the resulting multiplexed data to the transmission/reception processing unit 47 via the multiplexed data signal line PB, the switch 71, the microphone terminal TP3 of the plug 23, the microphone terminal TJ3 of the jack 14, the switch 41, and the multiplexed data signal line JB.

In the host device 10, in step S49, the multiplexed data transmitted from the transmission processing unit 78 as described above is received by the transmission/reception processing unit 47 via the microphone terminal TJ3 of the jack 14, the switch 41, and the multiplexed data signal line JB.

In the input device 20 of FIG. 8, the power detecting unit 111 can detect that the plug 23 has been inserted into the jack according to the occurrence of a predetermined change in an electric current rather than the voltage of the microphone terminal TP3 of the plug 23.

In the input device 20 of FIG. 8, only when the voltage of the microphone terminal TP3 of the plug 23 becomes the voltage of (almost) the power source V_{D}, the power detecting unit 111 switches the switch 71 selecting the terminal 71A in the default state to select the terminal 71B, and when the voltage of the microphone terminal TP3 does not reach the voltage of (almost) the power source V_{D} although the voltage of the microphone terminal TP3 of the plug 23 changes, the power detecting unit 111 can maintain the selection of the terminal 71A without change and without switching the switch 71 selecting the terminal 71A in the default state, and thus the following operation can be performed.

If the switch 41 of the host device 10 is now selecting the terminal 41A, the microphone terminal TP3 of the plug 23 is connected to the power source V_{D} via the microphone terminal TJ3 of the jack 14, the switch 41, and the resistor 33. In this case, the voltage of the microphone terminal TP3 of the plug 23 becomes a voltage that is lowered from the voltage of the power source V_{D} by a voltage drop in the resistor 33 and does not reach the voltage of the power source V_{D}, and thus the power detecting unit 111 maintains the selection of the terminal 71A without change and without switching the switch 71 selecting the terminal 71A.

On the other hand, if the switch 41 of the host device 10 is selecting the terminal 41B, the microphone terminal TP3 of the plug 23 is connected to the power source V_{D} via the microphone terminal TJ3 of the jack 14 and the switch 41. In this case, since there is no load such as the resistor 33 between the microphone terminal TP3 of the plug 23 and the power source V_{D} of the host device 10, the voltage of the microphone terminal TP3 of the plug 23 becomes the voltage of the power source V_{D}. Thus, the power detecting unit 111 switches the switch 71 selecting the terminal 71A to select the terminal 71B.

As described above, the power detecting unit 111 switches the switch 71 selecting the terminal 71A in the default state to select the terminal 71B only when the voltage of the microphone terminal TP3 of the plug 23 becomes the voltage of the power source V_{D}, and in this case, in the host device 10, the switch 41 selects the terminal 41B, and only when the master authentication pattern from the transmission/reception processing unit 47 is output from the terminal TJ3 of the jack 14 via the multiplexed data signal line JB and the switch 41, the switch 71 is switched from the terminal 71A to the terminal 71B.

Thus, only when the switch 41 selects the terminal 41B, and the master authentication pattern is output to the microphone terminal TJ3 of the jack 14 in the host device 10, in the power detecting unit 111 of the input device 20, the switch 71 is switched from the terminal 71A to the terminal 71B, and thus the control unit 75 of the input device 20 can receive the master authentication pattern from the host device 10 after the switch 71 is switched to the terminal 71B.

As described above, if the host device 10 and the input device 20 are connected, when the switch 71 is switched to select the terminal 71B, the input device 20 can receive the master authentication pattern from the host device 10 after the switching. Thus, as described above with reference to FIGS. 8 and 9, there is no situation in which the master authentication pattern has not been received within a predetermined period of time after the switch 71 is switched to select the terminal 71B in the input device 20, and thus there is no situation in which the switch 71 switched to select the terminal 71B is switched to select the terminal 71A again according to this situation.

<Seventh Exemplary Detailed Configuration of Host Device 10 and Input Device 20>

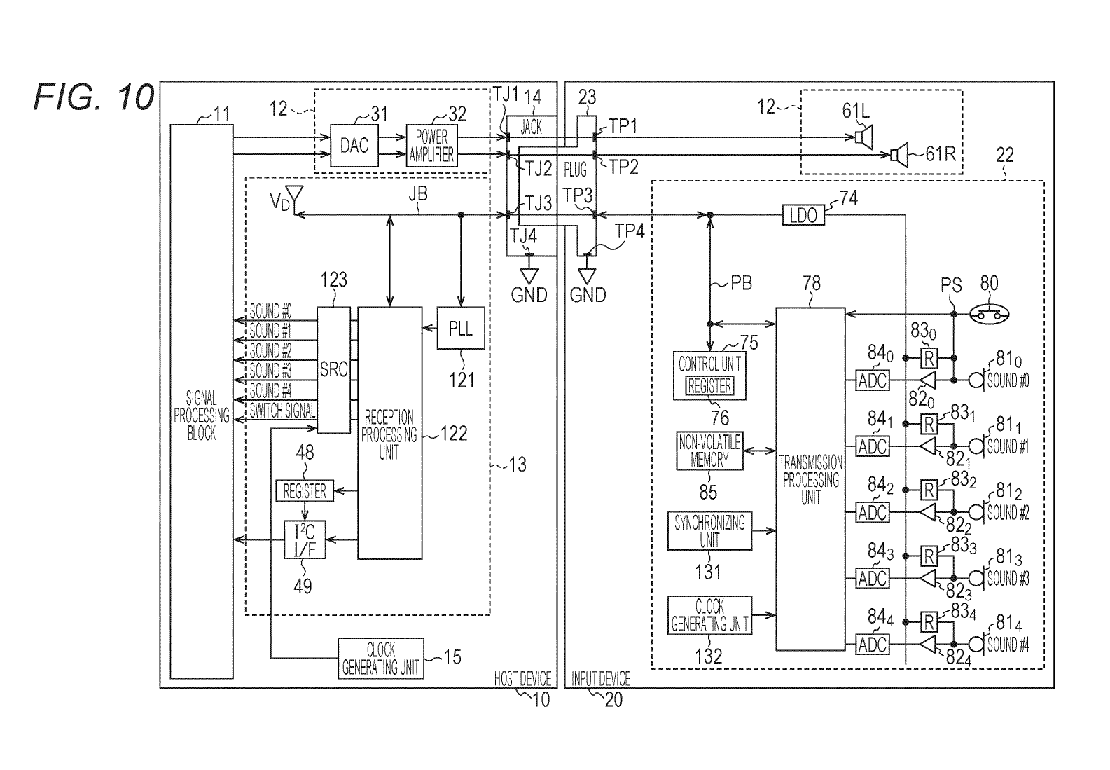

FIG. 10 is a block diagram illustrating a seventh exemplary detailed configuration of the host device 10 and the input device 20.

In FIG. 10, parts corresponding to those in FIG. 7 are denoted by the same reference numerals, and hereinafter, a description thereof will be appropriately omitted.

The host device 10 of FIG. 10 is the same as that of FIG. 7 in that the signal processing block 11, the clock generating unit 15, the DAC 31, the power amplifier 32, the register 48, and the I²C interface 49 are arranged.

However, the host device 10 of FIG. 10 differs from that of FIG. 7 in that a reception processing unit 122 is arranged instead of the transmission/reception processing unit 47, and a PLL 121, and a sampling rate converter (SRC) 123 are newly arranged.

In the host device 10 of FIG. 10, the analog sound interface 12 is configured with the DAC 31 and the power amplifier 32 (similarly to that of FIG. 7).

Further, in the host device 10 of FIG. 10, the multiplexed data interface 13 is configured with the register 48, the I²C interface 49, the PLL 121, the reception processing unit 122, and the SRC 123.

The input device 20 of FIG. 10 is the same as that of FIG. 7 in that the drivers 61L and 61R, the LDO 74, the control unit 75, the transmission processing unit 78, the switch 80, the microphones 81₀ to 81₄, the amplifiers 82₀ to 82₄, the resistors 83₀ to 83₄, the ADCs 84₀ to 84₄, and the non-volatile memory 85 are arranged.

However, the input device 20 of FIG. 10 differs from that of FIG. 7 in that a clock generating unit 132 is arranged instead of the PLL 77, and a synchronizing unit 131 is newly arranged.

In the input device 20 of FIG. 10, the analog sound interface 21 is configured with the drivers 61L and 61R (similarly to that of FIG. 7).

Further, in the input device 20 of FIG. 10, the multiplexed data interface 22 is configured with the LDO 74, the control unit 75, the transmission processing unit 78, the switch 80, the microphones 81₀ to 81₄, the amplifiers 82₀ to 82₄, the resistors 83₀ to 83₄, the ADCs 84₀ to 84₄, the non-volatile memory 85, the synchronizing unit 131, and the clock generating unit 132.

In the host device 10 of FIG. 10, the PLL 121 generates clock synchronized with a signal (multiplexed data) transmitted on the multiplexed data signal line JB from the input device 20 via the microphone terminal TJ3 of the jack 14 from the signal, and supplies the generated clock to the reception processing unit 122.

The reception processing unit 122 operates in synchronization with the clock supplied from the PLL 121, and receives the multiplexed data supplied from the input device 20 via the microphone terminal TJ3 of the jack 14, the switch 41, and the multiplexed data signal line JB, similarly to the transmission/reception processing unit 47 of FIG. 7 (FIG. 2).

The reception processing unit 122 performs an appropriate process such as a process of demultiplexing the multiplexed data, separates original data included in the multiplexed data, for example, the digital sound signals #0, #1, #2, #3, and #4 and the additional data, and supplies the digital sound signals #0, #1, #2, #3, and #4 and the additional data to the SRC 123, similarly to the transmission/reception processing unit 47 of FIG. 7 (FIG. 2).

The SRC 123 operates in synchronization with the clock (hereinafter, also referred to as a “host clock”) supplied from the clock generating unit 15, converts the digital sound signals #0, #1, #2, #3, and #4, and the additional data supplied from the reception processing unit 122 into data synchronized with the clock output from the clock generating unit 15, and supplies the resultant data to the signal processing block 11.

Here, the reception processing unit 122 operates in synchronization with the clock supplied from the PLL 121, but the clock supplied from the PLL 121 is a clock synchronized with the signal transmitted from the input device 20, that is, a clock synchronized with clock (hereinafter, also referred to as a “device clock”) generated by the clock generating unit 132 (which will be described later) arranged in the input device 20.

Thus, the digital sound signals #0, #1, #2, #3, and #4, and the additional data obtained by the reception processing unit 122 are data synchronized with the device clock of the input device 20 side, and the SRC 123 converts the sound signal #0, #1, #2, #3, #4 and the additional data which are synchronized with the device clock of the input device 20 side into data synchronized with master clock of the host device 10 generated by the clock generating unit 15.

In the input device 20 of FIG. 10, the clock generating unit 132 generates the device clock, and supplies the device clock to the transmission processing unit 78.

Thus, in FIG. 10, the transmission processing unit 78 operates in synchronization with the device clock generated by the clock generating unit 132 rather than the clock that is generated by the PLL 77 as in FIG. 7 (FIG. 2) and synchronized with the master clock.

As a result, the multiplexed data transmitted by the transmission processing unit 78 becomes data synchronized with the device clock.

The synchronizing unit 131 generates a synchronous signal indicating delimiting of the multiplexed data obtained by the transmission processing unit 78, that is, delimiting of a bundle (for example, a frame which will be described later) of the digital sound signals #0, #1, #2, #3, and #4 and the additional data included in the multiplexed data, and supplies the synchronous signal to the transmission processing unit 78.

Here, the transmission processing unit 78 includes the synchronous signal supplied from the synchronizing unit 131 at a position of the delimiting of the multiplexed data.

The reception processing unit 122 of the host device 10 separates the sound signal #0, #1, #2, #3, #4, and the additional data based on the synchronous signal included in the multiplexed data.

The host device 10 and the input device 20 having the above-described configuration operate in an asynchronous manner.

In other words, in the first to sixth exemplary detailed configurations, when the host device 10 and the input device 20 are connected, the host device 10 operates in synchronization with the master clock generated by the clock generating unit 15, and the input device 20 operates in synchronization with the clock that are generated by the PLL 77 (FIG. 7 or the like) and synchronized with the master clock, and thus the host device 10 and the input device 20 operate in synchronization with each other.

On the other hand, in FIG. 10, the host device 10 operates in synchronization with the master clock generated by the clock generating unit 15, the input device 20 operates in synchronization with the device clock generated by the clock generating unit 132, and thus the host device 10 and the input device 20 operate in an asynchronous manner.

In other words, in FIG. 10, when the host device 10 and the input device 20 are connected, the power source V_{D} of the host device 10 is connected with the LDO 74 of the input device 20 via the multiplexed data signal line JB, the microphone terminal TJ3 of the jack 14, the microphone terminal TP3 of the plug 23, and the multiplexed data signal line PB.

When the power source V_{D} of the host device 10 is connected with the LDO 74 of the input device 20, the LDO 74 starts to supply the electric power serving as the power source to the block that needs electric power such as the amplifier 82ᵢ of the input device 20, and thus the transmission processing unit 78 starts transmission of the multiplexed data.

In other words, the transmission processing unit 78 operates in synchronization with the device clock generated by the clock generating unit 132, and generates and transmits the synchronous signal supplied from the synchronizing unit 131, the digital sound signals #0 to #4 supplied from the ADCs 84₀ to 84₄, and the device information stored in the non-volatile memory 85 or the multiplexed data including the additional data such as the switch signal output from the switch 80.

The multiplexed data transmitted by the transmission processing unit 78 is supplied to the PLL 121 and the reception processing unit 122 via the multiplexed data signal line PB, the microphone terminal TP3 of the plug 23, the microphone terminal TJ3 of the jack 14, and the multiplexed data signal line JB.

The PLL 121 receives the multiplexed data from the transmission processing unit 78, generates clock synchronized with the multiplexed data, and supplies the generated clock to the reception processing unit 122.

The reception processing unit 122 operates in synchronization with the clock supplied from the PLL 121, and receives the multiplexed data from the transmission processing unit 78. The reception processing unit 122 separates the digital sound signals #0, #1, #2, #3, and #4 and the additional data included in the multiplexed data, and supplies the digital sound signals #0, #1, #2, #3, and #4 and the additional data to the SRC 123.

The SRC 123 operates in synchronization with the host clock supplied from the clock generating unit 15, converts the digital sound signals #0, #1, #2, #3, and #4 and the additional data supplied from the reception processing unit 122 into data synchronized with the clock output from the clock generating unit 15, and supplies the resultant data to the signal processing block 11.

The host device 10 and the input device 20 of FIG. 10 that operate in an asynchronous manner have no backward compatibility, similarly to the host device 10 and the input device 20 of FIG. 7. However, the host device 10 and the input device 20 that operate in an asynchronous manner may be configured to have the backward compatibility as in the host device 10 and the input device 20 of FIG. 2.

In other words, the host device 10 and the input device 20 of FIG. 2 having the backward compatibility may be configured to operate in an asynchronous manner as described above with reference to FIG. 10.

<Signal Format>

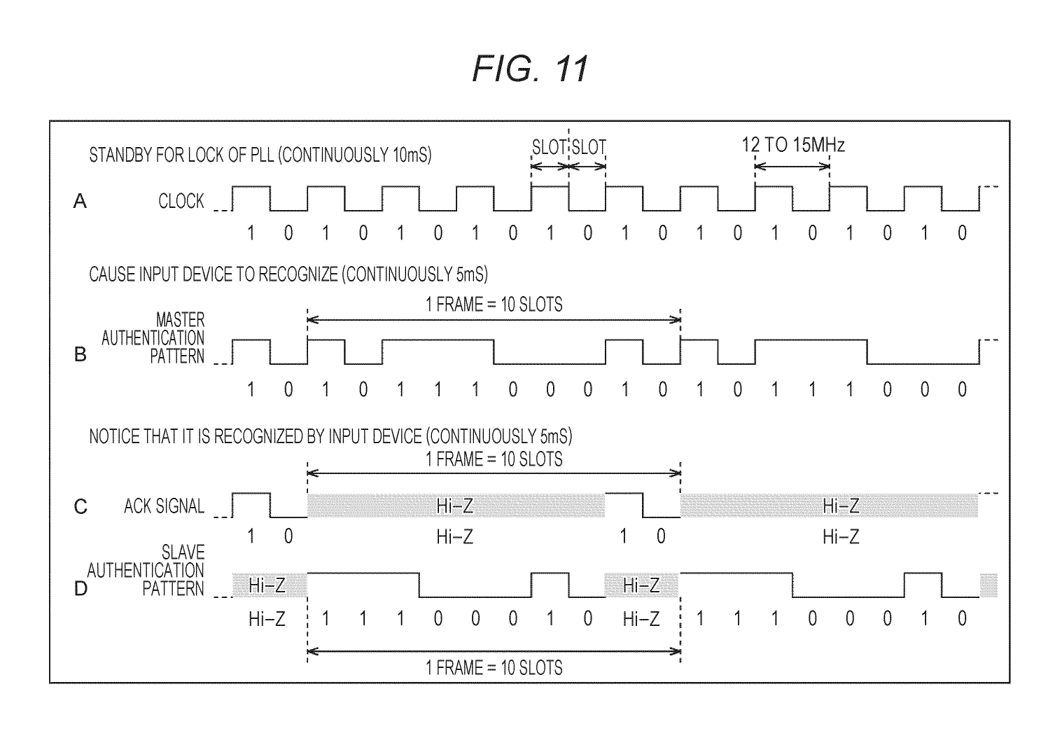

A signal format of a signal exchanged between the host device 10 and the input device 20 will be described with reference to FIGS. 11 to 13.

Here, the signal format will be described in connection with an example of the signal exchanged between the host device 10 and the input device 20 of, for example, the sixth exemplary detailed configuration of FIG. 8 among the first to seventh exemplary detailed configurations will be described.

Examples of the signal transmitted from the host device 10 of FIG. 8 to the input device 20 include the master authentication pattern (the authentication signal) and the command which are transmitted by the transmission/reception processing unit 47.

Examples of the signal transmitted from the input device 20 of FIG. 8 to the host device 10 include the slave authentication pattern (the authentication signal) and the multiplexed data which are transmitted by the transmission processing unit 78.

Examples of the command transmitted from the host device 10 to the input device 20 include a read command to request reading of data and a write command to request writing of data.

The command is configured with an operation code and a necessary operand.

For example, the read command includes a code indicating reading of data as an operation code, and includes an address (a beginning address) at the beginning of an address at which data is read and the number of addresses (the number of addresses at which data is read) at which data is read from the beginning address as an operand.

For example, the write command includes a code indicating writing of data as an operation code, and includes a write address at which data is written and data (write data) of a target written at the write address as an operand.

The control unit 75 of the input device 20 performs the process according to the storage value of the register 76 installed therein as described above, the host device 10 writes the storage value of the register 76 according to the write command, and thus it is possible to cause (the control unit 75 of) the input device 20 to perform various processes (for example, switching between an ON state and an OFF state of the ADC 84ᵢ, switching of an operation mode between a standby (power saving) mode and a normal mode of the LDO 74, and any other process).

In the host device 10, it is possible to read the device information from the non-volatile memory 85 of the input device 20 according to the read command.

On the other hand, the multiplexed data transmitted from the input device 20 to the host device 10 includes, for example, the digital sound signals #0, #1, #2, #3, and #4 and the additional data as described above.

In other words, the multiplexed data includes the sound signals #0, #1, #2, #3, and #4 of a maximum of 5 channels. The multiplexed data further includes the additional data.

As the additional data, the switch signal and the device information may be included (employed) as described above. As the additional data, data read according to the read command given from the host device 10, an address at which the data is stored, or the like may be included (employed) in the input device 20.

In the input device 20 of FIG. 8, only one switch of the switch 80 is installed as a switch operated by the user, and thus in FIG. 8, the switch signal included in the additional data is only the switch signal of the switch 80, but the additional data may include switch signals of a plurality of switches, for example, a maximum of four switches.

FIG. 11 is a timing chart illustrating an exemplary signal exchanged between the host device 10 and the input device 20 until the multiplexed data can be transceived after the plug 23 is inserted into the jack 14.

A of FIG. 11 illustrates a clock transmitted from the host device 10 to the input device 20.

As the clock transmitted from the host device 10 to the input device 20, for example, a pulse signal having a frequency of about 12 to 15 MHz can be employed.

In the host device 10, in step S44, the transmission of the clock starts as described above with reference to FIG. 9, but the transmission of the clock is continued during a predetermined period of time, for example, 10 ms.

Here, the clock transmitted from the host device 10 to the input device 20 is a pulse in which a period of time of the H level is equal to a period of time of the L level, and each of individual periods of time of the H level and the L level is hereinafter also referred to as a “slot.” Hereinafter, appropriately, the H level is indicated by “1,” and the L level is indicated by “0.” In this case, the clock is indicated by “10101010 . . . . ”

B of FIG. 11 illustrates the master authentication pattern transmitted from the host device 10 to the input device 20.

For example, when 10 slots are assumed to correspond to one frame, the master authentication pattern can be, for example, a pattern “1011100010” of one frame.

The host device 10 starts the transmission of the master authentication pattern in step S44 as described above with reference to FIG. 9, but the transmission of the master authentication pattern is continuously repeated during a predetermined period of time, for example, 5 ms.

C of FIG. 11 illustrates the ACK signal transmitted from the host device 10 to the input device 20.

As the ACK signal, a 2-slot pattern “10” can be employed. The 2-slot pattern “10” serving as the ACK signal is arranged at the end of the frame, a period of time of the remaining 8 slots is regarded as high impedance (Hi-Z) (the impedance of the microphone terminal TJ3 of the jack 14 of the host device 10 viewed from the outside is regarded as high impedance).

The host device 10 transmits the ACK signal in step S48 as described above with reference to FIG. 9, but the transmission of the ACK signal is continuously repeated during a predetermined period of time, for example, 5 ms.

In the input device 20, after the synchronization of the PLL 77 is established using the clock of A of FIG. 11 (after the PLL 77 enters the lock state), the synchronization of the PLL 77 is maintained using the 2-slot pattern “10” serving as the ACK signal.

D of FIG. 11 illustrates the slave authentication pattern transmitted from the input device 20 to the host device 10.

The slave authentication pattern is an 8-slot pattern “11100010” and arranged at the head of the frame, and a period of time of the remaining two slots is regarded as high impedance (the impedance of the microphone terminal TP3 of the plug 23 of the input device 20 viewed from the outside is regarded as high impedance).

The input device 20 transmits the slave authentication pattern in step S56 as described above with reference to FIG. 9, but the transmission of the slave authentication pattern is continuously repeated during a predetermined period of time, for example, 5 ms.

During the period of time other than the first eight slots of one frame, that is, the period of time of the last two slots of one frame in which the slave authentication pattern is transmitted from the input device 20 to the host device 10, the signal (for example, the ACK signal of C of FIG. 11 or the like) is transmitted from the host device 10 to the input device 20, and in the input device 20, the synchronization of the PLL 77 is maintained using the signal transmitted from the host device 10 during the period of time of the last two slots of one frame as necessary.

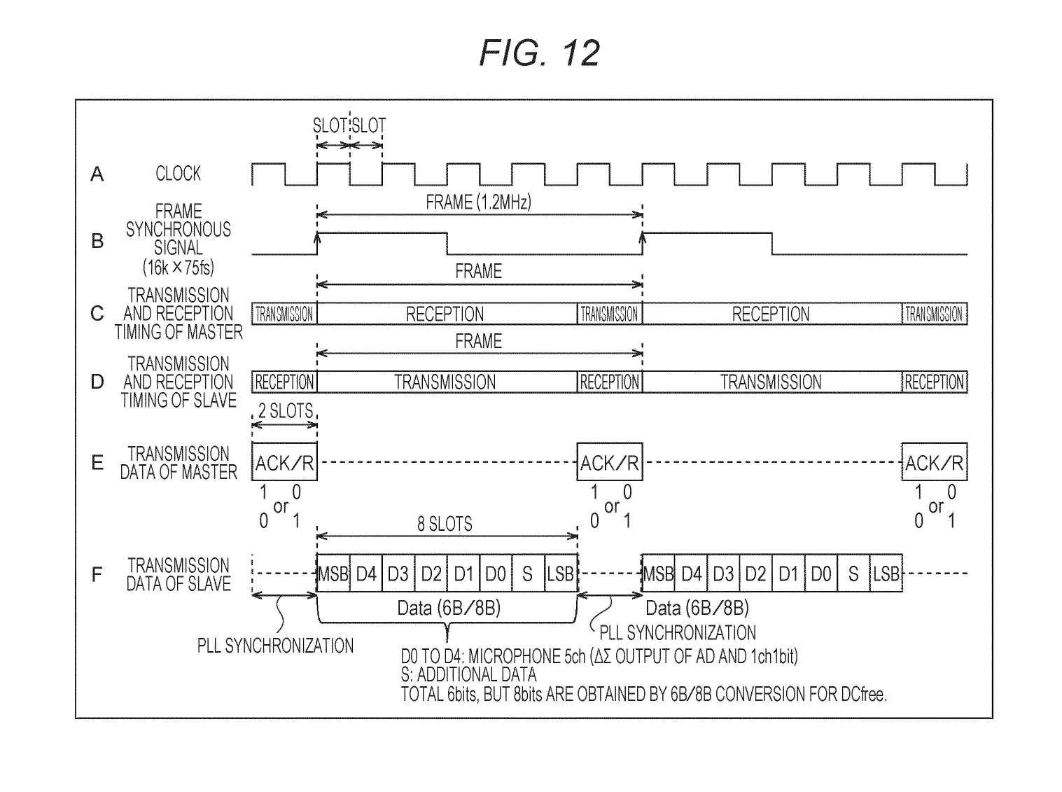

FIG. 12 is a timing chart illustrating an exemplary signal exchanged between the host device 10 and the input device 20 after it becomes possible to transceive the multiplexed data.

A of FIG. 12 illustrates a clock similar to that of A of FIG. 11.

B of FIG. 12 illustrates a frame synchronous signal indicating a head of a frame.

The frame synchronous signal is a pulse signal, and a rising edge indicates a timing of a head of a frame.

Here, in B of FIG. 12, for example, the frame synchronous signal is a pulse signal having a frequency of about 1.2 MHz.

C of FIG. 12 illustrates a signal transmission timing and a signal reception timing of the host device (hereinafter, also referred to as a “master”) 10.

The host device 10 transmits the signal to the input device 20 through the last two slots of the frame, and received the signal transmitted from the input device 20 through the first eight slots of the frame.

D of FIG. 12 illustrates a signal transmission timing and a signal reception timing of the input device (hereinafter, also referred to as a “slave”) 20.

The input device 20 transmits the signal to the host device 10 through the first eight slots of the frame, and receives the signal transmitted from the host device 10 through the last two slots of the frame.

E of FIG. 12 illustrates the signal transmitted by the host device 10.

The host device 10 transmits an ACK/R signal through the last two slots of the frame.

The ACK/R signal is a 2-slot pattern “10” or “01,” and in the input device 20, the synchronization of the PLL 77 is maintained using the ACK/R signal. Further, the ACK/R signal of each frame need not necessarily be used in maintaining the synchronization of the PLL 77.

In other words, for example, the synchronization of the PLL 77 can be maintained using the ACK/R signal of an every other frame.

F of FIG. 12 illustrates the multiplexed data transmitted by the input device 20.

The input device 20 transmits the multiplexed data through the first eight slots of the frame.

The multiplexed data of one frame is an 8-slot pattern, that is, 8-bit data, but in FIG. 12, for example, 8-bit data obtained by perform 6B/8B (6 bit/8 bit) conversion on 6-bit actual data is employed as the 8-bit data serving as the multiplexed data of one frame for DC free.

In other words, in communication between communication devices, in order to reduce power movement between the communication devices, it is desirable to perform communication through a signal having no DC component. Thus, in order to implement the DC free of reducing the DC component of the multiplexed data, in FIG. 12, the 8-bit data obtained by performing the 6B/8B conversion on the 6-bit actual data is employed as the multiplexed data of one frame.

The 6-bit actual data configuring the multiplexed data of one frame is configured with the 1-bit sound signals 0# to #4 output from the ADCs 84₀ to 84₄, that is, 1-bit sound signals (D0, D1, D2, D3, and D4) of the 5 channels and 1-bit additional data (S).

Here, if a predetermined number N of consecutive frames are referred to as a super frame, the additional data of the super frame becomes N-bit data, but in the present embodiment, a position (frame) at which the switch signal serving as the additional data, the device information, or the other data is arranged is allocated to the N-bit data serving as the additional data of the super frame in advance.

In this case, the additional data may be transmitted in units of super frames.

In FIG. 12, the 8-bit data obtained by performing the 6B/8B conversion on the 6-bit actual data is employed as the 8-bit data serving as the multiplexed data of one frame for the DC free, but, for example, when the DC free is guaranteed by a certain method other than the 6B/8B conversion, for example, 8-bit actual data can be employed as the 8-bit data serving as the multiplexed data of one frame without change.

A conversion performed for the DC free is not limited to the 6B/8B conversion.

Further, data included in the multiplexed data of one frame is not limited to the 1-bit sound signals of the 5 channels or the 1-bit additional data.

In other words, 1-bit sound signals of 6 or more channels, two- or more-bit additional data, or the like can be employed as the data included in the multiplexed data of one frame. In this case, when the multiplexed data of one frame is 9- or more-bit data, for example, 9- or more-bit data can be employed as the multiplexed data of one frame by configuring one frame with a necessary number of slots that are larger than 10 slots by a high-speed clock or the like.

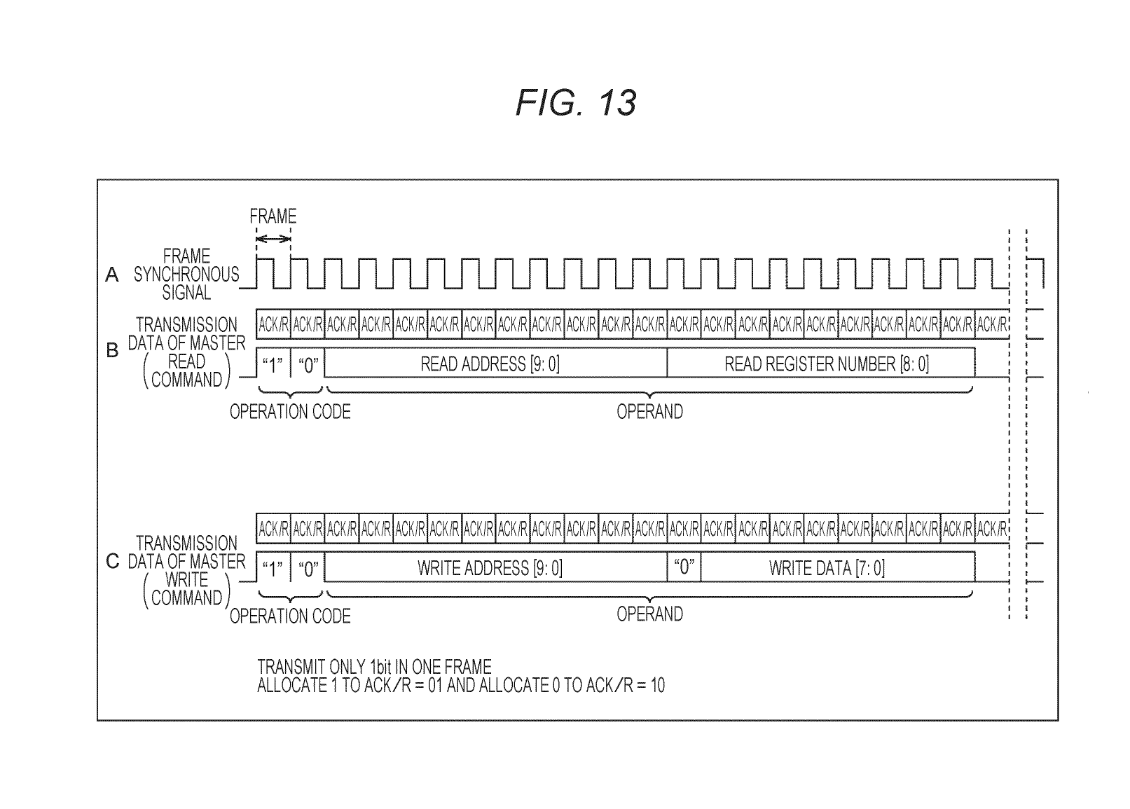

FIG. 13 is a timing chart illustrating an exemplary signal serving as a command transmitted from the host device 10 to the input device 20.

A of FIG. 13 illustrates the same frame synchronous signal as that of B of FIG. 12. In A of FIG. 13, a scale of a time axis (a horizontal direction) is smaller (coarser) than that of B of FIG. 12.

B of FIG. 13 illustrates the read command.

For example, the host device 10 transmits one read command using ACK/R signals (E of FIG. 12) of 21 frames as illustrated in B of FIG. 13.

Among the ACK/R signals of the 21 frames, ACK/R signals of the first two frames configure the operation code of the read command, and ACK/R signals of the remaining 19 frames configure an operand of the read command.

Two bits “10” are employed as the operation code of the read command.

Here, as described above with reference to E of FIG. 12, one ACK/R signal of one frame is the 2-slot pattern “10” or “01,” and in FIG. 13, one bit “1” configuring the command is allocated to the ACK/R signal=“10.” Further, one bit “0” configuring the command is allocated to the ACK/R signal=“01.”

Thus, the two bits “10” serving as the operation code of the read command is indicated by the 4-slot pattern “10” and “01” serving as the ACK/R signals of the two frames.

A 10-bit read address (a beginning address) and a 9-bit read address (register) number are employed as the operand of the read command.

In the input device 20 that has received the read command, the 10-bit read address of the operand of the read command is used as the beginning address, and data of an address of a number indicated by the 9-bit read address number of the operand of the read command from the beginning address is read, included in, for example, the additional data, and transmitted to the host device 10.

Even in the read address and the read address number serving as the operand of the read command, similarly to the operation code of the read command, the bit “1” is indicated by the ACK/R signal=“10,” and the bit “0” is indicated by the ACK/R signal=“01.” The same applies to the write command which will be described later.

C of FIG. 13 illustrates the write command.

For example, the host device 10 transmits one write command using the ACK/R signals of the 21 frames (E of FIG. 12), similarly to the read command of B of FIG. 13 as illustrated in C of FIG. 13.

Among the ACK/R signals of the 21 frames, the ACK/R signals of the first two frames configure the operation code of the write command, and the ACK/R signals of the remaining 19 frames configure the operand of the write command.

Two bits “11” are employed as the operation code of the write command.

A 10-bit write address, a fixed 1 bit “0,” and 8-bit write data are employed as the operand of the write command.

In the input device 20 that has received the write command, the 8-bit write data of the operand of the write command is written in the 10-bit write address of the operand of the write command.

Thus, in the present embodiment, a storage region (a storage region indicated by one address) of one address of an address space of the input device 20 is an 8-bit storage region.

The address space of the input device 20 is a storage region indicated by 1024 (=2¹⁰) (or less) addresses.

<Application of Host Device 10 and Input Device 20>

For example, the host device 10 and the input device 20 can be applied to a system that performs noise reduction (NR), a system that performs beam forming, or a system that performs various kinds of other signal processing.

Here, in this specification, the NR includes the NC and the noise suppression.

The NC refers to a technique of obtaining a sound (sound wave) in which a noise is removed (reduced) such that a noise works on (is added to) a sound emitted from a driver to a real space (the air) in the real space.

On the other hand, the noise suppression refers to a technique of obtaining a sound signal in which a noise is removed by performing signal processing on the sound signal.

Thus, the NC and the noise suppression are the same in that a noise is removed, but the difference between the NC and the noise suppression lies in that in the NC, the noise removal is performed in the real space, whereas in the noise suppression, the noise removal is performed by the signal processing.

Before describing an application to which the host device 10 and the input device 20 are applied, the NC and the noise suppression will be described as preparation of a preliminary step.

Examples of the NC include a feedback (FB) scheme, a feedforward (FF) scheme, and an FF+FB scheme.

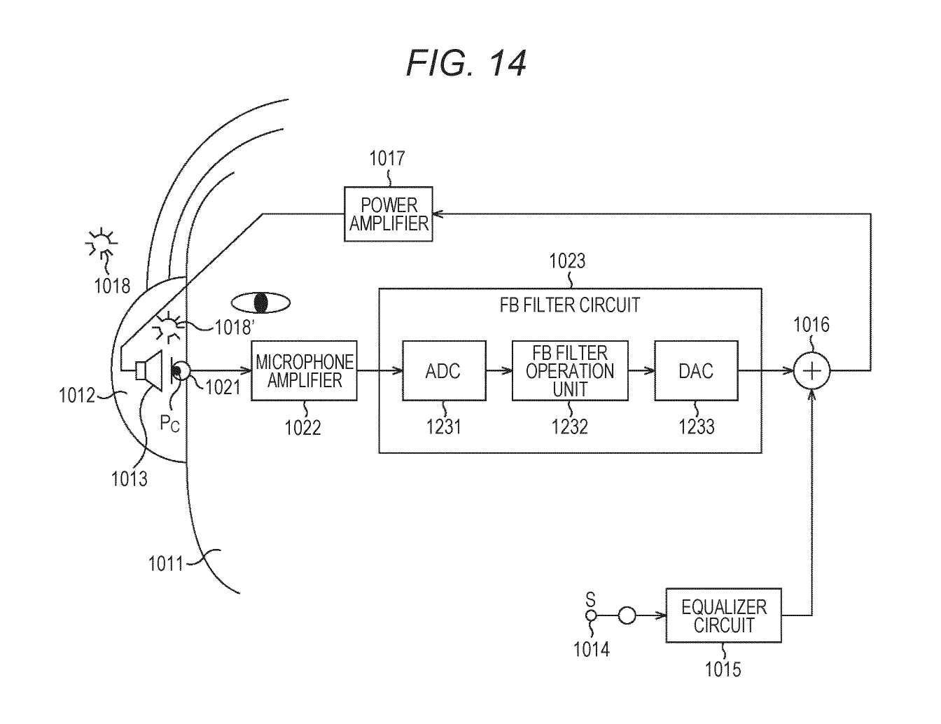

FIG. 14 is a block diagram illustrating an exemplary configuration of the NC system of the FB scheme that performs the NC of the FB scheme.

In FIG. 14, a listener (a user) 1011 wears a headphone, and the right ear of the listener 1011 is covered with a right ear headphone housing (housing unit) 1012.

In FIG. 14, for the sake of simple description, only a configuration for a portion of the headphone at the right ear side of the listener 11 is illustrated, but a portion at the left ear side has a similar configuration. The same applies to the NC system of the FF scheme that performs the NC of the FF scheme which will be described later and the NC system of the FF+FB scheme that performs the NC of the FF+FB scheme.

A driver (headphone driver) 1013 serving as an electroacoustic conversion unit that reproduces a sound signal serving as an electric signal as a sound is installed inside the headphone housing 1012.

In FIG. 14, a music (sound) signal is supplied from a sound signal input terminal 1014 to a power amplifier 1017 via an equalizer 1015 and an addition circuit 1016. The power amplifier 1017 amplifies the music signal supplied thereto and supplies the amplified music signal to the driver 1013, and a corresponding sound is output from the driver 1013. As a result, the right ear of the listener 1011 senses a reproduced sound of the music signal.

For example, the sound signal input terminal 1014 is configured with a headphone plug plugged into a headphone jack of a music player (not illustrated).

In the NC system of the FB scheme of FIG. 14, the equalizer 1015, the addition circuit 1016, and the power amplifier 1017 are installed on a sound signal transmission path between the sound signal input terminal 1014 and the driver 1013.

The NC system of the FB scheme of FIG. 14 includes a microphone 1021 serving as an acoustoelectric conversion unit, a microphone amplifier 1022, and an FB filter circuit 1023.

In the NC system of the FB scheme of FIG. 14, a noise entering a cancellation point Pc (which will be described later) of the listener 1011 in the headphone housing 1012 from a noise source 1018 outside the headphone housing 1012 in a music listening environment of the listener 1011 is reduced. As a result, the listener 1011 can listen to music in a good environment.

In the NC system of the FB scheme, a noise of the cancellation point Pc that is fictitiously recognized as an auditory position of the listener 1011 sensing a sound (sound wave) and combines a noise with a reproduced sound of a sound output from the driver 1013 is acquired by the microphone 1021.

Thus, in the NC system of the FB scheme, the microphone 1021 is installed at the cancellation point Pc inside the headphone housing (housing unit) 1012 as a noise acquisition microphone. For example, a position in front of a vibrating plate of the driver 1013 which is a position close to an ear is employed as the cancellation point Pc, and the microphone 1021 is installed at (a position close to) the cancellation point Pc.

In the NC system of the FB scheme, the noise entering the headphone housing 1012 from the outside can be reduced by generating a reverse phase of the noise acquired by the microphone 1021 as an NC sound signal, supplying the NC sound signal to the driver 11, and reproducing the sound.

Here, the noise in the noise source 1018 is not the same in characteristics as a noise 1018′ entering the headphone housing 1012. In the NC system of the FB scheme, the noise 1018′ entering the headphone housing 1012, that is, the noise 1018′ of a reduction target is acquired by the microphone 1021.

In the NC system of the FB scheme, the reverse phase of the noise 1018′ is generated so that the noise 1018′ acquired at the cancellation point Pc through the microphone 1021 is cancelled.

In FIG. 14, the NC sound signal serving as the reverse phase of the noise 1018′ is generated using the FB filter circuit 1023.

The FB filter circuit 1023 includes an FB filter operation unit 1232, an ADC 1231 installed in front of the FB filter operation unit 1232, and a DAC 1233 installed behind the FB filter operation unit 1232.

An analog sound signal acquired by the microphone 1021 is supplied to the FB filter circuit 1023 via the microphone amplifier 1022 and AD-converted into a digital sound signal by the ADC 1231. The digital sound signal is supplied to the FB filter operation unit 1232.

For example, the FB filter operation unit 1232 is configured with a digital signal processor (DSP) or the like, and performs an operation (hereinafter, also referred to as an “FB filter operation”) of a digital filter for generating a digital NC sound signal of the FB scheme. The digital filter generates a digital NC sound signal having characteristics according to a filter coefficient serving as a parameter set thereto from the digital sound signal input thereto. A predetermined filter coefficient is set to the digital filter of the FB filter operation unit 1232.

The digital NC sound signal generated by the FB filter operation unit 1232 is DA-converted into an analog NC sound signal in the DAC 1233. Then, the analog NC sound signal is supplied to the addition circuit 1016 as an output signal of the FB filter circuit 1023.

An input sound signal (the music signal or the like) S that is intended to be listened by the listener 1011 through the headphone is supplied to the addition circuit 1016 via the sound signal input terminal 1014 and the equalizer 1015. The equalizer 1015 performs sound quality correction by changing frequency characteristics of the input sound signal.

The addition circuit 1016 adds the input sound signal outputs from the equalizer 1015 to the NC sound signal serving as the output signal of the FB filter circuit 1023.

An addition result sound signal of the addition circuit 1016 is supplied to the driver 1013 via the power amplifier 1017 and reproduced. The sound that is reproduced and emitted by the driver 1013 includes a sound reproduction component by the NC sound signal generated in the FB filter circuit 1023. The sound reproduction component by the NC sound signal among the sound that is reproduced and emitted by the driver 1013 is combined with the noise 1018′, and thus the noise 1018′ is reduced (cancelled) at the cancellation point Pc.

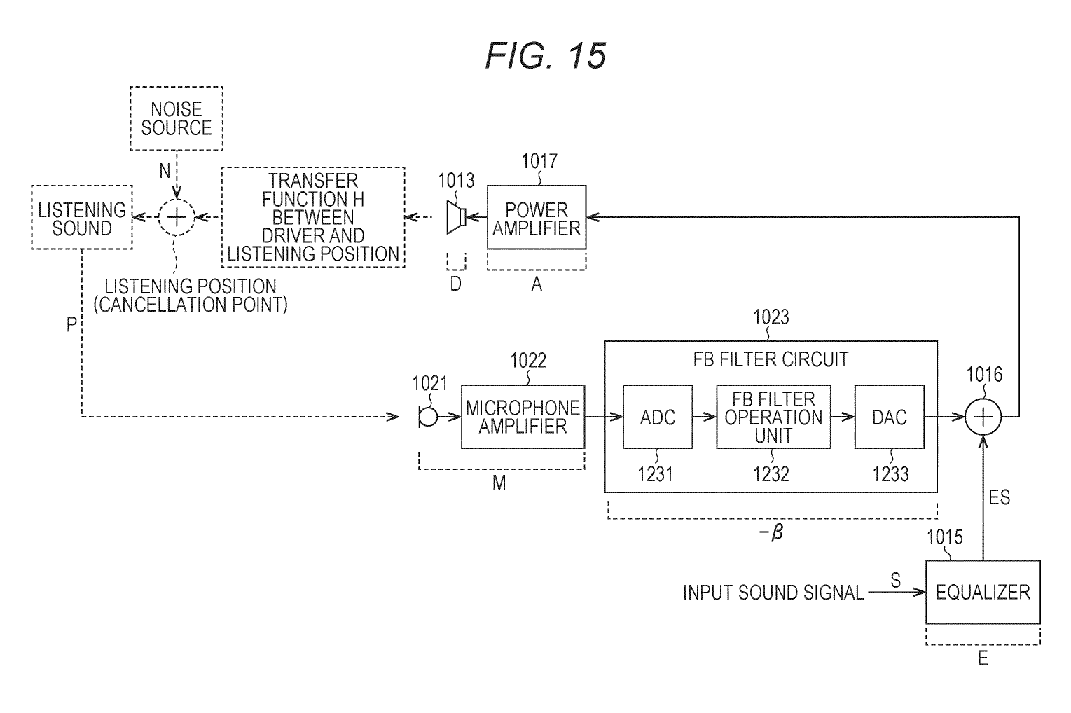

FIG. 15 is a diagram for describing a transfer function of the NC system of the FB scheme of FIG. 14.

As illustrated in FIG. 15, A indicates a transfer function of the power amplifier 1017, D indicates a transfer function of the driver 1013, M indicates a transfer function corresponding to a portion of the microphone 1021 and the microphone amplifier 1022, -β indicates a transfer function of the FB filter circuit 1023, H indicates a transfer function of a space from the driver 1013 to the cancellation point (the auditory position) Pc (eventually, the microphone 1021), and E indicates a transfer function of the equalizer 1015.

N indicates a noise entering the neighborhood of the position of the microphone 1021 in the headphone housing 1012 from the external noise source 1018, and P indicates a listening sound listened by the listener 1011 by means of sound pressure aching the ear of the listener 1011.

Further, as a case in which an external noise is transferred to the inside of the headphone housing 1012, for example, there are a case in which a sound leaks from a gap of an ear pad portion of a headphone as sound pressure and a case in which a sound is transferred to the inside of the headphone housing 1012 as the headphone housing 1012 receives the sound pressure and vibrates.

The transfer function of the NC system of the FB scheme of FIG. 14 is expressed by Formula (1):

P=(1/(1+ADHMβ))×N+(AHD/(1+ADHMβ))×ES (1)

If Formula (2) is held, Formula (1) is expressed by Formula (3):

E=1+ADHMβ (2)

P=(1/(1+ADHMβ))×N+ADHS (3)

According to Formula (3), the noise N decays to 1/(1+ADHMβ).

Thus, according to the NC system of the FB scheme of FIG. 14, the listener 1011 can listen to a sound of a listening target in which a noise has been reduced.

Further, in the NC system of the FB scheme of FIG. 14, in order to perform sufficient noise reduction, it is necessary to set a filter coefficient according to characteristics of the noise 1018′ transferred to the inside of the headphone housing 1012 to the digital filter of the FB filter operation unit 1232. In other words, the filter coefficient of the FB filter operation unit 1232 is set based on, for example, the transfer function M serving as characteristics of the microphone 1021 and the microphone amplifier 1022, the transfer function D serving as characteristics of the driver 1013, or the like so that the noise N included in the listening sound P expressed by Formula (3) can be appropriately reduced.

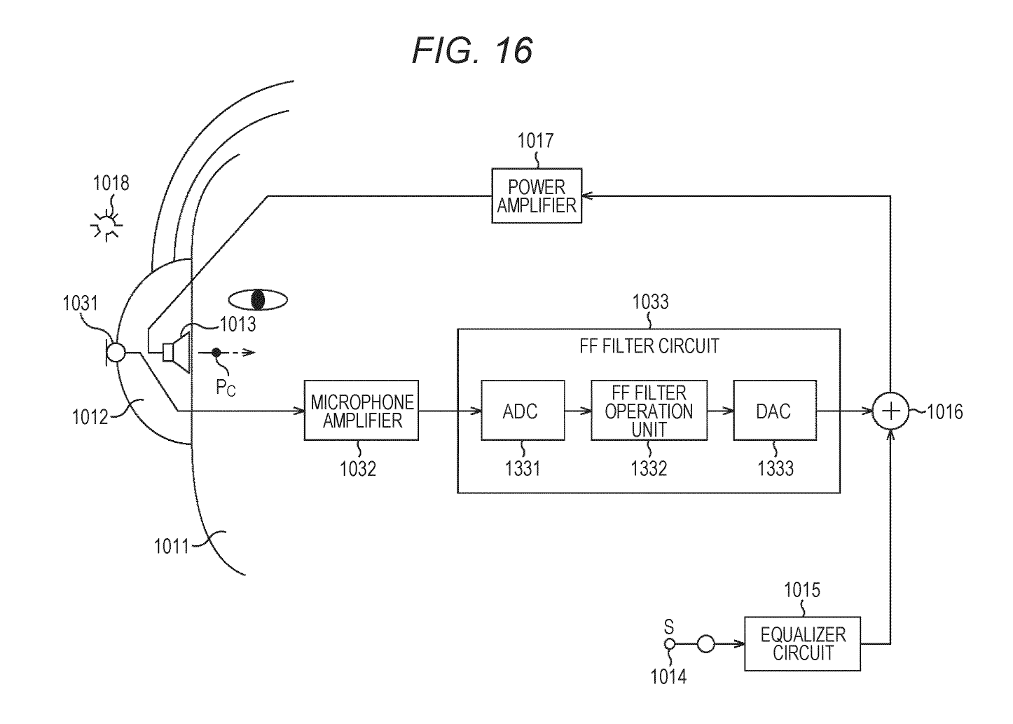

FIG. 16 is a block diagram illustrating an exemplary configuration of the NC system of the FF scheme that performs the NC of the FF scheme.

In FIG. 16, parts corresponding to those in FIG. 14 are denoted by the same reference numerals, and hereinafter, a description thereof will be appropriately omitted.

According to the NC system of the FF scheme of FIG. 16, in the music listening environment of the listener 1011, a noise entering the cancellation point Pc of the listener 1011 in the headphone housing 1012 from the noise source 1018 outside the headphone housing 1012 is reduced. As a result, the listener 1011 can listen to music in the good environment.

In the NC system of the FF scheme, a microphone 1031 is installed outside the headphone housing 1012 as illustrated in FIG. 16. In the NC system of the FF scheme, an appropriate filtering process is performed on the noise 1018 acquired by the microphone 1031 to generate the NC sound signal. In the NC system of the FF scheme, the generated NC sound signal is reproduced by the driver 1013 in the headphone housing 1012 to cancel the noise (the noise 1018′) at a position close to the ear of the listener 1011.

The noise 18 acquired by the microphone 1031 and the noise 1018′ inside the headphone housing 1012 have different characteristics according to a difference in a spatial position of both (a difference between the inside and the outside of the headphone housing 1012). In this regard, in the NC system of the FF scheme, the NC sound signal is generated in view of the difference in a spatial transfer function between the noise from the noise source 1018 acquired by the microphone 1031 and the noise 1018′ at the cancellation point Pc.

In the NC system of the FF scheme of FIG. 16, the NC sound signal is generated using an FF filter circuit 1033.

The FF filter circuit 1033 includes an FF filter operation unit 1332, an ADC 1331 installed in front of the FF filter operation unit 1332, and a DAC 1333 installed behind the FF filter operation unit 1332.

An analog sound signal acquired by the microphone 1031 is supplied to the FF filter circuit 1033 via a microphone amplifier 1032, and AD-converted into a digital sound signal by the ADC 1331. The digital sound signal is supplied to the FF filter operation unit 1332.

For example, the FF filter operation unit 1332 is configured with a DSP, and performs an operation (hereinafter, also referred to as an “FF filter operation”) of a digital filter for generating the digital NC sound signal. The digital filter generates a digital NC sound signal having characteristics according to a filter coefficient serving as a parameter set thereto from the digital sound signal input thereto. A predetermined filter coefficient is set to the digital filter of the FF filter operation unit 1332.

The digital filter of the FF filter operation unit 1332 generates the digital NC sound signal according to the set filter coefficient.

Then, the digital NC sound signal generated by the FF filter operation unit 1332 is DA-converted into an analog NC sound signal in the DAC 1333 and supplied to the addition circuit 1016 as an output signal of the FF filter circuit 1033.

The input sound signal (the music signal or the like) S that is intended to be listened by the listener 1011 through the headphone is supplied to the addition circuit 1016 via the sound signal input terminal 1014 and the equalizer 1015.

The addition circuit 1016 adds the input sound signal to the NC sound signal serving as the output signal of the FF filter circuit 1033.

An addition result sound signal of the addition circuit 1016 is supplied to the driver 1013 via the power amplifier 1017 and reproduced. The sound that is reproduced and emitted by the driver 1013 includes a sound reproduction component by the NC sound signal generated in the FF filter circuit 1033. The sound reproduction component by the NC sound signal among the sound that is reproduced and emitted by the driver 1013 is combined with the noise 1018′, and thus the noise 1018′ is reduced (cancelled) at the cancellation point Pc.

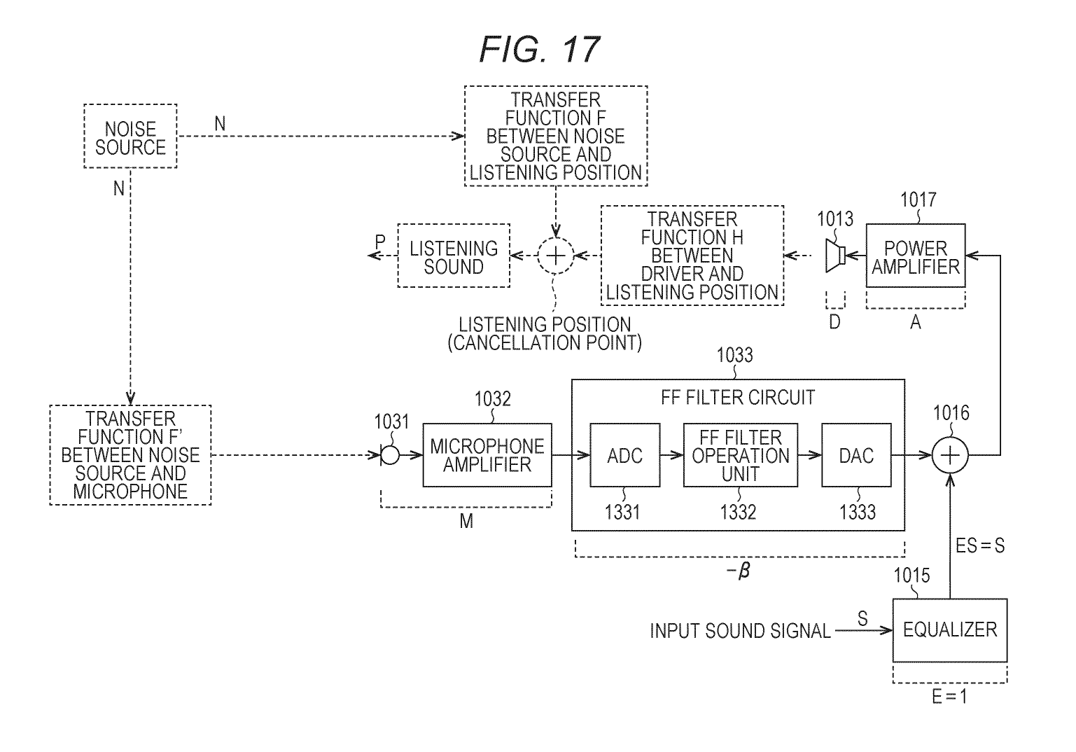

FIG. 17 is a diagram for describing the transfer function of the NC system of the FF scheme of FIG. 16.

As illustrated in FIG. 17, A indicates a transfer function of the power amplifier 1017, D indicates a transfer function of the driver 1013, M indicates a transfer function corresponding to a portion of the microphone 1031 and the microphone amplifier 1032, -α indicates a transfer function of the FF filter circuit 1033, H indicates a transfer function of a space from the driver 1013 to the cancellation point (the auditory position) Pc, E indicates a transfer function of the equalizer 1015, and F indicates a transfer function from the external noise source 1018 to the position of the cancellation point Pc of the ear of the listener 1011. Here, E=1 is assumed.

Further, if F′ indicates a transfer function from the noise source 1018 to the microphone 1031, N indicates a noise of the external noise source 1018, and P indicates a listening sound listened by the listener 1011, the transfer function of the NC system of the FF scheme of FIG. 16 is expressed by Formula (4):

P=−F′ADHMα×N+F×N+AHD×S (4)

Here, when Formula (5) is held, Formula (4) is expressed by Formula (6):

F=F′ADHMα (5)

P=ADHS (6)

According to Formula (6), the noise N is cancelled, a sound signal S of a listening target remains. Thus, according to the NC system of the FF scheme of FIG. 16, the listener 1011 can listen to the sound of the listening target in which the noise has been reduced.

The filter coefficient of the FF filter operation unit 1332 is set based on, for example, the transfer function M serving as characteristics of the microphone 1031 and the microphone amplifier 1032, the transfer function D serving as characteristics of the driver 1013, or the like so that the listening sound P is expressed by Formula (6), that is, Formula (5) is held as much as possible.

In the NC system of the FF scheme, a vibration possibility is low, and stability is high, but there are cases in which it is difficult to sufficiently reduce the noise. On the other hand, in the NC system of the FB scheme, the noise is expected to be sufficiently reduced, but it is necessary to pay attention to stability of the system.

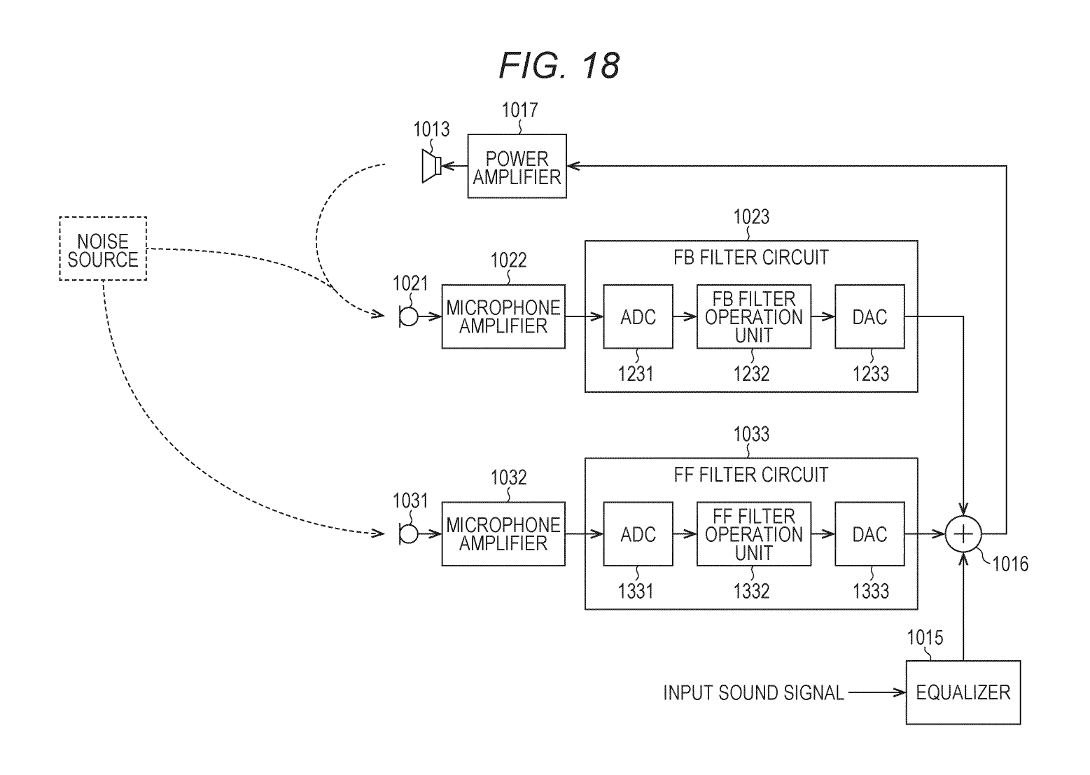

FIG. 18 is a block diagram illustrating an exemplary configuration of the NC system of the FF+FB scheme that performs the NC of the FF+FB scheme.

In FIG. 18, parts corresponding to those in FIGS. 14 and 16 are denoted by the same reference numerals, and hereinafter, a description thereof will be appropriately omitted.

The NC system of the FF+FB scheme is described in detail in Japanese Patent No. 4631939.

In the NC system of the FF+FB scheme, both the NC sound signal generated by the NC system of the FB scheme (FIG. 14) and the NC sound signal generated by the NC system of the FF scheme (FIG. 16) are used for noise reduction.

In other words, in the NC system of the FF+FB scheme of FIG. 18, the microphone 1021 installed in the headphone housing 1012 collects, for example, a noise (sound) input thereto, a sound output from the driver 1013, and the like. A sound signal corresponding to the sound collected by the microphone 1021 is amplified by the microphone amplifier 1022 and then supplied to the FB filter circuit 1023.

In the FB filter circuit 1023, the FB filter operation unit 1232 performs a filter operation (for example, a product sum operation) using a predetermined filter coefficient on the sound signal corresponding to the sound collected by the microphone 1021, and supplies the resulting sound signal to the addition circuit 1016 as a sound signal for the NC of the FB scheme.

Meanwhile, the microphone 1031 installed outside the headphone housing 1012 collects, for example, a noise (sound) input thereto or the like. A sound signal corresponding to the sound collected by the microphone 1031 is amplified by the microphone amplifier 1032 and supplied to the FF filter circuit 1033.

In the FF filter circuit 1033, the FF filter operation unit 1332 performs a filter operation (for example, the product sum operation) using a predetermined filter coefficient on the sound signal corresponding to the sound collected by the microphone 1031, and supplies the resulting sound signal to the addition circuit 1016 as a sound signal for the NC of the FF scheme.

The addition circuit 1016 adds the sound signal for the NC of the FB scheme supplied from the FB filter circuit 1023, the sound signal for the NC of the FF scheme supplied from the FF filter circuit 1033, and the input sound signal that serves as the sound signal corresponding to the sound of the listening target and is supplied from the equalizer 1015, and supplies a sound signal obtained as a result of addition to the power amplifier 1017.

The power amplifier 1017 amplifies the sound signal supplied from the addition circuit 1016, and supplies the amplified sound signal to the driver 1013. The driver 1013 outputs (reproduces) the sound corresponding to the sound signal supplied from the power amplifier 1017.

The sound output from the driver 1013 includes the sound corresponding to the sound signal for the NC of the FB scheme and the sound corresponding to the sound signal for the NC of the FF scheme, but the sound corresponding to the sound signal for the NC of the FB scheme and the sound corresponding to the sound signal for the NC of the FF scheme are added to the noise at the cancellation point Pc until the sound output from the driver 1013 is transferred through the real space and sensed by the listener 1011 and thus cancelled together with the noise.

As a result, the listening sound P that the listener 1011 can listen is the sound in which the noise has been appropriately reduced.

Next, the noise suppression will be described.

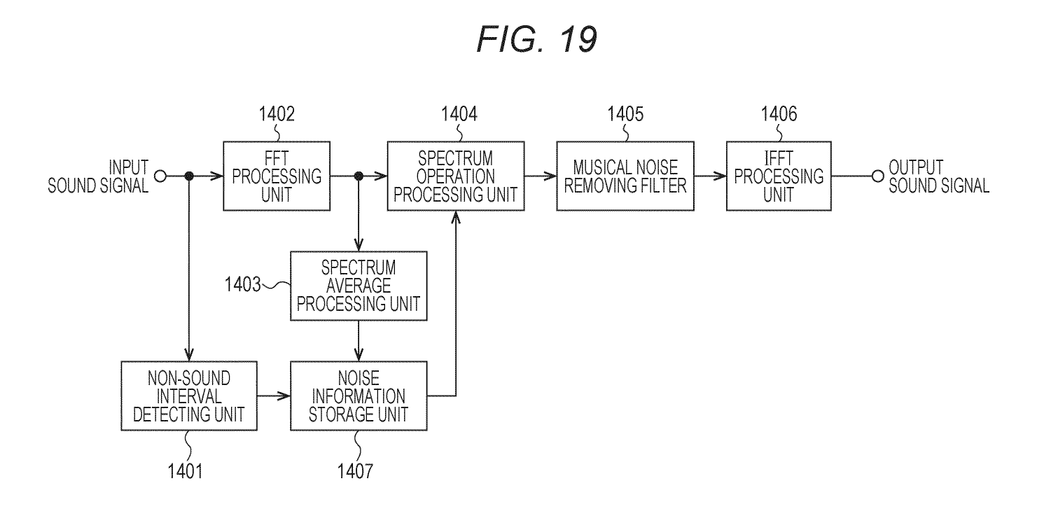

FIG. 19 is a block diagram illustrating an exemplary configuration of a noise suppression system that performs noise suppression.

The noise suppression system of FIG. 19 reduces (removes) a noise, for example, through a spectral subtraction (SS) technique.

In other words, in the noise suppression system of FIG. 19, an input sound signal serving as a sound signal of a noise suppression target is supplied to a non-sound interval detecting unit 1401 and a fast Fourier transform (FFT) processing unit 1042.

The non-sound interval detecting unit 1401 detects an interval (a non-sound interval) that is not a sound interval from the input sound signal, and supplies the non-sound interval signal indicating the non-sound interval to a noise information storage unit 1407.

In other words, the non-sound interval detecting unit 1401 detects the sound interval from the input sound signal, for example, through a predetermined technique, and detects an interval other than the sound interval as the non-sound interval.

The FFT processing unit 1402 performs the FFT on the input sound signal, and supplies a spectrum serving as a signal of a frequency domain obtained as a result to a spectrum average processing unit 1403 and a spectrum operation processing unit 1404.

The spectrum average processing unit 1403 averages the spectra supplied from the FFT processing unit 1402, and supplies the resulting average spectrum to the noise information storage unit 1407.

The spectrum operation processing unit 1404 subtracts a spectrum serving as noise information stored in the noise information storage unit 1407 from the spectrum supplied from the FFT processing unit 402, and supplies a spectrum obtained as a result of subtraction to a musical noise removing filter 1405.

The musical noise removing filter 1405 performs filtering for removing the musical noise on the spectrum supplied from the spectrum operation processing unit 1404, and supplies the spectrum in which the musical noise has been removed to an inverse FFT (IFFT) processing unit 1406.

The IFFT processing unit 1406 performs the IFFT on the spectrum supplied from the musical noise removing filter 1405, and outputs a sound signal serving as a signal of a time domain obtained as a result as an output sound signal that has undergone the noise suppression.

The noise information storage unit 1407 recognizes the non-sound interval based on the non-sound interval signal supplied from the non-sound interval detecting unit 1401, and stores the average spectrum of the non-sound interval among the average spectra supplied from the spectrum average processing unit 1403 as a noise spectrum.

In the noise suppression system having the above configuration, the input sound signal is supplied to the non-sound interval detecting unit 1401 and the FFT processing unit 1042.

The non-sound interval detecting unit 1401 detects the non-sound interval from the input sound signal, and supplies the non-sound interval signal indicating the non-sound interval to the noise information storage unit 1407.

The FFT processing unit 1402 performs the FFT on the input sound signal, and supplies the resulting spectrum to the spectrum average processing unit 1403 and the spectrum operation processing unit 1404.

The spectrum average processing unit 1403 averages the spectra supplied from the FFT processing unit 1402, and supplies the resulting average spectrum to the noise information storage unit 1407.

The noise information storage unit 1407 recognizes the non-sound interval based on the non-sound interval signal supplied from the non-sound interval detecting unit 1401, and stores the average spectrum of the non-sound interval among the average spectra supplied from the spectrum average processing unit 1403 as the noise spectrum.

Then, the spectrum operation processing unit 1404 reads the latest spectrum among the noise spectra serving as the noise information stored in the noise information storage unit 1407, and subtracts the read spectrum from the spectrum supplied from the FFT processing unit 402. The spectrum operation processing unit 1404 supplies the spectrum obtained by the subtraction to the musical noise removing filter 1405 as the spectrum in which the noise has been removed.

The musical noise removing filter 1405 removes the musical noise of the spectrum supplied from the spectrum operation processing unit 1404, and supplies the resulting spectrum to the IFFT processing unit 1406.

The IFFT processing unit 1406 performs the IFFT on the spectrum supplied from the musical noise removing filter 1405, and outputs the output sound signal obtained as a result.

For example, when the input sound signal is a signal including a sound, the output sound signal obtained as described above becomes a signal in which the noise has been reduced, and the sound has been emphasized.

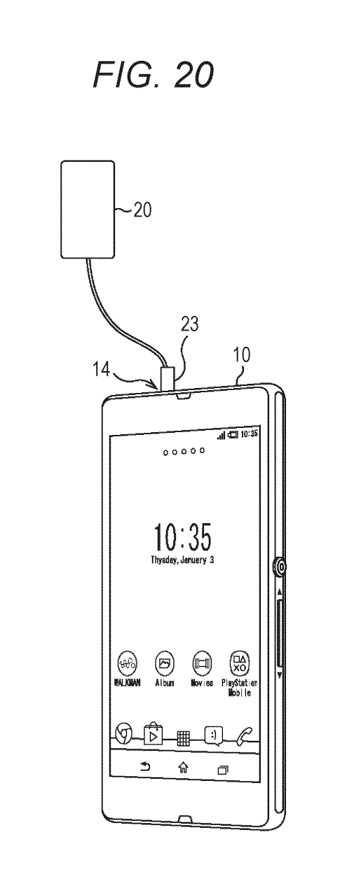

FIG. 20 is a perspective view illustrating an exemplary external appearance configuration of an application system to which the host device 10 and the input device 20 are applied.

Referring to FIG. 20, the host device 10 is applied to (employed in) a smartphone, and the input device 20 is applied to an input interface for inputting various data to the host device 10 when the plug 23 is inserted into the jack 14 of the host device 10 serving as the smartphone.

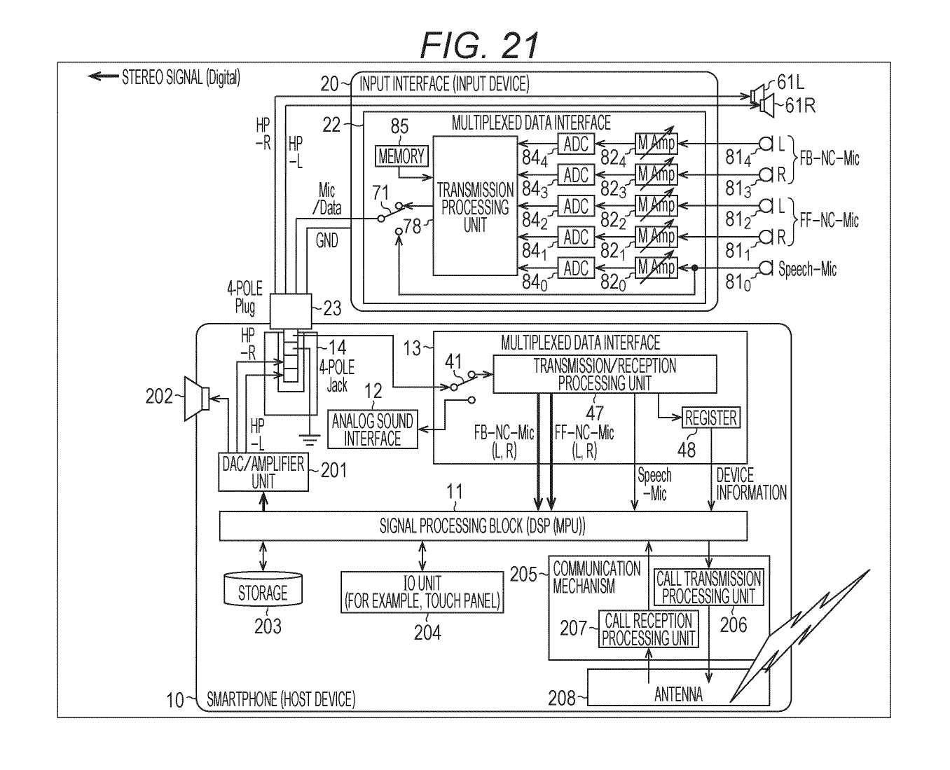

FIG. 21 is a block diagram illustrating an exemplary electrical configuration of the application system of FIG. 20.

In FIG. 21, parts corresponding to those in FIG. 2 are denoted by the same reference numerals, and hereinafter, a description thereof will be appropriately omitted.

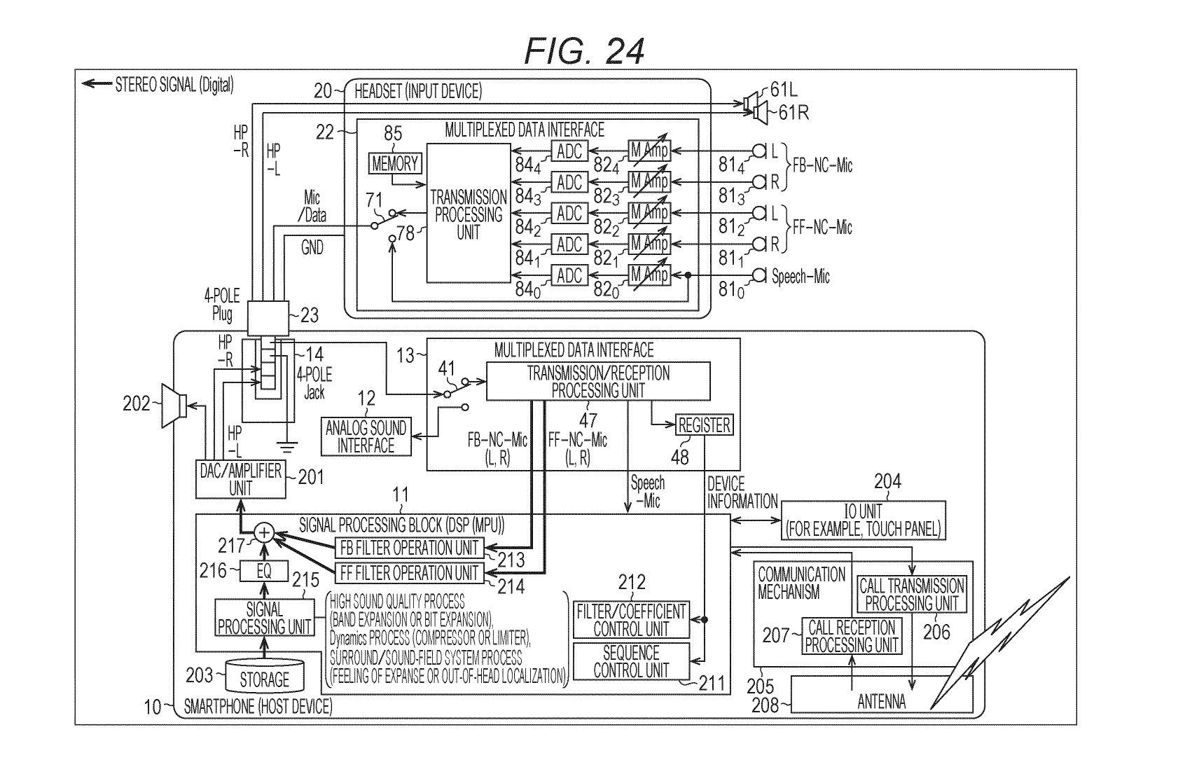

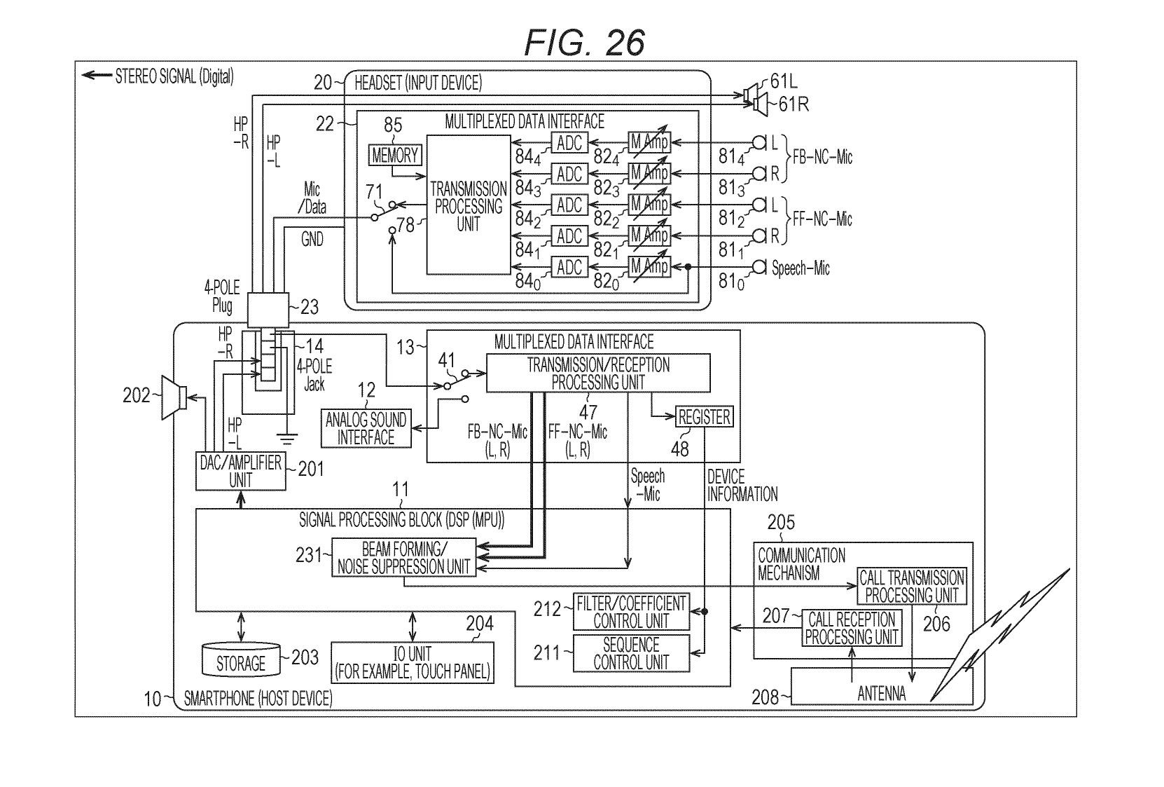

In FIG. 21, in order to avoid a complicated drawing, some blocks of FIG. 2 are not illustrated (the same applies to FIGS. 24 and 26 which will be described later).

In other words, in the host device 10, the blocks of the clock generating unit 15, the resistor 33, the capacitor 43, the microphone detecting unit 44, the association detecting unit 45, the interrupter 46, the register 48, and the I²C interface 49 of FIG. 2 are not illustrated in FIG. 21, but the host device 10 of FIG. 21 includes these blocks as necessary.

In the input device 20, the blocks of the switch 80, the resistors 83₀ to 83₄, the capacitor 72, the association detecting unit 73, the LDO 74, the control unit 75, and the PLL 77 are not illustrated in FIG. 21, but the input device 20 of FIG. 21 includes these blocks as necessary.

Referring to FIG. 21, the host device 10 serving as the smartphone includes a DAC/amplifier unit 201, a driver 202, a storage 203, an input output (IO) unit 204, a communication mechanism 205, and an antenna 208 in addition to the signal processing block 11, the analog sound interface 12, the multiplexed data interface 13, the jack 14, and the clock generating unit 15 (not illustrated in FIG. 21).

The DAC/amplifier unit 201 corresponds to, for example, the DAC 31 and the power amplifier 32 of FIG. 2, DA-converts a digital sound signal supplied from the signal processing block 11 into an analog sound signal, amplifies the analog sound signal, and supplies the amplified analog sound signal to the jack 14 or the driver 202.

The driver 202 is a sound output unit (for example, a transducer that is configured with a coil, a vibrating plate, and the like and converts a sound signal into a sound (a sound wave) serving as air vibrations) installed in the host device 10 serving as the smartphone, and outputs (emits) the sound corresponding to the sound signal supplied from the DAC/amplifier unit 201.

For example, the storage 203 is a storage medium such as a hard disk or semiconductor memory. For example, the sound signal supplied from the signal processing block 11 according to control of the signal processing block 11 is stored (recorded) in the storage 203. For example, the sound signal stored in the storage 203 is read according to control of the signal processing block 11 and supplied to the signal processing block 11.

The IO unit 204 is, for example, a touch panel or a physical button, and operated by the user. The input unit 204 supplies an operation signal corresponding to an operation of the user to the signal processing block 11.

The IO unit 204 displays a graphical user interface (GUI) such as a virtual button and other images according to control of the signal processing block 11.

The communication mechanism 205 includes a call transmission processing unit 206 and a call reception processing unit 207, and functions as a communication interface that performs communication with a network such as the Internet, a base station of a mobile phone, or the like.

The call transmission processing unit 206 performs a process necessary for transmitting the sound (voice) signal supplied from the signal processing block 11 to the base station of the mobile phone, and supplies the resulting sound signal to the antenna 208.

The call reception processing unit 207 performs a process necessary for restoring a sound (voice) signal of a call counterpart from a signal obtained by receiving a radio wave that is transmitted from the base station of the mobile phone and supplied from the antenna 208, and supplies the resulting sound signal to the signal processing block 11.

Here, the device information related to the input device 20 is stored in the non-volatile memory 85 of the input device 20, and the host device 10 can read the device information stored in the non-volatile memory 85 of the input device 20 and perform appropriate signal processing for the input device 20 based on the device information of the input device 20 through the signal processing block 11.

The NC will be described as an example of the appropriate signal processing performed for the input device 20 based on the device information of the input device 20 through the signal processing block 11 of the host device 10 as described above.

As a method of configuring the NC system, there are a method of implementing a function of performing the NC process in a headphone and a method of implementing a function of performing the NC process in a sound signal reproducing device having a sound signal reproduction function to which, for example, a music player, a smartphone, or any other headphone can be connected.

Since the headphone having the function of performing the NC process can perform the NC process in itself, the NC process can be performed regardless of a sound signal reproducing device to which the headphone is connected (not connected).

On the other hand, when the function of performing the NC process is implemented in the sound signal reproducing device, an appropriate FB filter operation or an appropriate FF filter operation (hereinafter, both operations are also referred to collectively as an “NC filter operation”) is performed for a headphone (hereinafter, also referred to as a “connected headphone”) connected to the sound signal reproducing device, and a filter coefficient corresponding to the connected headphone is stored in the sound signal reproducing device, and thus an appropriate NC process can be performed for a connected headphone.

Further, a plurality of coefficient sets, for example, a coefficient set NCHP-1 corresponding to a first headphone and a coefficient set NCHP-2 corresponding to a second headphone are stored in the sound signal reproducing device as a coefficient set of the filter coefficients. When the first headphone is connected to the sound signal reproducing device, the coefficient set NCHP-1 corresponding to the first headphone is selected by the user, and when the second headphone is connected to the sound signal reproducing device, the coefficient set NCHP-2 corresponding to the second headphone is selected by the user. Thus, even when any of the first and second headphones is connected to the sound signal reproducing device, the appropriate NC process can be performed for the headphone connected to the sound signal reproducing device.

Further, when the function of performing the NC process is implemented in the sound signal reproducing device as described above, a vendor of a headphone releases a new third headphone, and a coefficient set NCHP-3 corresponding to the third headphone is opened on a network such as the Internet, if the sound signal reproducing device has a network connection function of connecting to a network, the sound signal reproducing device downloads the coefficient set NCHP-3 on the network, and then the appropriate NC process can be performed for the third headphone.

However, when the sound signal reproducing device has no network connection function, if the new third headphone is released, the sound signal reproducing device hardly download and acquire the coefficient set NCHP-3 corresponding to the new third headphone.

Meanwhile, when the host device 10 and the input device 20 are applied to the NC system, and the host device 10 and the input device 20 are configured as the sound signal reproducing device and the headphone (headset), although the host device 10 serving as the sound signal reproducing device has no network connection function, if the input device 20 is released as the third headphone, the host device 10 serving as the sound signal reproducing device can acquire the coefficient set NCHP-3 corresponding to the input device 20 serving as the third headphone.

In other words, a coefficient set (hereinafter, also referred to as a “corresponding coefficient set”) corresponding to the input device 20 serving as the headphone is stored in the device information stored in the non-volatile memory 85 of the input device 20 serving as the headphone, and the host device 10 serving as the sound signal reproducing device can acquire the corresponding coefficient set included in the device information can by reading the device information of the input device 20 stored in the non-volatile memory 85.

Thus, in this case, although the host device 10 serving as the sound signal reproducing device has no network connection function, it is possible to acquire the coefficient set (the corresponding coefficient set) corresponding to the input device 20 serving as the headphone and perform the appropriate NC process for the headphone.

The device information stored in stored in the non-volatile memory 85 of the input device 20 serving as the headphone may include identification information identifying the input device 20 serving as the headphone instead of the corresponding coefficient set.

Further, the device information may include both the corresponding coefficient set and the identification information.

Here, for example, a combination of the same vendor ID as one allocated to a manufacturing company of a universal serial bus (USB) device and a product ID indicating a type or model of a product, a universally unique identifier (UUID), or the like can be employed as the identification information.

Now, in the host device 10 serving as the sound signal reproducing device, the signal processing block 11 is assumed to include an internal coefficient database serving as a database in which the identification information is associated with the coefficient set for performing the appropriate NC process for the input device 20 such as the headphone identified by the identification information.

The device information stored in the non-volatile memory 85 of the input device 20 serving as the headphone is assumed to include at least the identification information of the corresponding coefficient set and the identification information.

In this case, when the input device 20 serving as the headphone is connected to the host device 10 serving as the sound signal reproducing device, the host device 10 reads the device information from the input device 20, and determines whether or not the identification information that is included in the device information and identical to the identification information of the input device 20 is stored in the coefficient database.

When the identification information identical to the identification information of the input device 20 is stored in the coefficient database of the host device 10, in the host device 10 serving as the sound signal reproducing device, the coefficient set associated with the identification information identical to the identification information of the input device 20 in the coefficient database is reflected on the digital filter performing the NC filter operation, and the NC process is performed.

In this case, the appropriate NC process can be performed for the input device 20 serving as the headphone connected to the host device 10 serving as the sound signal reproducing device.

A technique of reading headphone side storage information from a headphone and setting signal processing characteristics of a signal processing device based on the headphone side storage information in a signal processing device such as a sound signal reproducing device to which a headphone is connected is described in Japanese Patent Application Laid-Open No. 2009-232205 previously proposed by the present applicant.

When the identification information identical to the identification information of the input device 20 is not stored in the coefficient database of the host device 10, the host device 10 serving as the sound signal reproducing device checks whether or not the coefficient set (the corresponding coefficient set) is included in the device information read from the input device 20 serving as the headphone.

Then, when the coefficient set is included in the device information, the host device 10 checks whether or not the coefficient set included in the device information conform to a platform of the NC function implemented in the host device 10.

For example, the platform of the NC function refers to a type of DSP serving as hardware performing the NC filter operation, a program (a configuration of the digital filter performing the NC filter operation) of the NC filter operation performed by the DSP, or the like.

When the coefficient set included in the device information of the input device 20 is checked to conform to the platform of the NC function implemented in the host device 10, the host device 10 reflects the coefficient set included in the device information on the digital filter performing the NC filter operation, and performs the NC process.

Further, when the coefficient set is not included in the device information or when the coefficient set is included in the device information but the coefficient set does not conform to the platform of the NC function implemented in the host device 10, the host device 10 turns off the NC function.

As described above, as the corresponding coefficient set is included in the device information stored in the non-volatile memory 85 of the input device 20 serving as the headphone, the host device 10 serving as the sound signal reproducing device can read the device information of the input device 20 stored in the non-volatile memory 85 and perform the NC process using the corresponding coefficient set included in the device information. Thus, although the host device 10 has no network connection function, the host device 10 can acquire the corresponding coefficient set of the input device 20 serving as the headphone and perform the appropriate NC process for the input device 20 serving as the headphone using the corresponding coefficient set.

In the above-described case, in the host device 10, when the identification information identical to the identification information of the input device 20 is stored in the coefficient database, the coefficient set associated with the identification information identical to the identification information of the input device 20 in the coefficient database is used, and the coefficient set included in the device information is used only when the identification information identical to the identification information of the input device 20 is not stored in the coefficient database.

Thus, the coefficient set stored in the coefficient database is used with priority higher than the coefficient set included in the device information. It is because of the following reasons.

In other words, for the input device 20 serving as the headphone, for example, there may a case in which a corresponding coefficient set (hereinafter, also referred to as an “update coefficient set”) for performing the appropriate NC process for the input device 20 serving as the headphone is developed at the time of release rather than a corresponding coefficient set (hereinafter, also referred to as an “initial coefficient set”) included in the device information.

Then, when the update coefficient set is opened on the network, and the host device 10 serving as the sound signal reproducing device has the network connection function, the host device 10 can download the update coefficient set and update the coefficient database.

In this case, the host device 10 serving as the sound signal reproducing device can perform the appropriate NC process using the update coefficient set rather than the initial coefficient set included in the device information by using the coefficient set stored in the coefficient database with priority higher than the coefficient set included in the device information.

Further, when the host device 10 serving as the sound signal reproducing device has no network connection function, but the initial coefficient set is stored in the coefficient database, the host device 10 performs the NC process using the initial coefficient set stored in the coefficient database. Furthermore, when the host device 10 serving as the sound signal reproducing device has no network connection function, and the initial coefficient set is not stored in the coefficient database, the host device 10 performs the NC process using the initial coefficient set included in the device information read from the input device 20.

The above description has been made in connection with the example in which the host device 10 serving as the sound signal reproducing device has the function of performing the NC process, but when the host device 10 has an equalizer that performs sound quality correction, a Virtual phones Technology (a registered trademark), or a process of performing the noise suppression, the beam forming, or sound signal processing of processing any other sound signal in addition to the NC process, the process information for performing the appropriate sound signal processing for the input device 20 serving as the headphone may be included in the device information.

Further, the host device 10 serving as the sound signal reproducing device can perform the appropriate sound signal processing for the input device 20 serving as the headphone by reading the device information from the input device 20 serving as the headphone and performing a setting of characteristics of the sound signal processing or the like based on the process information included in the device information.

In the above-described case, the filter coefficient (coefficient set) of the digital filter performing the NC filter operation is included in the device information, but the device information may include an NC filter operation parameter or characteristic information indicating characteristics of a sound-related transducer of the input device 20 serving as the headphone, that is, the microphone 81ᵢ and the drivers 61L and 61R instead of the filter coefficient.

Examples of the NC filter operation parameter include a type, a center frequency, and a gain of the digital filter performing the NC filter operation. Examples of the characteristic information of the transducer (the microphone 81ᵢ and the drivers 61L and 61R) include sensitivity and frequency characteristics (amplitude characteristics and phase shift characteristics) of the microphone 81ᵢ and the drivers 61L and 61R.

When the NC filter operation parameter or the characteristic information of the transducer is included in the device information, the host device 10 serving as the sound signal reproducing device obtains the filter coefficient of the digital filter performing the NC filter operation for executing the appropriate NC process based on the NC filter operation parameter or the characteristic information of the transducer.

For example, a setting value (a register setting value) of a register of a DSP serving as hardware for implementing the digital filter performing the NC filter operation is included in the device information, and the host device 10 serving as the sound signal reproducing device can set the register of the DSP as hardware for implementing the digital filter performing the NC filter operation according to the register setting value included in the device information and perform the NC process.

A method of including the parameter or the like in the device information as described above can be applied, for example, even when the sound signal processing of the equalizer or the like other than the NC process is performed.

By the way, for example, in order to perform the appropriate NC process for the input device 20 serving as the headphone as described above, it is necessary to include the characteristic information of the transducer or the filter coefficient for the NC process obtained from the characteristic information in the device information of the input device 20 and reduce the size, the power consumption, and the cost of the input device 20 when the device information is stored in the input device 20.

For the characteristic information of the transducer, there are cases in which the characteristic information of the transducer is measured again due to a measurement mistake made by an operator who measures the characteristic information, a replacement of the transducer (the microphone 81ᵢ and the drivers 61L and 61R) associated with a repair of the input device 20 serving as the headphone, or the like.

In this case, it is necessary to update the device information to the device information including the re-measured characteristic information or the filter coefficient obtained from the re-measured characteristic information.

In addition, for example, even when the design of the digital filter performing the NC filter operation is changed, it is necessary to update the device information to the device information including the filter coefficient of the digital filter having the changed design.

Thus, it is requested to easily update the device information as well as to reduce the size, the power consumption, and the cost of the input device 20 when the device information is stored in the input device 20.

As a method of reducing the size, the power consumption, and the cost of the input device 20 when the device information is stored in the input device 20, there is a method of employing, for example, OTP (memory) or EPROM that is small in size and power consumption and low in cost as the non-volatile memory 85 storing the device information.

Here, writing in the OTP can be performed only once (it is difficult to rewrite data of a storage region in which data is written).

In the EPROM, it is possible to rewrite data by irradiating with the ultraviolet rays and erasing data written in a storage region, but it is not realistic to irradiate the EPROM with the ultraviolet rays in a state in which the EPROM is mounted in the input device 20, and thus in practice, the EPROM can be regarded as a memory in which writing can be performed only once, similarly to the OTP.

For the device information stored in the non-volatile memory 85 employing the OTP or the EPROM in which writing can be performed only once, an update mechanism of the device information is introduced in order to easily update the device information.

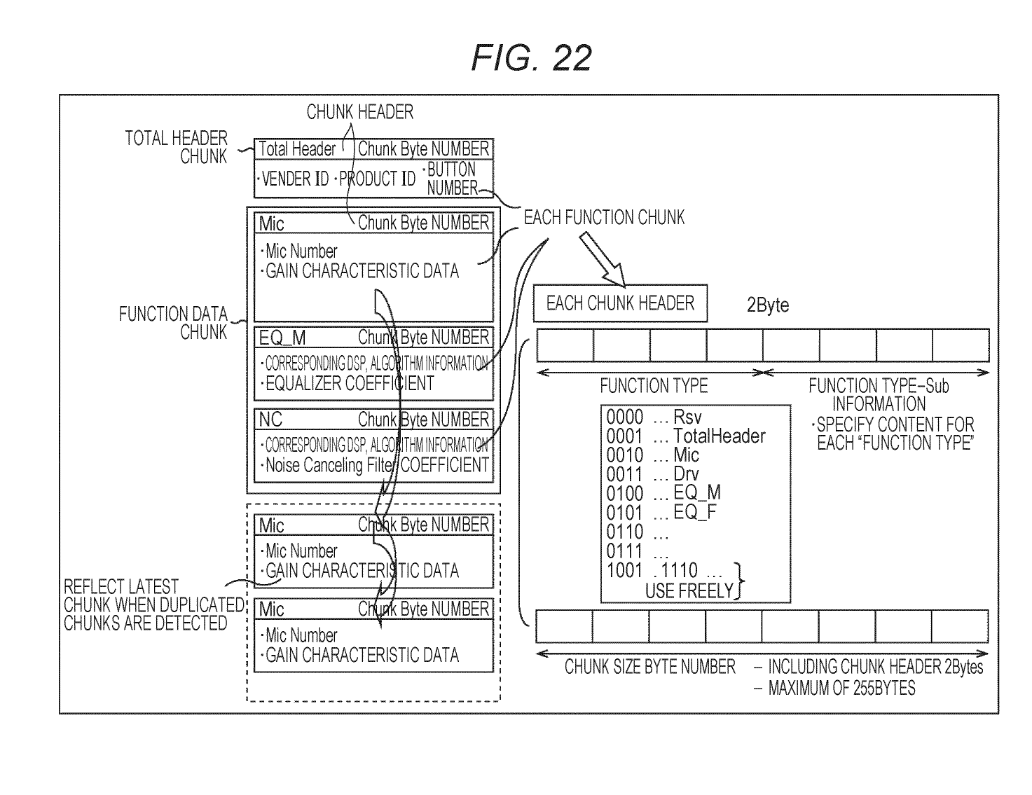

FIG. 22 is a diagram illustrating exemplary the device information stored in the non-volatile memory 85.

The device information is stored (written) in the non-volatile memory 85 with a chunk structure.

A chunk is (a structure of) a bundle of data related to one category such as a certain function, and in the present embodiment, there are a total header chunk and a function data chunk as a type of chunk.

Basic information of the input device 20 is registered in the total header chunk, and information related to a predetermined function is registered in the function data chunk.

For example, a region of a predetermined size such as a 2-byte region is set to the head of a chunk as a chunk header in which a function type and a chunk size are registered.

The function type indicates a function (category) related to data which is registered in a chunk in which the function type is registered.

For example, the chunk size indicates a size (the number of bytes) of a chunk including the chunk header.

When data of a chunk of a certain function type stored in the non-volatile memory 85 of the input device 20 is updated, the host device 10 additionally writes a chunk in which the updated data is registered in an empty region of the non-volatile memory 85.

When the chunk in which the updated data is registered is additionally written in the empty region of the non-volatile memory 85 as described above, there are cases in which a plurality of chunks having the same function type in the non-volatile memory 85.

When there are a plurality of chunks having the same function type in the device information read from the non-volatile memory 85 of the input device 20, the host device 10 regards the latest chunk (a chunk written last) among the plurality of chunks having the same function type as an effective chunk, and performs the signal processing such as the NC or the equalizer process using data registered in the effective chunk.

Further, when there are a plurality of chunks having the same function type in the device information of the non-volatile memory 85, the latest chunk among the plurality of chunks having the same function type is regarded as an effective chunk as described above, and the other chunks are ignored, but any one of the plurality of chunks having the same function type may be regarded as an effective chunk, and the user may select whether or not data of the effective chunk is used for signal processing.

In other words, for example, when there are a plurality of chunks having a function type indicating an equalizer, the user may select whether or not data of any one of the plurality of chunks is used for the equalizer process.

It may be recognized whether or not any one of a plurality of chunks having the same function type is the latest chunk based on the write date and time, for example, by registering the write date and time when the chunk is written.

Alternatively, for example, the chunks may be written in a predetermined order such as the ascending order of addresses of the non-volatile memory 85, and it may be recognized whether or not any one of a plurality of chunks having the same function type is the latest chunk based on an address at which the chunk is written.

FIG. 22 illustrates exemplary device information stored in the non-volatile memory 85 with the chunk structure as described above.

In FIG. 22, for example, the chunks are written in the ascending order of the addresses of the non-volatile memory 85.

As described above, the 2-byte chunk header is arranged in the head of the chunk, and the function type and the chunk size are registered in the chunk header.

In FIG. 22, the 2-byte chunk header includes a 4-bit function type, 4-bit function type sub information, and a 1-byte chunk size from the head.

The function type indicates a function related to data which is registered in a chunk as described above.

In FIG. 22, 4 bits “0000” serving as the function type are reserved (Rsv), 4 bits “0001” serving as the function type indicate that the chunk is the total header chunk (Total Header).

Further, 4 bits “0010” serving as the function type indicate that data (Mic) related to the microphone 81ᵢ such as the characteristic information of the microphone 81ᵢ installed in the input device 20 is registered in the chunk, and 4 bits “0011” serving as the function type indicate that data (Dry) related to the drivers 61L and 61R such as the characteristic information of the drivers 61L and 61R installed in the input device 20 is registered in the chunk.

In addition, 4 bits “0100” serving as the function type indicate that data (EQ_M) related to a music equalizer is registered in the chunk, and 4 bits “0101” serving as the function type indicate that data (EQ_F) related to the equalizer giving flat frequency characteristics is registered in the chunk.

In addition, for example, 4 bits indicating that data related to various kinds of signal processing such as the NC is registered in the chunk may be defined as the function type.

The function type sub information is arbitrary information serving as auxiliary information of the function type.

The chunk size indicates a size or the number of bytes of a chunk including a chunk header as described above.

The chunk size is 1-byte data, a maximum of the number of bytes that can be indicated by the 1-byte chunk size is 255 bytes, and thus a maximum size of one chunk is 255 bytes.

Here, a chunk in which the function type is 4 bits “0010,” and data (Mic) related to the microphone 81ᵢ such as the characteristic information of the microphone 81ᵢ installed in the input device 20 is registered is hereinafter also referred to as a “Mic chunk.”

A chunk in which the function type is 4 bits “0100,” and data (EQ_M) related to the music equalizer is registered is also referred to as an “EQ_M chunk.”

In addition, a chunk in which data related to the NC is registered is also referred to as an “NC chunk.”

For example, the basic information of the input device 20 such as a function (information indicating a headphone, information indicating a headset, or the like) provided by the input device 20, a vendor ID, a product ID, the number of operating units (the number of switches 80 or the like) that are installed in the input device 20 and can be operated by the user, and the like is registered in the total header chunk.

For example, the number (Mic Number) of the microphones 81ᵢ installed in the input device 20, the characteristic information (characteristics data) of the microphone 81ᵢ, and the like are registered in the Mic chunk.

For example, when the equalizer process is performed in the host device 10 to which the input device 20 is connected, information related to a DSP (a corresponding DSP) capable of performing the equalizer process, algorithm information related to an algorithm of the equalizer process, an equalizer coefficient used for the equalizer process, and the like are registered in the EQ_M chunk.

For example, when the NC process is performed in the host device 10 to which the input device 20 is connected, information related to a DSP (a corresponding DSP) capable of performing the NC process, algorithm information related to an algorithm of the NC process, a filter coefficient (noise canceling filter coefficient) used for the NC process, and the like are registered in the NC chunk.

In the chunk structure, when data of a chunk having a certain function type stored in the non-volatile memory 85 storing the device information is updated, the chunk in which the updated data is registered is additionally written, for example, in an empty region having a small address among the empty regions of the non-volatile memory 85.

Thereafter, when the input device 20 is connected to the host device 10, the host device 10 reads the chunk serving as the device information of the input device 20 stored in the non-volatile memory 85.

Further, when there are a plurality of chunks having the same function type in the device information read from the non-volatile memory 85 of the input device 20, the host device 10 performs the signal processing using the latest chunk (a chunk having the largest address) among a plurality of chunks having the same function type as the effective chunk.

Thus, it is possible to easily update the device information stored in the non-volatile memory 85 in which writing can be performed only once.

The total header chunk and the function data chunk can employ different structures rather than the same structure. However, when the total header chunk and the function data chunk employ the same structure, it is possible to simplify control of reading and writing of a chunk in the host device 10 that reads or writes a chunk from or in the non-volatile memory 85 of the input device 20.

Further, when the chunks are written in the ascending order of the addresses of the non-volatile memory 85, the total header chunk can be written at the head side of the address of the non-volatile memory 85 as illustrated in FIG. 22. However, the total header chunk may be written at an arbitrary position rather than the head side of the address of the non-volatile memory 85.

In FIG. 22, the largest size of the chunk is 255 bytes as described above, but information (flag) indicating that there is a consecutive chunk may be registered in the chunk, and the largest size of the chunk may be set to a size substantially larger than 255 bytes.

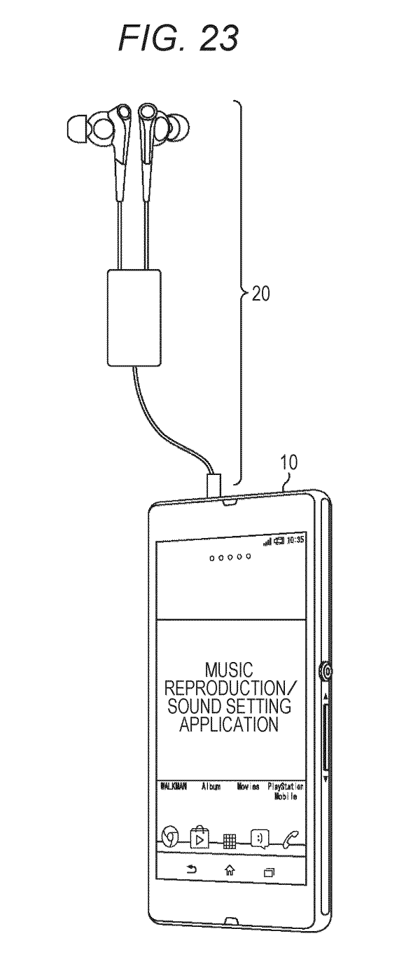

FIG. 23 is a perspective view illustrating an exemplary external appearance configuration of a first system to which the application system of FIGS. 20 and 21 is applied.

In FIG. 23, parts corresponding to those in FIG. 20 are denoted by the same reference numerals, and hereinafter, a description thereof will be appropriately omitted.

In FIG. 23, the host device 10 is applied to a smartphone including a music reproduction application, and the input device 20 is applied to a headset.

FIG. 24 is a block diagram illustrating an exemplary electrical configuration of the first system of FIG. 23.

In FIG. 24, parts corresponding to those in FIG. 21 are denoted by the same reference numerals, and hereinafter, a description thereof will be appropriately omitted.

Referring to FIG. 24, the signal processing block 11 is configured to function as a sequence control unit 211, a filter/coefficient control unit 212, an FB filter operation unit 213, an FF filter operation unit 214, a signal processing unit 215, an equalizer (EQ) 216, and an addition circuit 217.

The device information (the device information included in the multiplexed data transmitted from the input device 20 to the host device 10) read from the non-volatile memory 85 of the input device 20 through the multiplexed data interface 13 is supplied to the sequence control unit 211 and the filter/coefficient control unit 212.

The sound signal that is included in the multiplexed data transmitted from the input device 20 to the host device 10 and corresponds to the sound collected by the microphone 81ᵢ of the input device 20 is supplied from the multiplexed data interface 13 to the FB filter verification unit 213 and the FF filter operation unit 214.

The sound signal of the song stored in the storage 203 is supplied to the signal processing unit 215.

The sequence control unit 211 controls the signal processing block 11 and the other blocks based on the device information supplied from the multiplexed data interface 13.

The filter/coefficient control unit 212 sets the filter coefficient of the FB filter operation performed by the FB filter operation unit 213 to the FB filter operation unit 213 based on the device information supplied from the multiplexed data interface 13. Further, the filter/coefficient control unit 212 sets the filter coefficient of the FF filter operation performed by the FF filter operation unit 214 to the FF filter operation unit 214 based on the device information supplied from the multiplexed data interface 13.

The FB filter operation unit 213 performs the FB filter operation on the sound signal supplied from the multiplexed data interface 13 using the filter coefficient set by the filter/coefficient control unit 212, generates the sound signal for the NC of the FB scheme which is the same as one obtained by the FB filter operation unit 1232 of FIG. 18, and supplies the generated sound signal for the NC of the FB scheme to the addition circuit 217.

The FF filter operation unit 214 performs on the sound signal supplied from the multiplexed data interface 13 using the filter coefficient set by the filter/coefficient control unit 212, generates the sound signal for the NC of the FF scheme which is the same as one obtained by the FF filter operation unit 1332 of FIG. 18, and supplies the generated sound signal for the NC of the FF scheme to the addition circuit 217.

The signal processing unit 215 performs predetermined signal processing on the sound signal of the song supplied from the storage 203, and supplies the resulting sound signal to the equalizer 216.

The equalizer 216 performs sound quality correction on the sound signal of the song supplied from the signal processing unit 215, and supplies the corrected sound signal of the song to the addition circuit 217.

The addition circuit 217 adds the sound signal for the NC of the FB scheme supplied from the FB filter operation unit 213, the sound signal for the NC of the FF scheme supplied from the FF filter operation unit 214, and the sound signal of the song supplied from the equalizer 216, obtains a noise-reduced sound signal serving as a sound (sound wave) in which a noise has been reduced as a noise works on (is added) in the real space, and supplies the noise-reduced sound signal to the DAC/amplifier unit 201. For example, the noise-reduced sound signal supplied to the DAC/amplifier unit 201 is supplied to the drivers 61L and 61R via the jack 14 and the plug 23, and thus corresponding sounds are output from the drivers 61L and 61R.

In the first system having the above configuration, the host device 10 serving as the smartphone and the input device 20 serving as the headset function as the NC system that performs the NC process as the plug 23 of the input device 20 is inserted into the jack 14 of the host device.

Here, in the input device 20 serving as the headset, the characteristic information such as sensitivity or frequency characteristics (amplitude characteristics and phase shift characteristics) of the microphone 81ᵢ or the drivers 61L and 61R is included in the device information and stored in the non-volatile memory 85 in amass production process in advance.

The device information of the input device 20 stored in the non-volatile memory 85 can be read in the host device 10 connected to the input device 20 as described above.

The input device 20 includes the five microphones 81₀ to 81₄ as described above, and one microphone 81₀ can be used as the voice microphone (Speech-Mic).

In FIG. 24, the remaining four microphones 81₁ to 81₄ among the five microphones 81₀ to 81₄ are used for the NC as an NC microphone.

In other words, the microphone 81₁ is installed outside the headphone housing 1012 in the NC system of the FF scheme of FIG. 16, corresponds to the microphone 1031 that collects an external noise, and is used in the NC process of the FF scheme as a microphone (FF-NC-Mic(R)) for collecting a noise of an R channel.

The microphone 81₂ is a microphone configuring a pair with the microphone 81₁ and used in the NC process of the FF scheme as a microphone (FF-NC-Mic(L)) for collecting a noise of an L channel.

The microphone 81₃ is installed in the headphone housing 1012 in the NC system of the FB scheme of FIG. 14, corresponds to the microphone 1021 that collects an external noise, and is used in the NC process of the FB scheme as a microphone (FB-NC-Mic(R)) for collecting a noise of an R channel.

The microphone 81₄ is a microphone configuring a pair with the microphone 81₃ and used in the NC process of the FB scheme as a microphone (FB-NC-Mic(L)) for collecting a noise of an L channel.

In the host device 10, the multiplexed data interface 13 reads the device information from the non-volatile memory 85 of the input device 20, and supplies the device information to the sequence control unit 211 and the filter/coefficient control unit 212.

The filter/coefficient control unit 212 sets the filter coefficient of the FB filter operation performed by the FB filter operation unit 213 and the filter coefficient of the FF filter operation performed by the FF filter operation unit 214 based on the filter coefficient included in the device information or the like.

The sequence control unit 211 controls, a gain (sensitivity) of the amplifier 82ᵢ or a gain of the DAC/amplifier unit 201 based on the characteristic information of the transducer included in the device information or the like such that the appropriate NC process for the input device 20 is performed.

Thus, according to the first system, it is possible to construct an appropriate NC system while using a dynamic range effectively.

The filter/coefficient control unit 212 may include an internal coefficient database in which the identification information of the input device 20 is associated with the coefficient set for performing the appropriate NC process for the input device 20 such as the headset identified by the identification information.

In this case, the filter/coefficient control unit 212 may read the coefficient set associated with the same identification information as the identification information included in the device information from the coefficient database based on the identification information included in the device information and set the read coefficient set as the filter coefficient of the FB filter operation unit 213 and the FF filter operation unit 214.

Since the filter coefficient of the FB filter operation and the filter coefficient of the FF filter operation are set based on the filter coefficient included in the device information of the input device 20 serving as the headset or the like as described above, in the mass production process of the input device 20, it is necessary to measure the characteristic information and the like and write the characteristic information, the coefficient set (the filter coefficient) obtained from the characteristic information, and the like in the non-volatile memory 85, but it is unnecessary to adjust the transducer of the input device 20 and the like, and thus the huge cost required for the adjusting can be reduced.

In other words, when the NC process is performed using the same filter coefficient regardless of (an individual of) the headset, it is necessary to adjust the transducer of the headset so that the NC process according to the filter coefficient is effectively performed.

Meanwhile, when the filter coefficient (the filter coefficient of the FB filter operation and the filter coefficient of the FF filter operation) of the NC process is set based on the filter coefficient included in the device information of the input device 20 serving as the headset or the like, the adjusting of the transducer or the like becomes unnecessary by writing in the non-volatile memory 85, for example, the device information including the filter coefficient for performing the appropriate NC process for the input device 20 in the non-volatile memory 85 of the input device 20.

In addition, the user can receive the benefit of the effect of the appropriate NC process for the input device 20 serving as the headset without performing an operation for selecting the filter coefficient of the NC process through a user interface (UI) or the like.

Further, when the user performs the operation for selecting the filter coefficient of the NC process, if the filter coefficient that is not suitable for the input device 20 is selected due to an operation mistake and forgetfulness of the user or the like, it may be difficult to sufficiently receive the benefit of the effect of the NC process, or a vibrating or howling sound may be generated due to carelessness, but when the filter coefficient of the NC process is set based on the filter coefficient included in the device information of the input device 20 serving as the headset or the like, such situations can be prevented.

In the first system of FIG. 24, a setting of frequency characteristics of the equalizer 216 serving as appropriate music characteristics when music is listened using the input device 20 serving as the headset is included in the device information of the input device 20, the process of the equalizer 216 is performed according to the music characteristics, and thus the equalizer 216 can perform appropriate sound quality correction when music is listened using the input device 20 serving as the headset.

In addition, process information which relates to a sound-field system process (a feeling of expanse or out-of-head localization) such as a high sound quality process (band expansion orbit expansion), a dynamics process (a compressor or a limiter), a surround process, which are suitable for the input device 20 serving as the headset may be included in the device information.

For example, for the surround process, reverse characteristics of a headphone sound output unit of a headset largely works on a virtual sense of localization, and thus the reverse characteristics may be measured in the mass production process, and the reverse characteristics or information (for example, a filter coefficient of a finite impulse response (FIR) filter or an infinite impulse response (IIR) filter) necessary for the surround process obtained from the reverse characteristics may be included in the device information as the process information.

The filter/coefficient control unit 212 may include an internal database in which the identification information of the input device 20 is associated with, for example, process information for performing an appropriate process for the input device 20 such as the headset identified by the identification information and read, for example, the process information associated with the same identification information as the identification information included in the device information from the database. The database is installed in the filter/coefficient control unit 212 or the like but may be constructed on the network such as the Internet.

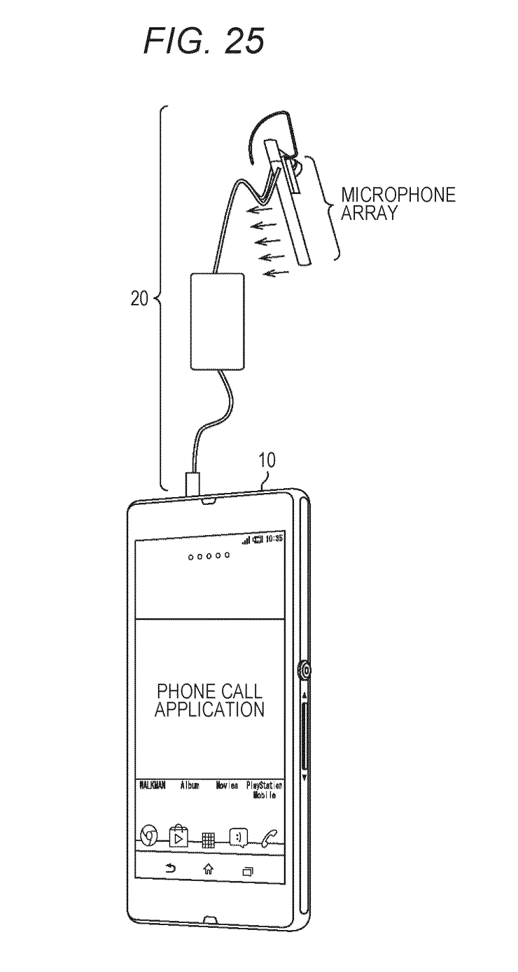

FIG. 25 is a perspective view illustrating an exemplary external appearance configuration of a second system to which the application system of FIGS. 20 and 21 is applied.

In FIG. 25, parts corresponding to those in FIG. 20 are denoted by the same reference numerals, and hereinafter, a description thereof will be appropriately omitted.

In FIG. 25, the host device 10 is applied to a smartphone including a phone call application, and the input device 20 is applied to a headset including a microphone array.

FIG. 26 is a block diagram illustrating an exemplary electrical configuration of the second system of FIG. 25.

In FIG. 26, parts corresponding to those in FIGS. 21 and 24 are denoted by the same reference numerals, and hereinafter, a description thereof will be appropriately omitted.

Referring to FIG. 26, the signal processing block 11 is configured to function as a sequence control unit 211, a filter/coefficient control unit 212, and a beam forming/noise suppression unit 231.

The sound signals #0 to #4 that are included in the multiplexed data transmitted from the input device 20 to the host device 10 and correspond to the sound collected by the microphones 81₀ to 81₄ of the input device 20 are supplied from the multiplexed data interface 13 to the beam forming/noise suppression unit 231.

The beam forming/noise suppression unit 231 performs the noise suppression or the beam forming described with reference to FIG. 19 using the sound signals #0 to #4 corresponding to the sound collected by the microphones 81₀ to 81₄ of the input device 20 serving as the headset, and emphasizes a voice signal of the user wearing the input device 20 serving as the headset.

Then, the voice signal obtained by the beam forming/noise suppression unit 231 is supplied to the call transmission processing unit 206 and transmitted via the antenna 208 as a voice of a phone call.

In the second system having the above configuration, when the input device 20 serving as the headset including the microphone array configured with a plurality of microphones, for example, the five microphones 81₀ to 81₄ is connected to the host device 10 serving as the smartphone, the host device 10 and the input device 20 function as a high signal to noise ratio (S/N) system that acquires a voice at a high S/N based on the device information under an environment in which the S/N is low.

Here, in the second system, the device information stored in the non-volatile memory 85 of the input device 20 serving as the headset include information indicating that the input device 20 is a beam forming support headset, a type of algorithm of a process such as beam forming suitable for the input device 20, and information of a parameter necessary for a process such as beam forming.

Further, the device information includes, for example, the characteristic information of the microphone 81ᵢ necessary for calibration of the microphone 81ᵢ or the like or information such as a filter coefficient that is obtained from the characteristic information and used for a process of a sound signal.

A database (hereinafter, also referred to as a “device information database”) in which the information included in the device information is associated with the identification information of the input device 20 may be configured, and the device information database may be installed in the signal processing block 11 or opened on a network. The host device 10 can acquire information such as a parameter for performing an appropriate process for the input device 20 from the device information database using the identification information included in the device information read from the input device 20 as a keyword.

For example, in the existing 4-pole headset, only a sound signal of a microphone corresponding to one channel can be transmitted to the host device 20, but in the second system configured with the host device 10 and the input device 20, the input device 20 can transmit the sound signals of the microphones of a plurality of channels such as five channels to the host device 10 in which sufficient calculation resources can be expected, and the signal processing block 11 of the host device 10 can performs the beam forming or the noise suppression suitable for the input device 20 on the sound signals transmitted from the input device 20 based on the device information.

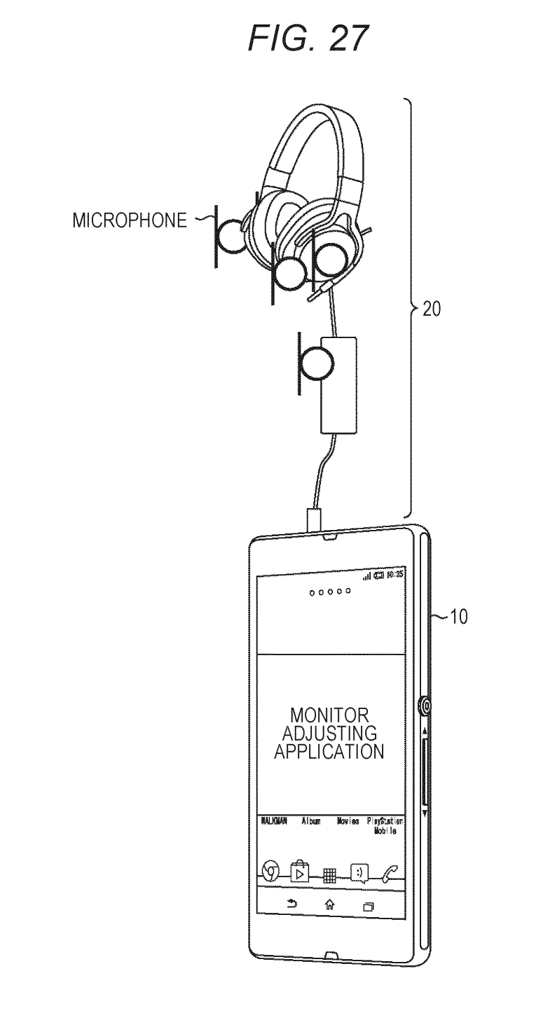

FIG. 27 is a perspective view illustrating an exemplary external appearance configuration of a third system to which the application system of FIGS. 20 and 21 is applied.

In FIG. 27, parts corresponding to those in FIG. 20 are denoted by the same reference numerals, and hereinafter, a description thereof will be appropriately omitted.

The third system of FIG. 27 has the same electrical configuration as, for example, the exemplary electrical configuration illustrated in FIG. 21.

In FIG. 27, the host device 10 is applied to a smartphone including an application of monitoring an ambient sound in real time, and the input device 20 is applied to an over ear headphone including a plurality of microphones, for example, four microphones 81₄ to 81₄ as the monitoring microphone.

In the third system, information indicating that the input device 20 is the over ear headphone including a function of monitoring an ambient sound in real time, information necessary for each calibration of the microphone 81ᵢ or the like, and the like are included in the device information stored in the non-volatile memory 85 (FIG. 21).

In the host device 10 serving as the smartphone, when the input device 20 serving as the over ear headphone is connected, the signal processing block 11 constructs a functional block that performs a process suitable for the input device 20 based on the device information of the input device 20 or a necessary operation of the user.

When the four microphones 81₁ to 81₄ of the input device 20 are used as a microphone that monitors an ambient sound in real time, the signal processing block 11 of the host device 10 can perform the process suitable for the input device 20 such as the beam forming or the noise suppression on the sound signals of the four microphones 81₁ to 81₄ supplied from the input device 20 based on the device information, similarly to the second system of FIGS. 25 and 26.

According to the process of the signal processing block 11 such as the beam forming or the noise suppression, for example, it is possible to generate a sound signal in which directivity is emphasized or a sound signal in which omnidirectional voice signals are emphasized.

In the third system, in order for the user to monitor the ambient sound in real time, the sound signal processed by the signal processing block 11 of the host device 10 (FIG. 21) is transmitted to the input device 20 via the DAC/amplifier unit 201, and corresponding sounds is output from the drivers 61L and 61R.

In this regard, in the third system, in order to prevent an echo or howling from occurring in the sounds output from the drivers 61L and 61R, the signal processing block 11 of the host device 10 may perform a process such as an echo canceller or howling suppression in addition to the beam forming or the noise suppression.

In the third system, the signal processing block 11 may perform the NC process of the FF+FB scheme as well.

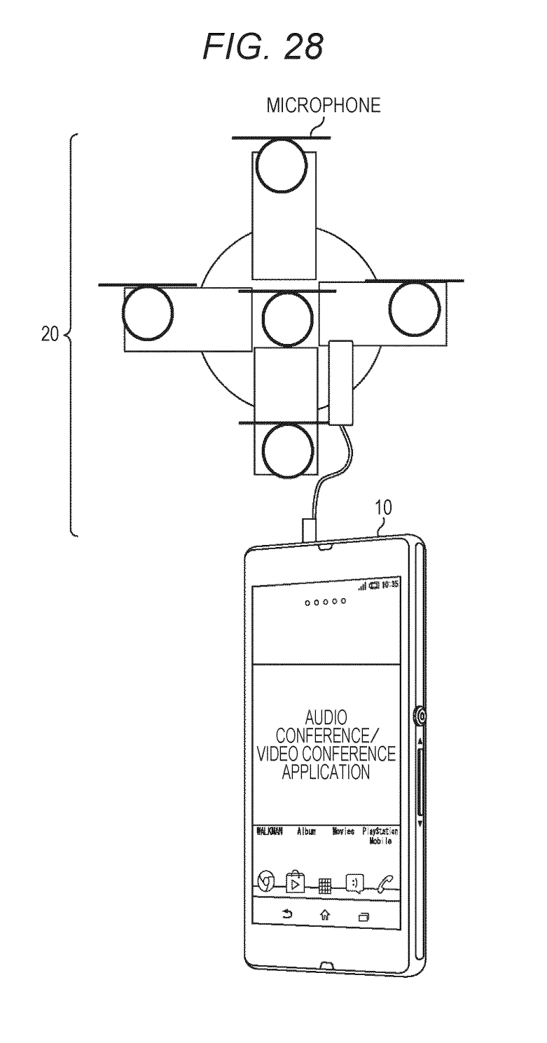

FIG. 28 is a perspective view illustrating an exemplary external appearance configuration of a fourth system to which the application system of FIGS. 20 and 21 is applied.

In FIG. 28, parts corresponding to those in FIG. 20 are denoted by the same reference numerals, and hereinafter, a description thereof will be appropriately omitted.

The fourth system of FIG. 28 has the same electrical configuration as, for example, the exemplary electrical configuration illustrated in FIG. 21.

In FIG. 28, the host device 10 is applied to a smartphone including an application of performing an audio (telephone) conference, and the input device 20 is applied to a stationary (conference) microphone system including a plurality of microphones, for example, five microphones 81₀ to 81₄.

According to the fourth system, when the host device 10 serving as the smartphone includes a camera, a video conference using an image as well as a voice can be performed.

In the fourth system, when the input device 20 serving as the stationary microphone system is connected to the host device 10, the host device 10 activates the application that performs the audio conference based on the device information.

The signal processing block 11 of the host device 10 performs, for example, high-accuracy sound signal processing suitable for the input device 20 such as the beam forming, the noise suppression, the echo canceller, or the howling suppression on the sound signal supplied from the input device 20 based on the device information, and thus directivity tracking in a dominant direction of a voice, echo cancellation, or the like can be executed.

Then, in the signal processing block 11, the sound signal obtained by processing the sound signal supplied from the input device 20 is transmitted from the communication mechanism 205 (FIG. 21) to the counterpart of the audio conference through the antenna 208.

Further, in the fourth system, the sound signal transmitted from the counterpart of the audio conference is received by the communication mechanism 205 through the antenna 208, and the signal processing block 11 performs the process suitable for the input device 20 such as the NC based on the device information on the received sound signal, and supplies the resulting sound signal to the input device 20. In the input device 20, the sounds corresponding to the sound signal supplied from the signal processing block 11 are output from the drivers 61L and 61R.

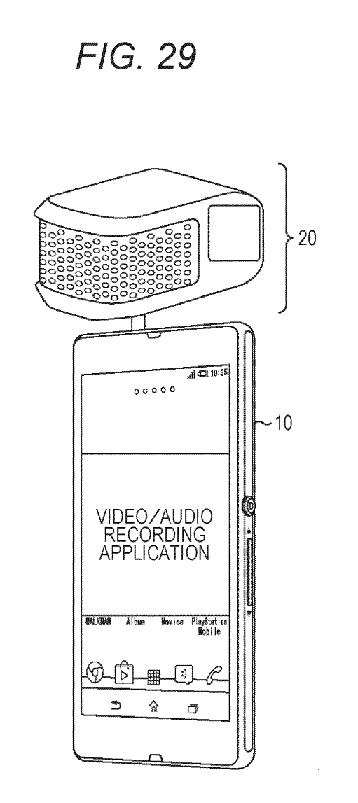

FIG. 29 is a perspective view illustrating an exemplary external appearance configuration of a fifth system to which the application system of FIGS. 20 and 21 is applied.

In FIG. 29, parts corresponding to those in FIG. 20 are denoted by the same reference numerals, and hereinafter, a description thereof will be appropriately omitted.

The fifth system of FIG. 29 has the same electrical configuration as, for example, the exemplary electrical configuration illustrated in FIG. 21.

In FIG. 29, the host device 10 is applied to a smartphone including a recording application that records a sound signal in an existing multi-channel audio format of 5.1 ch or the like, and the input device 20 is applied to an accessory microphone system that includes a plurality of microphones, for example, four microphones 81₁ to 81₄ or five microphones 81₀ to 81₄ therein and serves as one of accessories of a video camera.

In the fifth system, when the input device 20 serving as the accessory microphone system is connected to the host device 10, the host device 10 executes the recording application based on the device information, and functions as a system that records the sound signal in the multi-channel audio format.

Further, in the fifth system, the signal processing block 11 of the host device 10 performs a necessary process suitable for the input device 20 such as the beam forming or wind noise reduction on the sound signal supplied from the input device 20 based on the device information, and records the resulting sound signal in the storage 203 (FIG. 21), for example, in the multi-channel audio format.

Further, when the host device 10 serving as the smartphone includes a camera, the host device 10 records an image captured by the camera in the storage 203 as well, and thus the fifth system functions as a digital video camera capable of multi-channel voice recording.

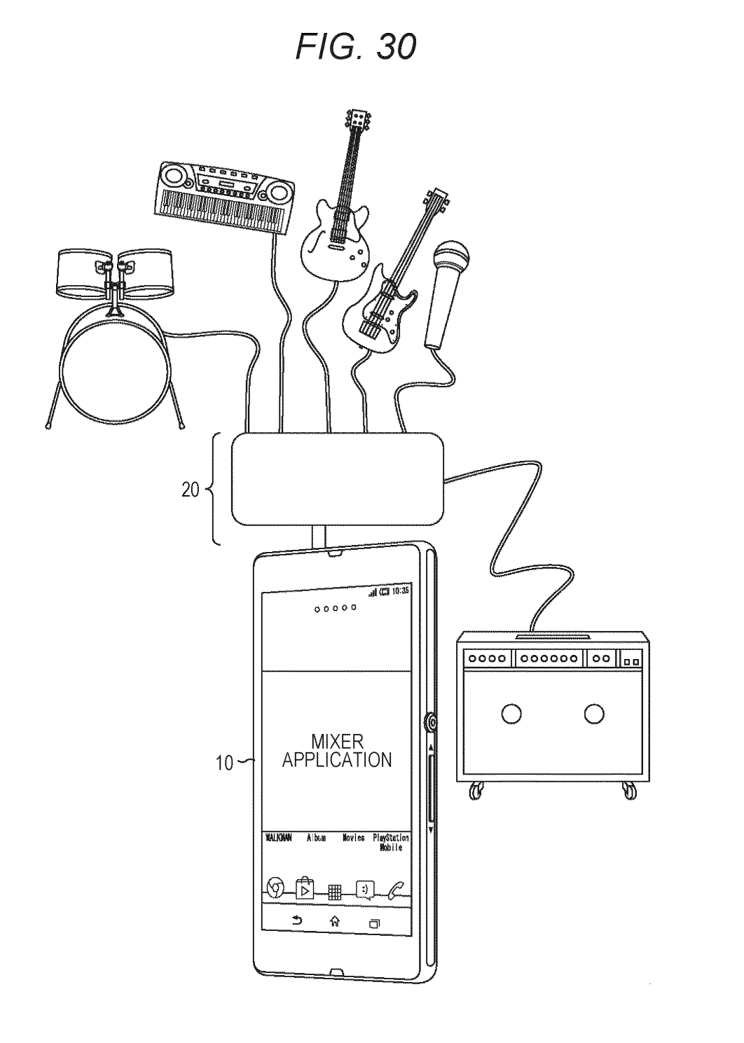

FIG. 30 is a perspective view illustrating an exemplary external appearance configuration of a sixth system to which the application system of FIGS. 20 and 21 is applied.

In FIG. 30, parts corresponding to those in FIG. 20 are denoted by the same reference numerals, and hereinafter, a description thereof will be appropriately omitted.

The sixth system of FIG. 30 has the same electrical configuration as, for example, the exemplary electrical configuration illustrated in FIG. 21.

In FIG. 30, the host device 10 is applied to a smartphone including a mixer application of performing mixing of sound signals, and the input device 20 is applied to an input device that receives an input of a sound signal having a line level.

In FIG. 30, since the input device 20 is an input device that receives an input of a sound signal having a line level as described above, a plurality of line input terminals (jacks) for inputting the sound signal having the line level or a musical instrument input terminal corresponding to an electric guitar or the like are installed instead of the microphone 81ᵢ of FIG. 21 or together with the microphone 81ᵢ.

The sound signals of the musical instruments output from a plurality of musical instruments via the plugs can be input to the input device 20 serving as the input device such that plugs of a plurality of musical instruments (including a microphone) are inserted into the line input terminals or the musical instrument input terminals. The input device 20 serving as the input device can transmit the input sound signals of the musical instruments to the host device 20, similarly to the sound signal obtained by the microphone 81ᵢ.

In the sixth system, when the input device 20 serving as the input device is connected to the host device 10, the host device 10 activates the mixer application based on the device information.

The signal processing block 11 of the host device 10 performs signal processing such as a process of adjusting mixing balance of the sound signals of the musical instruments supplied from the input device 20 or a process of applying an effect to the sound signals of the individual musical instruments.

In the sixth system, the sound signals (including the sound signals that have undergone the signal processing performed by the signal processing block 11) of the musical instruments supplied from the input device 20 may be recorded in the storage 203 (FIG. 21).

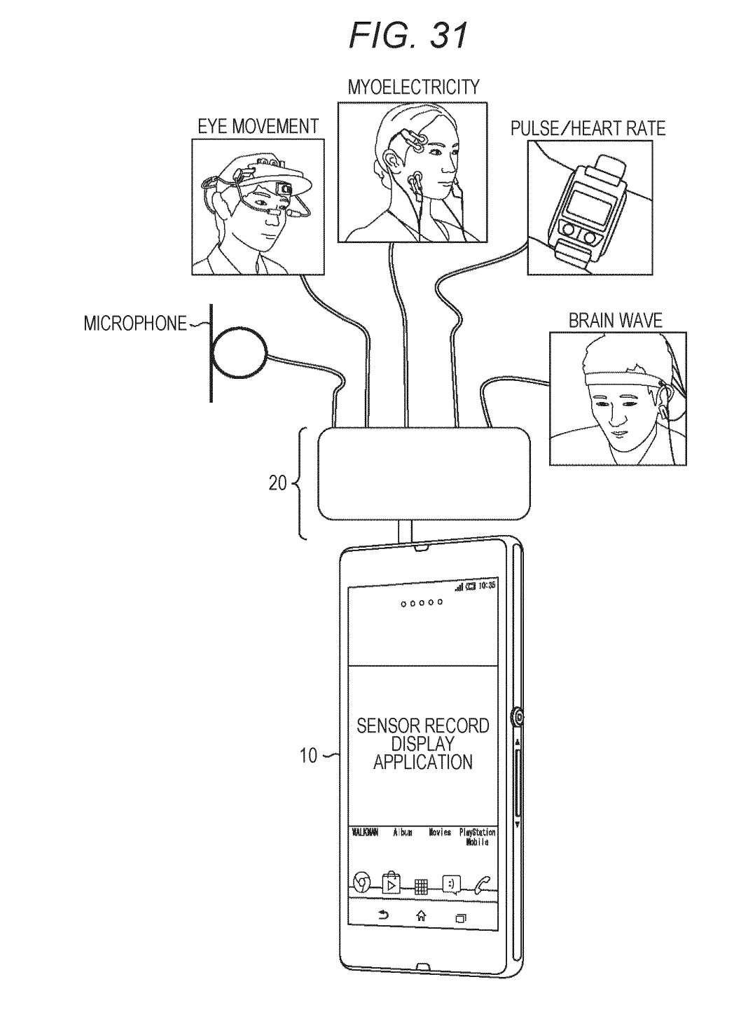

FIG. 31 is a perspective view illustrating an exemplary external appearance configuration of a seventh system to which the application system of FIGS. 20 and 21 is applied.

In FIG. 31, parts corresponding to those in FIG. 20 are denoted by the same reference numerals, and hereinafter, a description thereof will be appropriately omitted.

The seventh system of FIG. 31 has the same electrical configuration as, for example, the exemplary electrical configuration illustrated in FIG. 21.

In FIG. 31, the host device 10 is applied to a smartphone including a recording application that records a sensor signal output from a sensor, and the input device 20 is applied to a sensor input device that receives an input of a sensor signal of a biological sensor that senses biological information.

In FIG. 31, since the input device 20 is the sensor input device as described above, a plurality of input terminals (jack) each of which inputs the sensor signal are installed instead of the microphone 81ᵢ of FIG. 21 or together with the microphone 81ᵢ.

The sensor signal output from a plurality of biological sensors through the plugs can be input to the input device 20 serving as the sensor input device such that plugs of a plurality of biological sensors (for example, a sensor of sensing eye movement, a sensor of sensing a brain wave, and the like) are inserted into the input terminals. Then, the input device 20 serving as the sensor input device can transmit the input sensor signals to the host device 20, similarly to the sound signal obtained by the microphone 81ᵢ.

In the seventh system, when the input device 20 serving as the sensor input device is connected to the host device 10, the host device 10 activates the recording application based on the device information.

Then, the signal processing block 11 of the host device 10 performs a necessary process on the sensor signals of the biological sensors supplied from the input device 20, and records the resulting sensor signals in the storage 203.

As described above, according to the seventh system, the sensor signals of a plurality of biological sensors can be input to and recorded in the host device 10 through the 4-pole plug 23 of the input device 20 and the 4-pole jack 14 of the host device 10.

In the seventh system, for example, the host device 10 can receive a feedback result obtained by transmitting the sensor signals of the biological sensors supplied from the input device 20 to (a computer configuring) a cloud or processing the sensor signals in the cloud as necessary, display the feedback result, or record the feedback result in the storage 203.

<Eighth Exemplary Detailed Configuration of Host Device 10 and Input Device 20>

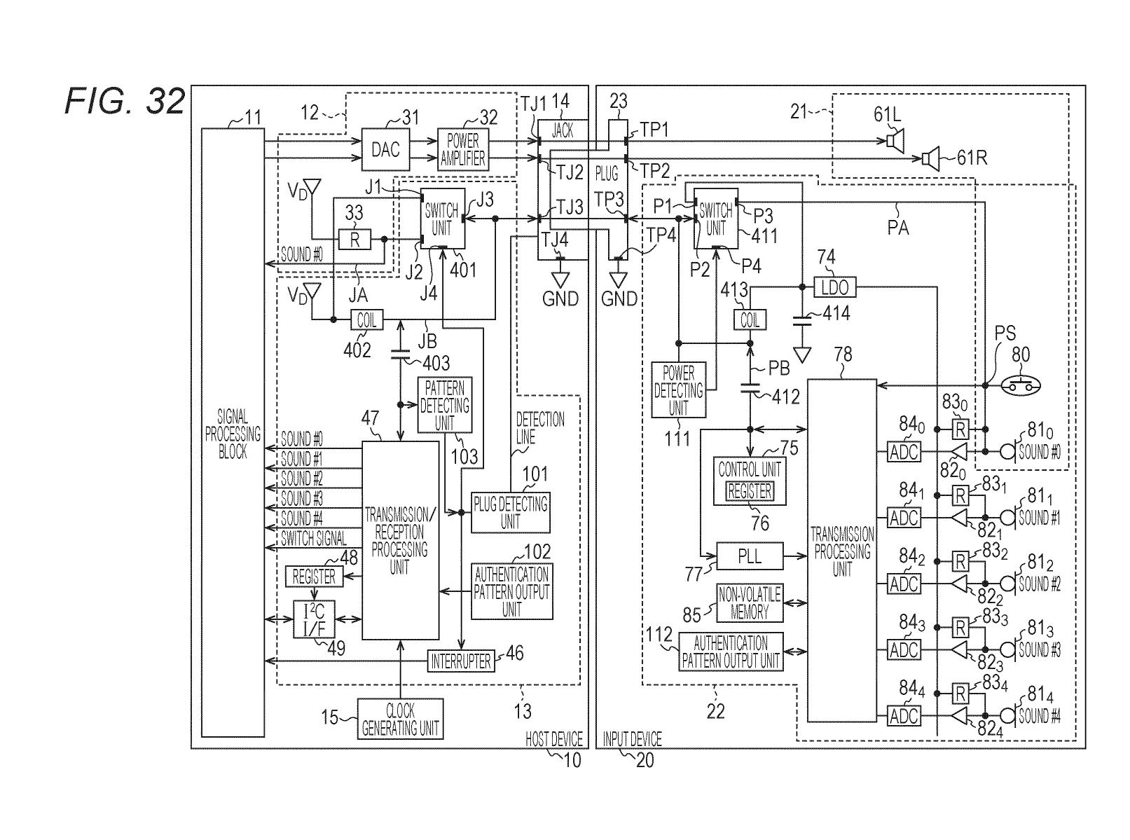

FIG. 32 is a block diagram illustrating an eighth exemplary detailed configuration of the host device 10, and the input device 20.

In the first to seventh exemplary detailed configurations (excluding the host device 10 having no backward compatibility), in order to facilitate understanding of the description, the host device 10 is configured using the switch 41 that is switchable to select one of the two terminals 41A and 41B, but in a practical implementation of the host device 10, for example, an analog switch is used as the switch 41.

Similarly, in the first to seventh exemplary detailed configurations (excluding the input device 20 having no backward compatibility), in order to facilitate understanding of the description, the input device 20 is configured using the switch 71 that is switchable to select one of the two terminals 71A and 71B, but in a practical implementation of the input device 20, for example, an analog switch is used as the switch 71.

In this regard, an exemplary configuration of the host device 10 and the input device 20 when the switches 41 and 71 are implemented using an analog switch will be described.

FIG. 32 illustrates an exemplary configuration of the host device 10, and the input device 20 when the switches 41 and 71 of the sixth exemplary detailed configuration are implemented using an analog switch in connection with the sixth exemplary detailed configuration of FIG. 8.

In FIG. 32, parts corresponding to those in FIG. 8 are denoted by the same reference numerals, and hereinafter, a description thereof will be appropriately omitted.

Here, even in the exemplary detailed configurations other than the sixth exemplary detailed configuration, the switches 41 and 71 can be implemented using an analog switch.

The host device 10 of FIG. 32 is the same as that of FIG. 8 in that the signal processing block 11, the clock generating unit 15, the DAC 31, the power amplifier 32, the resistor 33, the interrupter 46, the transmission/reception processing unit 47, the register 48, the I²C interface 49, the plug detecting unit 101, the authentication pattern output unit 102, and the pattern detecting unit 103 are arranged.

However, the host device 10 of FIG. 32 differs from that of FIG. 8 in that a switch unit 401 is arranged instead of the switch 41, and a coil 402 and a capacitor 403 are newly arranged.

In the host device 10 of FIG. 32, the analog sound interface 12 has a similar configuration to that of FIG. 8.

In the host device 10 of FIG. 32, the multiplexed data interface 13 is configured with the interrupter 46, the transmission/reception processing unit 47, the register 48, the I²C interface 49, the plug detecting unit 101, the authentication pattern output unit 102, the pattern detecting unit 103, the switch unit 401, the coil 402, and the capacitor 403.

The input device 20 of FIG. 32 is the same as that of FIG. 8 in that the drivers 61L and 61R, the LDO 74, the control unit 75, the PLL 77, the transmission processing unit 78, the switch 80, the microphones 81₀ to 81₄, the amplifiers 82₀ to 82₄, the resistors 83₀ to 83₄, the ADCs 84₀ to 84₄, the non-volatile memory 85, the power detecting unit 111, and the authentication pattern output unit 112 are arranged.

However, the input device 20 of FIG. 32 differs from that of FIG. 8 in that a switch unit 411 is arranged instead of the switch 71, and a capacitor 412, a coil 413, and a capacitor 414 are newly arranged.

In the input device 20 of FIG. 32, the analog sound interface 21 has a similar configuration to that of FIG. 8.

In the input device 20 of FIG. 32, the multiplexed data interface 22 is configured with the LDO 74, the control unit 75, the PLL 77, the transmission processing unit 78, the switch 80, the microphones 81₀ to 81₄, the amplifiers 82₀ to 82₄, the resistors 83₀ to 83₄, the ADCs 84₀ to 84₄, the non-volatile memory 85, the power detecting unit 111, the authentication pattern output unit 111, the switch unit 411, the capacitor 412, the coil 413, and the capacitor 414.

In the host device 10 of FIG. 32, the switch unit 401 is configured using an analog switch, and includes terminals J1, J2, J3, and J4.

The terminal J1 is a power terminal to which electric power (a predetermined voltage) is applied, and connected to the power source V_{D} in FIG. 32.

The terminals J2 and J3 are terminals of an ON/OFF target, and a portion between the terminals J2 and J3 enters an On state (a conduction state) or an OFF state (a non-conduction state) in the switch unit 401.

In FIG. 32, the terminal J2 is connected to the sound signal line JA and the other end of the resistor 33 whose one end is connected to the power source V_{D}, and the terminal J3 is connected to the microphone terminal TJ3 of the jack 14 and the multiplexed data signal line JB.

The terminal J4 is a control terminal for controlling the ON state and the OFF state of the portion between the terminals J2 and J3, and in the switch unit 401, the portion between the terminals J2 and J3 is turned on or off according to a signal supplied to the terminal J4. In FIG. 32, the terminal J4 is connected to the plug detecting unit 101 and the pattern detecting unit 103, and thus, the portion between the terminals J2 and J3 of the switch unit 401 is turned on or off according to the signal supplied from the plug detecting unit 101 or the pattern detecting unit 103 to the terminal J4.

The coil 402 is connected in series between the multiplexed data signal line JB and the power source V_{D}, and cuts off an alternating current (AC) component of a signal flowing from the coil 402 to the power source V_{D} side. The terminal J1 is connected to a connection point between the power source V_{D} and the coil 402.

One end of the capacitor 403 is connected to a connection point between the coil 402 and the multiplexed data signal line JB, and the other end of the capacitor 403 is connected to the transmission/reception processing unit 47 and the pattern detecting unit 103. The capacitor 403 cuts off a DC component of a signal flowing from the capacitor 403 to the transmission/reception processing unit 47 side and the pattern detecting unit 103 side.

In the input device 20 of FIG. 32, the switch unit 411 is configured using an analog switch, and includes terminals P1, P2, P3, and P4.

The terminals P1 to P4 of the switch unit 411 correspond to the terminals J1 to J4 of the switch unit 401, respectively.

Thus, in the switch unit 411, a portion between the terminals P2 and P3 is turned on or off according to a signal supplied to the terminal P4. In FIG. 32, the terminal P4 is connected to the power detecting unit 111, and thus, the portion between the terminals P2 and P3 of the switch unit 411 is turned on or off according to a signal supplied from the power detecting unit 111 to the terminal P4.

The terminal P1 is connected to a connection point between the coil 413 and the LDO 74, and the terminal P2 is connected to the microphone terminal TP3 of the plug 23 and the multiplexed data signal line PB.

The terminal P3 is connected to the sound signal line PA, and the terminal P4 is connected to the power detecting unit 111 as described above.

The capacitor 412 is connected in series between the multiplexed data signal line PB and the transmission processing unit 78 (further, the control unit 75 or the PLL 77), and cuts off a DC component of a signal flowing to the transmission processing unit 78 side.

One end of the coil 413 is connected to a connection point between the microphone terminal TP3 of the plug 23 and the multiplexed data signal line PB, and the other end of the coil 413 is connected to the LDO 74.

One end of the capacitor 414 is grounded (connected to the ground), and the other end of the capacitor 414 is connected to a connection point between the coil 413 and the LDO 74.

Through the coil 413 and the capacitor 414, an AC component of a signal supplied from the microphone terminal TP3 of the plug 23 to the LDO 74 via the coil 413 and the capacitor 414 is cut off.

In the host device 10 having the above configuration, the ON state of the portion between the terminals J2 and J3 of the switch unit 401 corresponds to the selection of the terminal 41A by the switch 41 (FIG. 8), and the OFF state of the portion between the terminals J2 and J3 of the switch unit 401 corresponds to the selection of the terminal 41B by the switch 41 (FIG. 8).

In the input device 20, the ON state of the portion between the terminals P2 and P3 of the switch unit 411 corresponds to the selection of the terminal 71A by the switch 71 (FIG. 8), and the OFF state of the portion between the terminals P2 and P3 of the switch unit 411 corresponds to the selection of the terminal 71B by the switch 71 (FIG. 8).

In FIG. 32, when the plug 23 of the input device 20 is inserted into the jack 14 of the host device 10, the host device 10 detects that the plug of the plug detecting unit 101 has been inserted into the jack 14.

When it is detected that the plug has been inserted into the jack 14, the plug detecting unit 101 supplies the control signal to the terminal J4 of the switch unit 401, and thus the portion between the terminals J2 and J3 is turned off.

Thereafter, the transmission/reception processing unit 47 starts transmission of (the signal including) the clock and transmission of the master authentication pattern stored in the authentication pattern output unit 102 in synchronization with the clock output from the clock generating unit 15.

The clock and the master authentication pattern transmitted by the transmission/reception processing unit 47 are output from the microphone terminal TJ3 of the jack 14 via the capacitor 403 and the multiplexed data signal line JB.

After the transmission of the clock and the master authentication pattern starts, the pattern detecting unit 103 is on standby for the slave authentication pattern transmitted from the plug device including the plug inserted into the jack 14.

When the slave authentication pattern has not transmitted during a predetermined period of time, the pattern detecting unit 103 detects (recognizes) the plug device including the plug inserted into the jack 14 to be not the associated device, and supplies the control signal to the terminal J4 of the switch unit 401 such that the portion between the terminals J2 and J3 is turned on.

In the switch unit 401, when the portion between the terminals J2 and J3 is turned on, the microphone terminal TJ3 of the jack 14 is connected to the sound signal line JA via the switch unit 401 and connected to the power source V_{D} via the switch unit 401 and the resistor 33.

Thereafter, the host device 10 performs the operation (the operation of the mode of the related art) when the plug device including the plug inserted into the jack 14 is not the associated device such as the existing 4-pole headset including the microphone, which has been described above with reference to FIG. 2.

Meanwhile, when the slave authentication pattern is transmitted from the plug device including the plug inserted into the jack 14, that is, for example, when the plug 23 of the input device 20 serving as the associated device is inserted into the jack 14, and the slave authentication pattern is transmitted from the input device 20 to the pattern detecting unit 103 via the microphone terminal TJ3 of the jack 14, the multiplexed data signal line JB, and the capacitor 403, the pattern detecting unit 103 receives the slave authentication pattern, and the plug device including the plug inserted into the jack 14 is detected to be the associated device by the reception of the slave authentication pattern.

When the plug device including the plug inserted into the jack 14 is detected to be the associated device, the pattern detecting unit 103 supplies a signal (hereinafter, also referred to as an “associated device detection signal”) corresponding to the information indicating that the switch 41 has been switched to select the terminal 41B described above with reference to FIG. 8 to the interrupter 46.

When the associated device detection signal is supplied from the pattern detecting unit 103, the interrupter 46 supplies the information indicating that (the plug of) the associated device has been inserted into the jack 14 to the signal processing block 11.

When the information indicating that the associated device has been inserted into the jack 14 is supplied from the interrupter 46, the signal processing block 11 starts the signal processing for the associated device.

When the pattern detecting unit 103 receives the slave authentication pattern, the transmission/reception processing unit 47 transmits (returns) the ACK signal to, for example, the input device 20 serving as the plug device including the plug inserted into the jack 14 via the capacitor 403, the multiplexed data signal line JB, and the microphone terminal TJ3 of the jack 14.

Thereafter, the transmission/reception processing unit 47 starts to receive the multiplexed data transmitted from the input device 20 via the microphone terminal TJ3 of the jack 14, the multiplexed data signal line JB, and the capacitor 403.

Meanwhile, in the input device 20, when the plug 23 of the input device 20 is inserted into the jack 14 of the host device 10, the power detecting unit 111 detects that the plug 23 has been inserted into the jack (the jack 14 or the 4-pole existing jack).

In other words, when the plug 23 of the input device 20 is inserted into the jack 14 of the host device 10, the voltage of the power source V_{D} appears in the microphone terminal TP3 of the plug 23 via the resistor 33, the switch unit 401 in which the portion between the terminals J2 and J3 is turned on, and the microphone terminal TJ3 of the jack 14 in the host device 10 or via the coil 402, the multiplexed data signal line JB, and the microphone terminal TJ3 of the jack 14 in the host device 10.

The power detecting unit 111 detects that the plug 23 has been inserted into the jack as the voltage of the microphone terminal TP3 of the plug 23 changes to (a voltage close to) a voltage of the power source_{D}.

When the plug 23 is detected to have been inserted into the jack, the power detecting unit 111 supplies the control signal to the terminal P4 of the switch unit 411, and turns off the portion between the terminals P2 and P3.

Here, in FIG. 32, the microphone terminal TP3 of the plug 23 is connected to the LDO 74 via the coil 413.

In the host device 10, as the portion between the terminals J2 and J3 of the switch unit 401 is maintained in the ON state, the host device 10 can be fictitiously recognized as the existing jack device that can use the existing 4-pole headset including the microphone but is not the associated device.

When (the host device 10 fictitiously recognized as) the existing jack device is connected with the input device 20, since the portion between the terminals J2 and J3 of the switch unit 401 remains in the ON state, the power source V_{D} is supplied to the LDO 74 of the input device 20 via the resistor 33, the switch unit 401, and the microphone terminal TJ3 of the jack 14 (of the host device 10) and the microphone terminal TP3 of the plug 23 and the coil 413 (of the input device 10).

Since the power source V_{D} is supplied to the LDO 74 of the input device 20 via the resistor 33 as described above, the LDO 74 hardly supplies sufficient electric power (voltage) to the blocks for transmitting the multiplexed data such as the control unit 75 or the transmission processing unit 78 due to voltage drop in the resistor 33, and thus the blocks for transmitting the multiplexed data do not operate.

When the blocks (the control unit 75, the transmission processing unit 78, and the like) for transmitting the multiplexed data do not operate, the power detecting unit 111 detects the jack device connected to the plug 23 to be not the associated device, supplies the control signal to the terminal P4 of the switch unit 411, and turns on the portion between the terminals P2 and P3.

As the portion between the terminals P2 and P3 of the switch unit 411 is turned on, the microphone terminal T3 of the plug 23 is connected with the sound signal line PA via the switch unit 411.

Then, the input device 20 performs the operation when the jack device including the jack into which the plug 23 is inserted is the existing jack device that is not the associated device such as the existing smartphone corresponding to, for example, the existing 4-pole headset including the microphone or the like, which has been described above with reference to FIG. 2.

On the other hand, when the jack device connected to the input device 20 is the host device 10 serving as the associated device, the host device 10 turns off the portion between the terminals J2 and J3 of the switch unit 401 as described above.

When the portion between the terminals J2 and J3 of the switch unit 401 is turned off, the power source V_{D} is supplied to the LDO 74 of the input device 20 via the coil 402, the microphone terminal TJ3 of the jack 14, the microphone terminal TP3 of the plug 23, and the coil 413.

In this case, there is not voltage drop in the resistor 33 which occurs when the portion between the terminals J2 and J3 of the switch unit 401 is turned on, the LDO 74 of the input device 20 can obtain sufficient electric power (voltage) from the power source V_{D}, supply the obtained electric power to the blocks for transmitting the multiplexed data such as the control unit 75 or the transmission processing unit 78, and thus normally operate the blocks for transmitting the multiplexed data.

Thereafter, the input device 20 receives the clock and the master authentication pattern that are transmitted from the transmission/reception processing unit 47 of the host device 10 via the capacitor 403, the multiplexed data signal line JB, and the microphone terminal TJ3 of the jack 14 as described above.

In other words, in the input device 20, the PLL 77 receives the clock transmitted from the host device 10 via the microphone terminal TP3 of the plug 23, the multiplexed data signal line PB, and the capacitor 412, and starts the operation. When the PLL 77 enters the lock state, the PLL 77 supplies the clock synchronized with the clock supplied from the transmission/reception processing unit 47 to the transmission processing unit 78 and the like.

The transmission processing unit 78 operates in synchronization with the clock supplied from the PLL 77.

In the input device 20, the control unit 75 receives the master authentication pattern transmitted from the host device 10 via the microphone terminal TP3 of the plug 23, the multiplexed data signal line PB, and the capacitor 412.

Upon receiving the master authentication pattern, the control unit 75 detects the jack device including the jack into which the plug 23 is inserted to be the associated device, and causes the transmission processing unit 78 to transmit the slave authentication pattern supplied from the authentication pattern output unit 112 during a predetermined period of time.

The slave authentication pattern transmitted by the transmission processing unit 78 is output from the microphone terminal TP3 of the plug 23 via the capacitor 412 and the multiplexed data signal line JB.

The slave authentication pattern output from the microphone terminal TP3 of the plug 23 is received by the pattern detecting unit 103 via the microphone terminal TJ3 of the jack 14, the multiplexed data signal line JB, and the capacitor 403 as described above.

In the host device 10, after the pattern detecting unit 103 receives the slave authentication pattern, the transmission/reception processing unit 47 transmits the ACK signal via the capacitor 403, the multiplexed data signal line JB, and the microphone terminal TJ3 of the jack 14 as described above, and thus the control unit 75 of the input device 20 receives the ACK signal transmitted via the microphone terminal TJ3 of the jack 14 as described above via the microphone terminal TP3 of the plug 23, the multiplexed data signal line PB, and the capacitor 412.

Then, the transmission processing unit 78 starts the process of multiplexing the switch signal supplied from the switch 80, the digital sound signal #i supplied from the ADC 84ᵢ, the data read from the register 76, and the data read from the non-volatile memory 85 and transmitting the resulting multiplexed data to the transmission/reception processing unit 47 via the capacitor 412, the multiplexed data signal line PB, the microphone terminal TP3 of the plug 23, the microphone terminal TJ3 of the jack 14, the multiplexed data signal line JB, and the capacitor 403.

In the host device 10, the transmission/reception processing unit 47 receives the multiplexed data transmitted from the transmission processing unit 78 as described above.

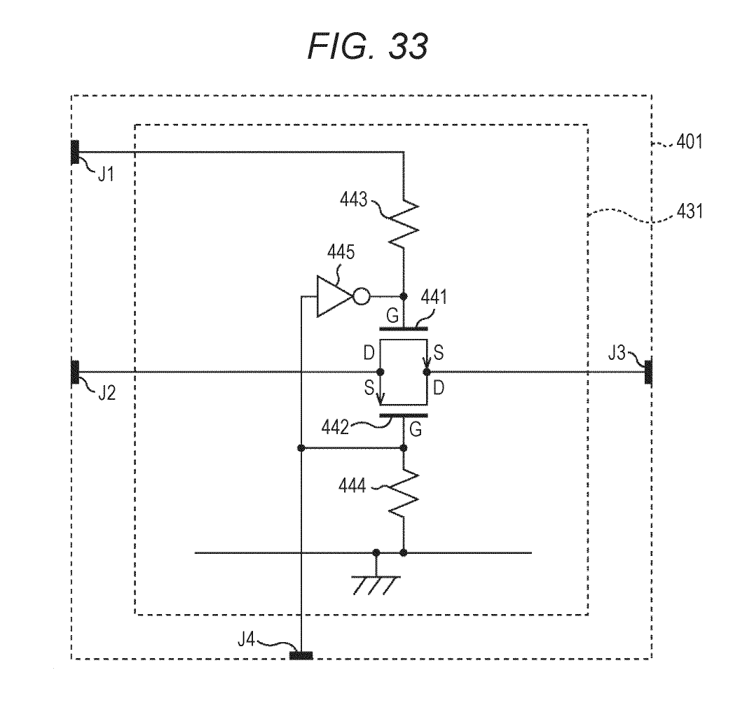

FIG. 33 is a circuit diagram illustrating an exemplary configuration of the switch unit 401 of FIG. 32.

The switch unit 401 includes a field effect transistor (FET) switch 431 that is an analog switch.

The FET switch 431 includes FETs 441 and 442, resistors 443 and 444, and an inverter 445.

The FET 441 is an n-channel metal oxide semiconductor (nMOS) FET, and a gate of the FET 441 is connected to one end of the resistor 443. A drain of the FET 441 is connected to a source of the FET 442, and a source of the FET 441 is connected with a drain of the FET 442.

The FET 442 is a p-channel MOS (pMOS) FET, and connected to one end of the resistor 444. As described above, the source of the FET 442 is connected with the drain of the FET 441, and the drain of the FET 442 is connected with the source of the FET 441.

A connection point between the drain of the FET 441 and the source of the FET 442 is connected to the terminal J2, and a connection point between the source of the FET 441 and the drain of the FET 442 is connected to the terminal J3.

One end of the resistor 443 is connected to the gate of the FET 441 as described above, and the other end of the resistor 443 is connected to the terminal J1.

One end of the resistor 444 is connected to the gate of the FET 442 as described above, and the other end of the resistor 444 is grounded.

An input terminal of the inverter 445 is connected to the terminal J4 and a connection point between the gate of the FET 442 and the resistor 444. The output terminal of the inverter 445 is connected to a connection point between the gate of the FET 441 and the resistor 443.

The FET switch 431 having the above configuration operates using a voltage of the terminal J1 as electric power, and when the voltage of the terminal J4 has the H level, the H level is applied to the gate of the FET 442, and the L level is applied to the gate of the FET 441 via the inverter 445.

As a result, both of the FETs 441 and 442 are turned off, and the portion between the terminals J2 and J3 enters the OFF state (the non-conduction state).

On the other hand, when the voltage of the terminal J4 has the L level, the L level is applied to the gate of the FET 442, and the H level is applied to the gate of the FET 441 via the inverter 445.

As a result, both of the FETs 441 and 442 are turned on, and the portion between the terminals J2 and J3 enters the ON state (the conduction state).

As described above, the FET switch 431 turns on or off the portion between the terminals J2 and J3 according to the signal (the control signal) supplied to the terminal J4.

Commonly, a protection diode for protection from an over voltage (overcurrent) is appropriately installed in an electronic circuit, but in FIG. 33, in order to avoid a complicated drawing, a protection diode is not illustrated.

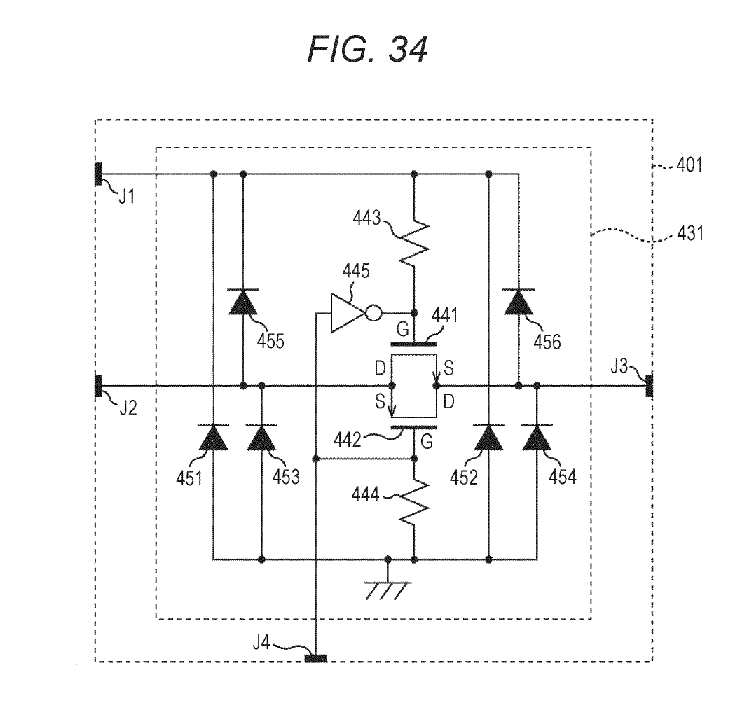

FIG. 34 is a circuit diagram illustrating an exemplary configuration of the switch unit 401 when a protection diode is installed.

In FIG. 34, parts corresponding to those in FIG. 33 are denoted by the same reference numerals, and hereinafter, a description thereof will be appropriately omitted.

In FIG. 34, as a protection diode, a diode 451 is installed at a terminal J2 side between a terminal J1 and the ground, a diode 452 is installed at a terminal J3 side between the terminal J1 and the ground, a diode 453 is installed between the terminal J2 and the ground, a diode 454 is installed between the terminal J3 and the ground, a diode 455 is installed between the terminals J1 and J2, and a diode 456 is installed between the terminals J1 and J3.

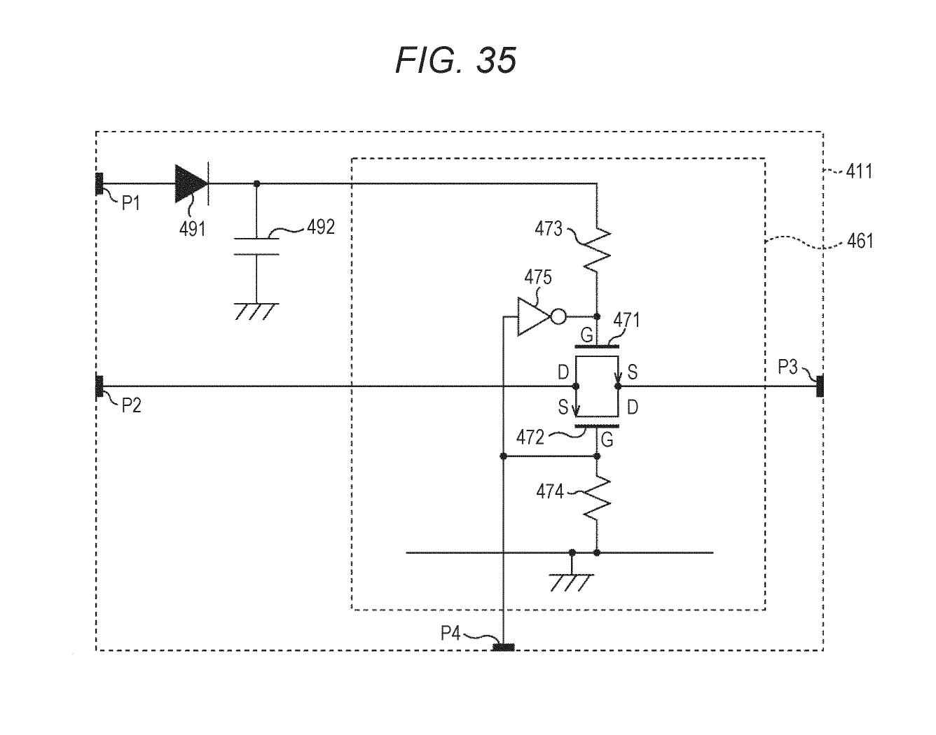

FIG. 35 is a circuit diagram illustrating an exemplary configuration of the switch unit 411 of FIG. 32.

The switch unit 411 includes an FET switch 461 that is an analog switch.

The switch unit 411 further includes a diode 491 and a capacitor 492.

The FET switch 461 includes FETs 471 and 472, resistors 473 and 474, and an inverter 475 and has a similar configuration to the FET switch 431 of FIG. 33.

In other words, the FET 471 is an nMOS FET, and a gate of the FET 471 is connected to one end of the resistor 473. A drain of the FET 471 is connected with a source of the FET 472 serving as a pMOS FET, and a source of the FET 471 is connected with a drain of the FET 472.

A gate of the FET 472 is connected to the other end of the resistor 474 whose one end is grounded. A connection point between the drain of the FET 471 and the source of the FET 472 is connected to the terminal P2, and a connection point between the source of the FET 471 and the drain of the FET 472 is connected to the terminal P3.

An input terminal of the inverter 475 is connected to the terminal P4 and a connection point between the gate of the FET 472 and the resistor 474. An output terminal of the inverter 475 is connected to a connection point between the gate of the FET 471 and the resistor 473.

The other end of the resistor 473 whose one end is connected to the gate of the FET 471 is connected to the terminal P1 via the diode 491.

The FET switch 461 having the above configuration operates a voltage supplied from the terminal P1 via the diode 491 as electric power, and when a voltage of the terminal P4 has the H level, the H level is applied to the gate of the FET 472, and the L level is applied to the gate of the FET 471 via the inverter 475.

As a result, both of the FETs 471 and 472 are turned off, and the portion between the terminals P2 and P3 enters the OFF state (the non-conduction state).

On the other hand, when the voltage of the terminal P4 has the L level, the L level is applied to the gate of the FET 472, and the H level is applied to the gate of the FET 471 via the inverter 475.

As a result, both of the FET 471 and 472 are turned on, and the portion between the terminals P2 and P3 enters the ON state (the conduction state).

As described above, the FET switch 461 turns on or off the portion between the terminals P2 and P3 according to the signal (the control signal) supplied to the terminal P4.

By the way, the switch unit 411 includes the diode 491 and the capacitor 492 in addition to the FET switch 461.

An anode of the diode 491 is connected to the terminal P1, and a cathode of the diode 491 is connected to the other end of the resistor 473 whose one end is connected to the gate of the FET 471.

The cathode of the diode 491 is connected to the capacitor 492 whose one end is grounded as well.

The reason why the switch unit 411 of the input device 20 includes the diode 491 and the capacitor 492 in addition to the FET switch 461 is as follows.

In other words, in the input device 20 (FIG. 32), if the switch 80 is configured so that the connect point PS is short-circuited to the ground when the switch 80 is operated, the terminal P3 of the switch unit 411 is connected to the ground with almost 0 ohm via the sound signal line PA connected to the connect point PS, the connect point PS, and the switch 80 when the switch 80 is operated.

Meanwhile, when the existing jack device such as the existing smartphone that is not the associated device is connected to the input device 20, the portion between the terminals P2 and P3 of the switch unit 411 is turned on (needs to enter the ON state) as described above with reference to FIG. 32.

If the switch unit 411 does not include the diode 491 and the capacitor 492, and the terminal P1 is connected directly to the resistor 473 of the FET switch 461, the terminal P1 of the switch unit 411 is connected to the microphone terminal TP3 of the plug 23 via the coil 413 of the input device 20 (FIG. 32), and thus the FET switch 461 operates using a signal supplied from the host device 10 to the terminal P1 of the switch unit 411 via the microphone terminal TP3 of the plug 23 and the coil 413 as electric power.

When the existing jack device that is not the associated device is connected to the input device 20, the input device 20 turns on the portion between the terminals P2 and P3 of the switch unit 411 as described above with reference to FIG. 32.

In this case, when the switch 80 is operated, and the terminal P3 of the switch unit 411 is connected (short-circuited) to the ground, the voltage of the microphone terminal TP3 of the jack 23 largely drops via the portion between the terminals P2 and P3 of the switch unit 411 that is in the ON state.

When the voltage of the microphone terminal TP3 of the jack 23 drops, the voltage supplied from the microphone terminal TP3 to the terminal P1 of the switch unit 411 also drops, and in the FET switch 461, it is difficult to secure a voltage V_{GS} between the gate and the source of the nMOS FET 471 so that the ON state of the FET 471 is maintained.

As a result, in the FET switch 461, the FET 471 is turned off (opened), it becomes difficult to maintain the portion between the terminals P2 and P3 of the switch unit 411 in the ON state, and the portion between the terminals P2 and P3 is turned off.

When the portion between the terminals P2 and P3 of the switch unit 411 is turned off, an electrical connection between the microphone terminal TP3 of the plug 23 and the sound signal line PA is disconnected, and thus it is difficult to transmit the switch signal of the switch 80 or the sound signal of the microphone 81₀ to the existing jack device connected to the input device 20.

In order to prevent the situation in which when the existing jack device is connected to the input device 20, the portion between the terminals P2 and P3 of the switch unit 411 is turned off according to the operation of the switch 80, and it is difficult to transmit the switch signal of the switch 80 or the sound signal of the microphone 81₀ to the existing jack device connected to the input device 20 as described above, the diode 491 and the capacitor 492 are installed in the switch unit 411.

In other words, the circuit including the diode 491 whose anode is connected to the terminal P1 and the capacitor 492 in which one end is grounded, and the other end is connected to the cathode of the diode 491 configures a power supply circuit that supplies electric power to the FET switch 461.

The power supply circuit including the diode 491 and the capacitor 492 is a power source of a separate system from the LDO 74 that supplies electric power to the control unit 75 and the transmission processing unit 78.

In the power supply circuit including the diode 491 and the capacitor 492, the signal supplied from the terminal P1 of the switch unit 411 is rectified in the diode 491, and the capacitor 492 is charged by the rectified signal. Then, the FET switch 461 is supplied with electric power by the charged capacitor 492.

Thus, as described above, although the voltage of the microphone terminal TP3 of the jack 23 drops as the switch 80 is operated, the gate voltage, that is, the voltage V_{GS} between the gate and the source of the nMOS the FET 471 is maintained by the capacitor 492, and thus the FET 471 can be prevented from being turned off.

As a result, when the existing jack device is connected to the input device 20, it is possible to prevent the portion between the terminals P2 and P3 of the switch unit 411 from being turned off by the operation of the switch 80, and eventually, it is possible to prevent the situation in which it is difficult to transmit the switch signal of the switch 80 or the sound signal of the microphone 81₀ to the existing jack device connected to the input device 20.

Here, for the power supply circuit including the diode 491 and the capacitor 492, a reverse bias current of the diode 491, a leak current of the capacitor 492, and a gate current of the FET 471 function as a consumption current of the switch unit 411 but the currents are extremely small.

Thus, in (the capacitor 492 of) the power supply circuit including the diode 491 and the capacitor 492, it is possible to maintain a voltage necessary to operate the FET switch 461 during a period of time sufficiently larger than a period of time during which the switch 80 is being operated.

For the switch unit 401 of the host device 10 (FIG. 33), there is no cases in which it is difficult to maintain the voltage between the gate and the source of the FET 441 by the operation of the switch 80, and thus it is unnecessary to install a power source of another system such as the power supply circuit including the diode 491 and the capacitor 492.

However, for the switch unit 401 (FIG. 33), similarly to the switch unit 411 (FIG. 35), it is possible to install a power source of another system such as the power supply circuit including the diode 491 and the capacitor 492.

Here, in the switch unit 411 of FIG. 35, the diode 491 has a role of preventing a reverse current of an electric current to the terminal P1.

In FIG. 35, similarly to the example of FIG. 33, in order to avoid a complicated drawing, a protection diode is not illustrated.

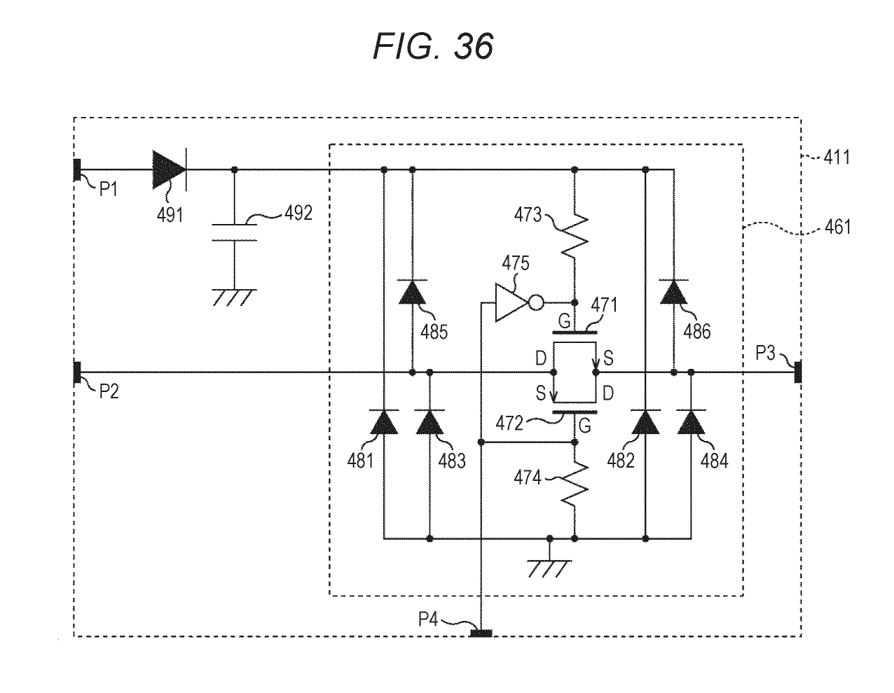

FIG. 36 is a circuit diagram illustrating an exemplary configuration of the switch unit 411 when a protection diode is installed.

In FIG. 36, parts corresponding to those in FIG. 35 are denoted by the same reference numerals, and hereinafter, a description thereof will be appropriately omitted.

In FIG. 36, as a protection diode, a diode 481 is installed at a terminal P2 side between a terminal P1 and the ground, a diode 482 is installed at a terminal P3 side between the terminal P1 and the ground, a diode 483 is installed between the terminal P2 and the ground, the diode 484 is installed between the terminal P3 and the ground, a diode 485 is installed between the terminals P1 and P2, and a diode 486 is installed between the terminals P1 and P3.

<Description of Computer to which Present Technology is Applied>

Next, (part of) a series of processes may be performed by hardware or may be performed by software. When the above-described process is performed by software, a program configuring the software is installed in a computer or the like.

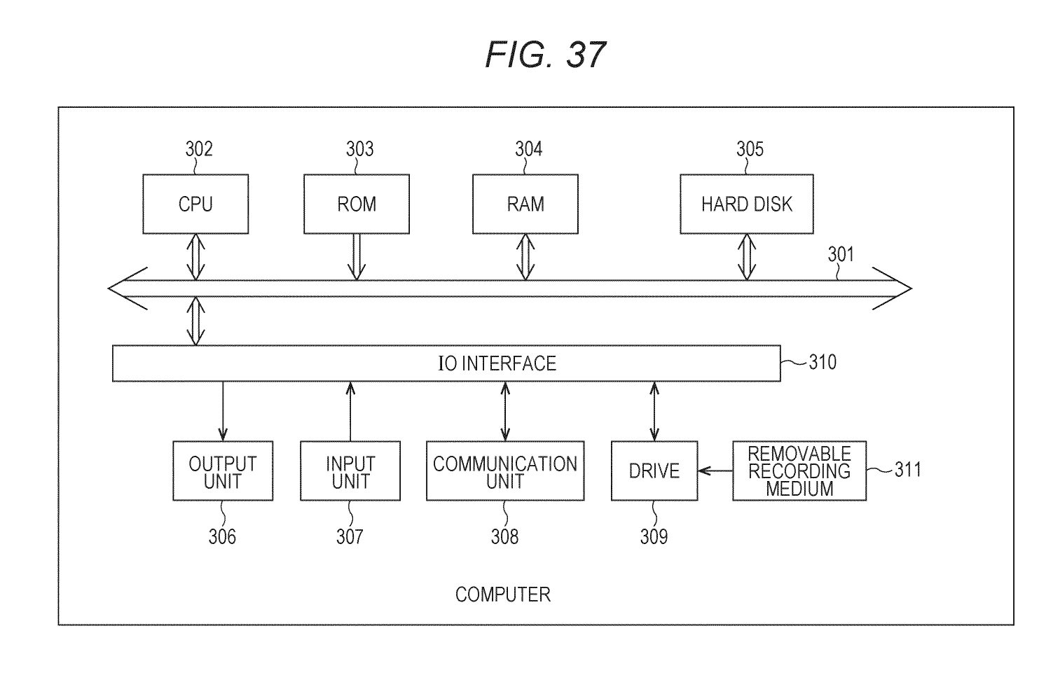

FIG. 37 illustrates an exemplary configuration of an embodiment of a computer in which a program executing the above-described process is installed.

The program may be recorded in a hard disk 305 or ROM 303 serving as a recording medium installed in the computer.

Alternatively, the program may be stored (recorded) in a removable recording medium 311. The removable recording medium 311 may be provided as so-called package software. Examples of the removable recording medium 311 include a flexible disk, a compact disc read only memory (CD-ROM), a magneto optical (MO) disk, a digital versatile disc (DVD), a magnetic disk, and semiconductor memory.

The program is installed in the computer from the removable recording medium 311 but may be downloaded to the computer via a communication network or a broadcasting network and installed in the internal hard disk 305. In other words, for example, the program may be transferred from a download site to the computer via a satellite for digital satellite broadcasting in a wireless manner or may be transferred to the computer via a network such as a local area network (LAN) or the Internet in a wired manner.

The computer includes an internal CPU 302, and an input output (IO) interface 310 is connected to the CPU 302 via a bus 301.

When the user operates an input unit 307 through the IO interface 310 and inputs a command, the CPU 302 executes the program stored in the read only memory (ROM) 303 according to the input command. Alternatively, the CPU 302 loads the program stored in the hard disk 305 onto random access memory (RAM) 304 and then executes the program.

As a result, the CPU 302 performs the process according to the above-described flowchart or the process performed by the configuration of the above-described block diagram. Then, for example, the CPU 302 outputs the process result from an output unit 306, transmits the process result from a communication unit 308, or records the process result in the hard disk 305 through the IO interface 310 as necessary.

The input unit 307 is configured with a keyboard, a mouse, a microphone, or the like. The output unit 306 is configured with a liquid crystal display (LCD), a speaker, or the like.

Here, in this specification, the process performed by the computer according to the program need not be necessarily performed chronologically according to the order described as the flowchart. In other words, the process performed by the computer according to the program includes processes (for example, parallel processes or processes by an object) that are executed in parallel or individually.

The program may be processed through one computer (processor) or may be distributedly processed through a plurality of computers. Further, the program may be transferred to a computer at a remote site and executed.

In this specification, a system means a set of a plurality of elements (devices, modulates (parts), or the like) regardless of whether or not all elements are arranged in a single housing. Thus, both a plurality of devices that are accommodated in separate housings and connected via a network and a single device in which a plurality of modules are accommodated in a single housing are systems.

The embodiment of the present technology is not limited to the above embodiments, and various changes can be made within the scope not departing from the gist of the present technology.

For example, the present disclosure can adopt a configuration of cloud computing which processes by allocating and connecting one function by a plurality of devices through a network.

Further, each step described by the above mentioned flow charts can be executed by one device or by allocating a plurality of devices.

In addition, in the case where a plurality of processes is included in one step, the plurality of processes included in this one step can be executed by one device or by allocating a plurality of devices.

Further, the present technology can have the following configurations.

<1>

An input device, including:

a plug that is inserted into a jack of a jack device including the jack;

a plurality of converting units each of which converts a physical quantity into an electric signal;

a detecting unit that detects whether or not the jack device is an associated device capable of dealing with multiplexed data obtained by multiplexing the electric signals output from the plurality of converting units; and

a transmission processing unit that transmits the multiplexed data via the plug when the jack device is the associated device.

<2>

The input device according to <1>, further including

a storage unit that stores device information related to the input device,

wherein the multiplexed data includes the device information.

<3>

The input device according to <1> or <2>,

wherein the input device operates with electric power supplied from the jack device.

<4>

The input device according to any one of <1> to <3>, further including

a sound output unit that outputs a sound corresponding to a sound signal transmitted from the jack device.

<5>

The input device according to <4>,

wherein the converting unit is a microphone that converts a sound into a sound signal,

the plug is a plug including

a ground terminal that is connected to a ground,

two sound signal terminals that receive input of sound signals of two channels corresponding to the sound output from the sound output unit, and

one microphone terminal that outputs the sound signal output from a predetermined microphone among a plurality of microphones serving as the plurality of converting units to the jack device, and

the transmission processing unit transmits the multiplexed data through microphone terminal.

<6>

The input device according to <5>, further including

a selecting unit that selects one of a sound signal line for transmitting the sound signal output from the predetermined microphone and a multiplexed data signal line for transmitting the multiplexed data output from the transmission processing unit, and connects the selected line to the microphone terminal.

<7>

The input device according to <6>,

wherein the detecting unit detects the jack device to be the associated device when a predetermined signal is received via the microphone terminal, and switches the selecting unit selecting the sound signal line to select the multiplexed data signal line, and

the transmission processing unit transmits the multiplexed data via the multiplexed data signal line and the microphone terminal.

<8>

The input device according to <6>,

wherein when there is a predetermined change in a signal of the microphone terminal, the selecting unit selecting the sound signal line is switched to select the multiplexed data signal line,

the detecting unit detects the jack device to be the associated device when a predetermined signal is received via the microphone terminal and the multiplexed data signal line, and

the transmission processing unit transmits the multiplexed data via the multiplexed data signal line and the microphone terminal.

<9>

A transmitting method of an input device including a plug inserted into a jack of a jack device including the jack and a plurality of converting units each of which converts a physical quantity into an electric signal, the transmitting method including:

a step of detecting, by the input device, whether or not the jack device is an associated device capable of dealing with multiplexed data obtained by multiplexing the electric signals output from the plurality of converting units; and

a step of transmitting, by the input device, the multiplexed data via the plug when the jack device is the associated device.

<10>

A host device, including:

a jack into which a plug of a plug device including the plug is inserted;

a detecting unit that detects whether or not the plug device is an associated device capable of dealing with multiplexed data obtained by multiplexing electric signals output from a plurality of converting units each of which converts a physical quantity into the electric signal; and

a reception processing unit that receives the multiplexed data transmitted from the plug device serving as the associated device via the jack when the plug device is the associated device.

<11>

The host device according to <10>,

wherein the multiplexed data includes device information related to the plug device serving as the associated device, and

the host device further includes a signal processing unit that performs signal processing according to the device information.

<12>

The host device according to <10> or <11>,

wherein the host device supplies electric power to the plug device.

<13>

The host device according to any one of <10> to <12>, further including

a sound interface that transmits a sound signal to the plug device.

<14>

The host device according to <13>,

wherein the plug device serving as the associated device includes the plurality of converting units,

each of the converting units is a microphone that converts a sound into a sound signal,

the jack is a jack including

a ground terminal that is connected to a ground,

two sound signal terminals that output sound signals of two channels output from the sound interface, and

one microphone terminal that receives an input of the sound signal output from a predetermined microphone among a plurality of microphones serving as the plurality of converting units, and

the reception processing unit receives the multiplexed data via the microphone terminal.

<15>

The host device according to <14>, further including

a selecting unit that selects one of a sound signal line for receiving the sound signal output from the predetermined microphone and a multiplexed data signal line for receiving the multiplexed data, and connects the selected line to the microphone terminal.

<16>

The host device according to <15>,

wherein the detecting unit detects the plug device to be the associated device when a predetermined signal is received via the microphone terminal, and switches the selecting unit selecting the sound signal line to select the multiplexed data signal line, and

the reception processing unit receives the multiplexed data via the microphone terminal and the multiplexed data signal line.

<17>

The host device according to <15>,

wherein when the plug is inserted into the jack, the selecting unit selecting the sound signal line is switched to select the multiplexed data signal line,

the detecting unit detects the plug device to be the associated device when a predetermined signal is received via the microphone terminal and the multiplexed data signal line, and

the reception processing unit receives the multiplexed data via the microphone terminal and the multiplexed data signal line.

<18>

A receiving method of a host device including a jack into which a plug of a plug device including the plug is inserted, the receiving method including:

a step of detecting whether or not the plug device is an associated device capable of dealing with multiplexed data obtained by multiplexing electric signals output from a plurality of converting units each of which converts a physical quantity into the electric signal; and

a step of receiving the multiplexed data transmitted from the plug device serving as the associated device via the jack when the plug device is the associated device.

<19>

A signal processing system, including:

an input device including

a plug that is inserted into a jack of a jack device including the jack,

a plurality of converting units each of which converts a physical quantity into an electric signal,

a detecting unit that detects whether or not the jack device is an associated device capable of dealing with multiplexed data obtained by multiplexing the electric signals output from the plurality of converting units, and

a transmission processing unit that transmits the multiplexed data via the plug when the jack device is the associated device; and

a host device including

a jack into which a plug of a plug device including the plug is inserted, and

another detecting unit that detects whether or not the plug device is the associated device, and

a reception processing unit that receives the multiplexed data transmitted from the plug device serving as the associated device via the jack when the plug device is the associated device.

<20>

A transceiving method, including:

a step of detecting, by the input device, whether or not a jack device is an associated device capable of dealing with multiplexed data obtained by multiplexing electric signals output from a plurality of converting units, the input device including a plug inserted into a jack of the jack device including the jack and the plurality of converting units each of which converts a physical quantity into the electric signal;

a step of transmitting, by the input device, the multiplexed data via the plug when the jack device is the associated device;

a step of detecting, by a host device, whether or not a plug device is an associated device, the host device including a jack into which a plug of the plug device including the plug is inserted; and

a step of receiving, by the host device, the multiplexed data transmitted from the plug device serving as the associated device via the jack when the plug device is the associated device.

### REFERENCE SIGNS LIST

10 Host device
11 Signal processing block
12 Analog sound interface
13 Multiplexed data interface
14 Jack
15 Clock generating unit
20 Input device
21 Analog sound interface
22 Multiplexed data interface
23 Plug
31 DAC
32 Power amplifier
33 Resistor
41 Switch
41A, 41B Terminal
43 Capacitor
44 Microphone detecting unit
45 Association detecting unit
46 Interrupter
47 Transmission/reception processing unit
48 Register
49 I²C interface
61L, 61R Driver
71 Switch
71A, 71B Terminal
72 Capacitor
73 Association detecting unit
74 LDO
75 Control unit
76 Register
77 PLL
78 Transmission processing unit
80 Switch
81₁ to 81₄ Microphone
82₁ to 82₄ Amplifier
83₁ to 83₄ Resistor
84₁ to 84₄ aDC
85 Non-volatile memory
101 Plug detecting unit
102 Authentication pattern output unit
103 Pattern detecting unit
111 Power detecting unit
112 Authentication pattern output unit
121 PLL
122 Reception processing unit
123 SRC
131 Synchronizing unit
132 Clock generating unit
301 Bus
302 CPU
303 ROM
304 RAM
305 Hard disk
306 Output unit
307 Input unit
308 Communication unit
309 Drive
310 IO interface
311 Removable recording medium

1. An input device, comprising:
a plug that is inserted into a jack of a jack device including the jack;
a plurality of converting units each of which converts a physical quantity into an electric signal;
a detecting unit that detects whether or not the jack device is an associated device capable of dealing with multiplexed data obtained by multiplexing the electric signals output from the plurality of converting units; and
a transmission processing unit that transmits the multiplexed data via the plug when the jack device is the associated device.

2. The input device according to claim 1, further comprising
a storage unit that stores device information related to the input device,
wherein the multiplexed data includes the device information.

3. The input device according to claim 2,
wherein the input device operates with electric power supplied from the jack device.

4. The input device according to claim 3, further comprising
a sound output unit that outputs a sound corresponding to a sound signal transmitted from the jack device.

5. The input device according to claim 4,
wherein the converting unit is a microphone that converts a sound into a sound signal,
the plug is a plug including
a ground terminal that is connected to a ground,
two sound signal terminals that receive input of sound signals of two channels corresponding to the sound output from the sound output unit, and
one microphone terminal that outputs the sound signal output from a predetermined microphone among a plurality of microphones serving as the plurality of converting units to the jack device, and
the transmission processing unit transmits the multiplexed data through microphone terminal.

6. The input device according to claim 5, further comprising
a selecting unit that selects one of a sound signal line for transmitting the sound signal output from the predetermined microphone and a multiplexed data signal line for transmitting the multiplexed data output from the transmission processing unit, and connects the selected line to the microphone terminal.

7. The input device according to claim 6,
wherein the detecting unit detects the jack device to be the associated device when a predetermined signal is received via the microphone terminal, and switches the selecting unit selecting the sound signal line to select the multiplexed data signal line, and
the transmission processing unit transmits the multiplexed data via the multiplexed data signal line and the microphone terminal.

8. The input device according to claim 6,
wherein when there is a predetermined change in a signal of the microphone terminal, the selecting unit selecting the sound signal line is switched to select the multiplexed data signal line,
the detecting unit detects the jack device to be the associated device when a predetermined signal is received via the microphone terminal and the multiplexed data signal line, and
the transmission processing unit transmits the multiplexed data via the multiplexed data signal line and the microphone terminal.

9. A transmitting method of an input device including a plug inserted into a jack of a jack device including the jack and a plurality of converting units each of which converts a physical quantity into an electric signal, the transmitting method comprising:
a step of detecting, by the input device, whether or not the jack device is an associated device capable of dealing with multiplexed data obtained by multiplexing the electric signals output from the plurality of converting units; and
a step of transmitting, by the input device, the multiplexed data via the plug when the jack device is the associated device.

10. A host device, comprising:
a jack into which a plug of a plug device including the plug is inserted;
a detecting unit that detects whether or not the plug device is an associated device capable of dealing with multiplexed data obtained by multiplexing electric signals output from a plurality of converting units each of which converts a physical quantity into the electric signal; and
a reception processing unit that receives the multiplexed data transmitted from the plug device serving as the associated device via the jack when the plug device is the associated device.

11. The host device according to claim 10,
wherein the multiplexed data includes device information related to the plug device serving as the associated device, and
the host device further includes a signal processing unit that performs signal processing according to the device information.

12. The host device according to claim 11,
wherein the host device supplies electric power to the plug device.

13. The host device according to claim 12, further comprising
a sound interface that transmits a sound signal to the plug device.

14. The host device according to claim 13,
wherein the plug device serving as the associated device includes the plurality of converting units,
each of the converting units is a microphone that converts a sound into a sound signal,
the jack is a jack including
a ground terminal that is connected to a ground,
two sound signal terminals that output sound signals of two channels output from the sound interface, and
one microphone terminal that receives an input of the sound signal output from a predetermined microphone among a plurality of microphones serving as the plurality of converting units, and
the reception processing unit receives the multiplexed data via the microphone terminal.

15. The host device according to claim 14, further comprising
a selecting unit that selects one of a sound signal line for receiving the sound signal output from the predetermined microphone and a multiplexed data signal line for receiving the multiplexed data, and connects the selected line to the microphone terminal.

16. The host device according to claim 15,
wherein the detecting unit detects the plug device to be the associated device when a predetermined signal is received via the microphone terminal, and switches the selecting unit selecting the sound signal line to select the multiplexed data signal line, and
the reception processing unit receives the multiplexed data via the microphone terminal and the multiplexed data signal line.

17. The host device according to claim 15,
wherein when the plug is inserted into the jack, the selecting unit selecting the sound signal line is switched to select the multiplexed data signal line,
the detecting unit detects the plug device to be the associated device when a predetermined signal is received via the microphone terminal and the multiplexed data signal line, and
the reception processing unit receives the multiplexed data via the microphone terminal and the multiplexed data signal line.

18. A receiving method of a host device including a jack into which a plug of a plug device including the plug is inserted, the receiving method comprising:
a step of detecting whether or not the plug device is an associated device capable of dealing with multiplexed data obtained by multiplexing electric signals output from a plurality of converting units each of which converts a physical quantity into the electric signal; and
a step of receiving the multiplexed data transmitted from the plug device serving as the associated device via the jack when the plug device is the associated device.

19. A signal processing system, comprising:
an input device including
a plug that is inserted into a jack of a jack device including the jack,
a plurality of converting units each of which converts a physical quantity into an electric signal,
a detecting unit that detects whether or not the jack device is an associated device capable of dealing with multiplexed data obtained by multiplexing the electric signals output from the plurality of converting units, and
a transmission processing unit that transmits the multiplexed data via the plug when the jack device is the associated device; and
a host device including
a jack into which a plug of a plug device including the plug is inserted, and
another detecting unit that detects whether or not the plug device is the associated device, and
a reception processing unit that receives the multiplexed data transmitted from the plug device serving as the associated device via the jack when the plug device is the associated device.

20. A transceiving method, comprising:
a step of detecting, by the input device, whether or not a jack device is an associated device capable of dealing with multiplexed data obtained by multiplexing electric signals output from a plurality of converting units, the input device including a plug inserted into a jack of the jack device including the jack and the plurality of converting units each of which converts a physical quantity into the electric signal;
a step of transmitting, by the input device, the multiplexed data via the plug when the jack device is the associated device;
a step of detecting, by a host device, whether or not a plug device is an associated device, the host device including a jack into which a plug of the plug device including the plug is inserted; and
a step of receiving, by the host device, the multiplexed data transmitted from the plug device serving as the associated device via the jack when the plug device is the associated device.
